(19) United States
(12) Patent Application Publication
(10) Pub. No.: US 2013/0154553 A1
(43) Pub. Date: Jun. 20, 2013

(54) Wireless Automated Vehicle Energizing System

(71) Applicant: Daniel W. Steele, Clay, NY (US)

(72) Inventor: Daniel W. Steele, Clay, NY (US)

(21) Appl. No.: 13/402,211

(22) Filed: Feb. 22, 2012

Related U.S. Application Data
(60) Provisional application No. 61/463,717, filed on Feb. 22, 2011.
(60) Provisional application No. 61/573,750, filed on Sep. 12, 2011.

(51) Int. Cl. H02J 7/00

(52) U.S. Cl. 320/108

(57) ABSTRACT

A wireless recharging system for battery or hybrid vehicles having an in-road magnetic power transmission assembly that interconnects to a magnetic power reception assembly onboard the vehicle. As the vehicle stops or passes over the in-road magnetic power transmission assembly, magnetic coupling transfers power to the magnetic power reception assembly which, in turn, is used to recharge the vehicle battery. The in-road magnetic power transmission assembly may be powered from the electrical grid or designated electrical generators and is preferably designed to build the powering magnetic field in response to the detection of an authorized vehicle in proximity to the transmission assembly.

### CROSS-REFERENCE TO RELATED APPLICATIONS

The present application is a non-provisional of U.S. Provisional Application No. 61/463,717, filed on Feb. 22, 2011 and U.S. Provisional No. 61/573,750, filed on Sep. 12, 2011, both of which are hereby incorporated by reference in their entirety.

### BACKGROUND OF THE INVENTION

1. Field of the Invention

The present invention relates to electric and hybrid electric vehicles and, more particularly, a system and method for wirelessly charging vehicle batteries while stationary or in motion.

2. Description of the Related Art

The rapid development of a new electric vehicle fleet is being fueled by a “perfect storm” of pressures—to cut foreign oil consumption, reduce greenhouse gas pollution and revive USA based manufacturing. However a major impediment to the rapid growth of an electric vehicle fleet is the high cost, low reliability and performance limitations associated with vehicular energy storage—the battery. Other major components required to produce a low cost, high performance electric vehicle are currently ready for mass production—strong lightweight body, electric motor and associated electronic controller. Accordingly, there is a need in the art for utility-based power generation capacity that is capable of adapting to the electrical consumption posed by any reasonable growth in electrically powered transportation.

The U.S. Department of Energy is faced with the very difficult task of driving development that will transition the energy infrastructure of our nation from one primarily based upon early 20th century technologies to an infrastructure based upon early 21st century technologies. The key being that the required 21st century technology is only partially developed, with many missing pieces and not integrated. Transitioning the transportation sector to 21st century technology is one very important component that U.S. Department of Energy must address if it is to successfully drive this difficult transition.

Vehicle fleet electrification is a fundamental way for the U.S. Department of Energy to drive fuel efficient and low pollution electrical energy generation to ubiquitously change the present inefficient nature of fossil fuel consumption. The primary impediment to widespread adoption of electric bus, truck and automobile electrification is the disconnect between electric power generation and vehicle motors, currently bridged by battery technology that is costly, easily damaged and performance limiting. The U.S. Department of Energy is of course one of the important drivers of battery technology improvement, however this appears to be a long term developmental process. The U.S. Department of Energy thus needs an adjunct that can enable both current and longer term battery technologies to seamlessly transition into all modes of land transport. The focus upon higher and higher battery energy storage density at proportionately lower cost, volume and weight still ignores the difficulties associated with peak charging energy demands that grow larger with each improvement.

### BRIEF SUMMARY OF THE INVENTION

The present invention provides.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a schematic of the wireless energizing system according to the present invention;

FIG. 2 is a schematic of an in-road embodiment of a wireless power transmission system according to the present invention;

FIG. 3 is a schematic of an intersection provided with a wireless power transmission system according to the present invention;

FIG. 4 is a schematic of a parking lot provided with a wireless power transmission system according to the present invention;

FIG. 5 is a schematic of an in-home embodiment of a wireless power transmission system according to the present invention;

FIG. 6 is a schematic of a grid power multiphase interface according to the present invention;

FIG. 7 is a schematic of a grid power multiphase interface according to the present invention;

FIG. 8 is a schematic of a grid power multiphase interface according to the present invention;

FIG. 9 is a schematic of the coil electronics subassembly of a power transmission module according to the present invention;

FIG. 10 is a graph of the power transmission module primary waveform according to the present invention;

FIG. 11 is a schematic of the coil electronics subassembly of a power transmission module according to the present invention;

FIG. 12 is a schematic of a roadway installation of a wireless power transmission system according to the present invention;

FIG. 13 is a schematic of a power transmission cable according to the present invention;

FIG. 14 is a schematic of a power transmission cable interface according to the present invention;

FIG. 15 is a detailed schematic of a parking lot provided with a wireless power transmission system according to the present invention;

FIG. 16 is a schematic of a roadway power transmission cable and magnetic interface according to the present invention;

FIG. 17 is a schematic of a power transmission module truss support assembly according to the present invention;

FIG. 18 is a schematic of a power transmission module assembly according to the present invention;

FIG. 19 is a schematic of a power transmission module end cap according to the present invention;

FIG. 20 is a schematic of the integrated tank and link coils of the coil electronics subassembly of a power transmission module according to the present invention;

FIG. 21 is a schematic of tank coil of the coil electronics subassembly of a power transmission module according to the present invention;

FIG. 22 is a schematic of the integrated tank capacitor of the coil electronics subassembly of a power transmission module according to the present invention;

FIG. 23 is a schematic of the design of the tank capacitor of the coil electronics subassembly of a power transmission module according to the present invention;

FIG. 24A is an electrical diagram of the circuitry of the power transmission module power amplifier according to the present invention;

FIG. 24B is a schematic of the power amplifier output current sampling of a power transmission module according to the present invention;

FIG. 25 is a schematic of the laminate construction of the coil electronics subassembly of a power transmission module according to the present invention;

FIG. 26 is a schematic of the heat sink via designs of the coil electronics subassembly of a power transmission module according to the present invention;

FIG. 27 is a schematic of the magnetic fields produced by a power transmission module according to the present invention'

FIG. 28 is a schematic of the selective energization of power transmission modules in a roadway according to the present invention;

FIG. 29 is an electrical schematic of an embodiment of the H-bridge power amplifier according to the present invention;

FIG. 30 is a schematic of a power receive module according to the present invention;

FIG. 31 is flowchart of the logic of a power transmit module according to the present invention;

FIG. 32 is a schematic of the vehicle interfaces of a power transmit module according to the present invention;

FIG. 33 is a schematic of an integrated power receive module coil assembly according to the present invention;

FIG. 34 is a schematic of a dual mode embodiment of the wireless power transmission system according to the present invention;

FIG. 35 is a schematic of an intersection provided with a wireless power transmission system according to the present invention;

FIG. 36 is a schematic of a steering correct display according to the present invention;

FIG. 37 is a schematic of a power receive module configuration for use with a steering correct display according to the present invention;

FIG. 38 is an electrical schematic of an example of a power transmit module according to the present invention;

FIG. 39 is an electrical schematic of an example of the electronic subassemblies of a power transmit module according to the present invention;

FIG. 40 is an electrical schematic of an H-bridge amplifier of an example of a power transmit module according to the present invention;

FIG. 41 is an electrical schematic of a tank coil of an example of a power transmit module according to the present invention;

FIG. 42 is a schematic of a power amplifier tank cap of an example of a power transmit module according to the present invention;

FIG. 43 is a schematic of a pickup coil of an example of a power transmit module according to the present invention;

FIG. 44 is a schematic of a pickup coil resonating cap of an example of a power transmit module according to the present invention;

FIG. 45 is an electrical schematic of the carrier logic and power amplifier gate drive electronics for an example of a power transmit module according to the present invention;

FIG. 46 is a schematic of the gate drive and coil polarity relationships for an example of a power transmit module according to the present invention;

FIG. 47 is a schematic of the variable frequency oscillator subassembly of an example of a power transmit module according to the present invention;

FIG. 48 is a schematic of the chassis layout for an example of a power transmit module according to the present invention;

FIG. 49 is a schematic of the load bank layout for an example of a power receive module according to the present invention;

FIG. 50 is a schematic of the foil and conductive surfaces for an example of a power transmit module according to the present invention;

FIG. 51 is a schematic of the electronics of an example power receive module according to the present invention; and

FIG. 52 is a schematic of a strapping system for present invention.

### DETAILED DESCRIPTION OF THE INVENTION

Referring now to the drawings, wherein like reference numerals refer to like parts throughout, the present invention comprises a wireless automated vehicle energizing system, referred to hereinafter as WAVES. WAVES complements the current development of an electric vehicle fleet and provides a primary means for achieving national “energy security” for U.S. vehicular transportation. The present invention presents a clear path towards the near- and long term elimination of battery technology limitations regarding range, charging time and associated lifetime cost and real-time performance trades. The present invention also provides the U.S. with a way to leapfrog over potentially severe investments in conventional mass transit, by providing similar gains in efficiency and carbon reductions as it complements our currently flexible roadway transportation based infrastructure. WAVES can be a very large factor towards achieving U.S. international commitments regarding greenhouse gas reductions.

In general, the present invention provides a wireless means of charging “all electric” and “hybrid electric” vehicle batteries and is applicable to stationary and moving vehicles (in parking spaces and within the roadway). The present invention is also scalable for both new production vehicles and as an add-on to existing vehicles. Intra-city use is an initial target, with inter-city and inter-state follow-on. Consistent with the needs of both private and public transportation vehicles, the present invention also includes a fee-based system whereby charges are automatically levied in proportion to energy use.

FIG. 1 depicts a means for seamlessly charging batteries of all-electric or plug-in hybrid electric vehicles under a variety of conditions, both statically while a vehicle is parked or otherwise stationary and dynamically while a vehicle is in motion, using WAVES 10. A distributed network 12 of parking/road imbedded Power Transmit Modules (PTMs) 14 are connected to a power grid 18 for primary power and wirelessly linked to a Power Receiver Modules (PRMs) 16 located in a vehicle 20 that is within proximity to PTM 14 for magnetic power transfer. Vehicle 20 generally comprises an electric motor 22, controller 24, and battery supply 26. Vehicle mounted PRMs 16 are interconnected to battery 26 to recharge battery 26 while vehicle 20 is stationary or in motion via magnetic coupling with PTMs 14.

The charging operation is automatic when enabled by the driver of vehicle 20, employing a wireless data communication links between PRMs 16 and each/any PTM 14 supplying power. PTMs 14 are in turn LAN (Local Area Network) and subsequently internet connected for energy billing. The intent of the static infrastructure of WAVES 10 is to provide energy “hot spots” whereby WAVES equipped vehicles can partially or completely recharge using individual parking area located PTMs 14. Dynamic charging is accomplished by the concatenation of additional PTMs as necessary to provide continuous wireless charging.

When dynamically charging, vehicle 20 is both recharged and energized on a continuous basis while in transit, providing a power transfer capability greater than that required by electric motor 22. The result being that subsequent to a long range trip, requiring perhaps many times the energy nominally available from battery 26, vehicle 20 leaves the highway with a battery in a high state of charge.

In either stationary or mobile mode, the driver can be automatically charged for energy use (and tolls as they may apply), such as in a manner directly analogous to the current EZ Pass system where a credit card account is periodically charged for usage fees.

It should be recognized by those of skill in the art that safety standards must be adopted for the effective implementation of WAVES 10 so that the various components of the present invention, including PTMs 14, PRMs 16, and associated grid power and internet interfaces, are designed for safe operation, meeting transportation, fire, electrical and magnetic field standards. For example, the Department of Transportation and National Traffic Safety Administration are pivotal sources of safety and compatibility standards that all U.S. based WAVES components must meet to insure roadway safety. Regarding magnetic field health standards, the present invention is designed to meet IEEE P1140 (a VDT standard) in the VLF band from 2 KHz to 400 KHz, with magnetic field strengths within the passenger compartment below 0.25 mG. Regarding electric field intensity health standards, WAVES meets IEEE P1140 with VLF band field strengths within the passenger compartment less than 2.5 Volts/Meter.

In a preferred embodiment, WAVES magnetic coupling fields alternate at a frequency at the upper portion of the VLF band. PTM 14 magnetic fields emanate through a Faraday shielded assembly with electrical fields of the power amplifier waveform and its harmonics attenuated to meet FCC radiated emissions limits. It is intended that all WAVES modules are U. L. approved as a first insurance of electrical safety. This implies that the design has been verified to prevent catastrophic fire and shock exposure under normal, worst case and failed modes of operation. Conservatively rated components, temperature control, rigorous power fusing, automatic shutdowns and fault detection and location are important design attributes in meeting overall electrical safety and reliability.

Reliable wireless data interlocking between PTM 14 and PRM 16 modules prevents power generation until a vehicle PRM 16 is in the immediate proximity of a given PTM 14. When immediate proximity is achieved, efficient power transfer is possible given that the vehicle has established a valid ID via two independent communications paths, i.e., a first proximity link 28 between the PRM 16 and PTM 14 and an internet or data link 30, as well as an additional and independent real-time check on vehicle presence via a valid second proximity link 32.

The inherently rapid attenuation of magnetic fields at distances beyond the 3 inch nominal roadway clearance between PTM 14 and PRM 16 means that the magnetic field strength is normally very weak at the floor level of vehicle 20. Free space magnetic attenuation can be expressed as proportional to 1/(distance ratio)³. Additionally, if the floor of vehicle 20 contains a suitably magnetically permeable material, such as iron or ferrite, this already weak magnetic field will be significantly further weakened by being shunted away from the passenger compartment. Furthermore, when PRM 16 is effectively coupling power from PTM 14, the majority of the magnetic field is shunted through the vehicle's PRM 16 with a significantly weakened field left to propagate across the remaining distance to the floor of the vehicle 20 (again at an attenuation factor equal to 1/(distance ratio)³). If desired, in-vehicle magnetic field sensing can be employed to alarm and otherwise inhibit a valid ID from being sent via the first proximity link, thus disabling PTM 14 power generation such as in cases of an accident.

Power transfer can only be enabled by the condition of two valid ID requests, one in relatively non-real-time via the Wi-Fi (radio) Data Link 30 and the other in real-time via the first proximity link (magnetic) 28. Note that first proximity link 28 operates through the same PTM coil 42 of PTM 14 utilized for magnetic power transfer to insure correlation with the power transfer footprint. The second proximity link 32 verification is an additional condition that must be met for power transfer. It operates independently from both the first proximity link 28 and the Internet access link 30 by utilizing a radio sensing subsystem. This 3-way enabling function in combination with Exciter Control criteria insure that no magnetic radiation occurs from any Power Transmit Module—Coil Electronics Subassembly (PTM-CES) 34 whenever there is not a PRM 16 directly above (or within adequate coupling range) of a PTM-CES 34. The requirement that all three conditions be met makes certain that there will be a valid vehicle PRM 16 ready to absorb energy and the presence of highly attenuated magnetic fringe fields due to the large range, vehicle PRM 16 absorption and chassis between PTM fields and vehicle passengers.

From the broader standpoint of traffic safety, WAVES 10 provides a basis for real-time comprehensive traffic density and speed data that are vital to an efficient traffic management system. This can include active feedback to individual vehicles or to traffic signals as well as to law enforcement.

WAVES Energy Requirements

The energy required by electric vehicles 20 traveling on a highway is dependent upon many factors including size, weight, speed, acceleration demands. At city traffic speeds below 50 mph the energy requirements are dominated by mass acceleration and tire/rolling losses. The average of these energy requirements, with dynamic braking significantly normalizing acceleration demands is, on average, less than the energy required at constant upper-end highway speeds. Therefore, WAVES 10 energy requirements are set by the more demanding high speed conditions. At approximately 40 to 50 MPH wind losses begin to dominate vehicle energy demands and wind losses increase disproportionately with increases in speed. Maximum highway speed as defined for WAVES 10 energy transfer purposes is set at 70 MPH, which is at or above most maximum legal speed limits within the continental US.

Electric vehicle miles per gallon equivalent is often expressed in electrical energy per mile or kilowatt hours per mile. The continuous required power for a vehicle 20 is then kilowatt hours per mile divided by hours per mile or “watts”. This continuous power requirement can be distributed equally across the number of coils within the vehicle's PRM 16 since its design efficiently combines individual coil powers to produce a single source of DC for vehicle battery 26 charging and motor energizing power. The vehicle PRM 16 insures that all of its pickup coils are energized (continuously) by sequentially enabling magnetic coupling from respective roadway PTM 14 transmitting coils as they pass under the PRM 16 pickup coils. It is then the net continuous power per PRM 16 coil that is at the core of the roadway electrical design requirement. The energy requirements for various scenarios may be seen in Table 1 below:

TABLE 1

| | 50 mph | 60 mph | 70 mph |
|---|---|---|---|
| Medium Sized Car | | | |
| Kilowatt hours/mile | 0.2 | 0.25 | 0.433 |
| Continuous Power - kilowatts | 10 | 15 | 26 |
| Total energy for 20 miles - kilowatt | 4 | 5 | 8.66 |
| hours | | | |
| Continuous Power Kilowatts | 0.71 | 1.07 | 1.86 |
| per PRM Coil (coil PRM) | | | |
| PHEV Bus or Truck | | | |
| Kilowatt hours/mile | 0.8 | 1 | 1.73 |
| Continuous Power - kilowatts | 40 | 50 | 86.6 |
| Total energy for 20 miles - kilowatt | 16 | 20 | 34.64 |
| hours | | | |
| Continuous Power Kilowatts per | 0.95 | 1.19 | 2.06 |
| PRM Coil (42 coil PRM) | | | |

It should be emphasized that WAVES 10 provides significant utility in offsetting the normally high 26 to 86 kilowatt rates of discharge from vehicle batteries 20 during normal operation. Repeated high discharge rates can be especially problematic, leading to lack of capacity and early failure, as batteries age and as battery temperatures are lowered during winter. By continuously offsetting the need for long periods of high rates of discharge, WAVES 10 provides the ability to dramatically extend battery life as well as range. From the above chart it can be understood that the maximum continuous power per PRM 16 coil, a core requirement, is 2 kilowatts. This is for practical purposes identical to the peak PTM-CES 34 magnetic field power requirement. Average PTM-CES 34 magnetic field power is less, dependent upon the traffic density induced energization duty cycle.

WAVES Roadway and Parking Lot Installation

Roadway 36 installations for the present invention may range from entire highway systems such as interstates to all or portions of local or intrastate highways to parking lots. Smaller scale installations can include segments of highways such as at traffic signals, waiting lines and other cueing areas where traffic densities are high and vehicle dwell times are sufficient to allow significant, although transient, battery charging intervals.

In the overwhelming majority of installations, roadways and parking areas already exist. Therefore an emphasis is placed upon existing roadway installations in a way that makes such installations cost-effective and as minimally intrusive as possible. This implies a set of national standards, an automated means of implanting PTM 14 modules and reasonable access to grid 18 and internet connection points. New roadway installations can however engineer required interfaces in a rigorous manner, thus avoiding retrofits and other perhaps more indirect methods to accomplish interconnectivity.

In either existing or new cases, subsequent to a WAVES 10 installation, the roadway 36 must provide a seamless transition across PTMs 14, with no effects upon drivability and safety. This implies that PTMs 14 have an ability to support worst case traffic loads, present a skid-free surface and be resistant to sun, oil, fuel, water, ice, salt, sand and temperature extremes. During roadway 36 installation, PTMs 14 are preferably imbedded within a V-shaped channel 38 cut along the centerline of each driving lane to form a PTM lane 40. The walls of roadway channel 38 are lined with salt resistant concrete, coated with asphalt or tar. The corresponding V-shaped bottom of PTM 14 is designed to fully seat into the roadway channel 38, continuously sealed along both side-walls, with the top surface of the PTM 14 matching the level of the roadway 36. Vertical traffic loads are thus translated to forces perpendicular to the side-walls of the V-Channel as downward pressure is exerted upon PTM 14, thus securing it within the roadway channel. This triangular implementation provides a robust installation, given that the trussed triangular cross section throughout the length of each PTM 14 translates load forces with minimal deflection.

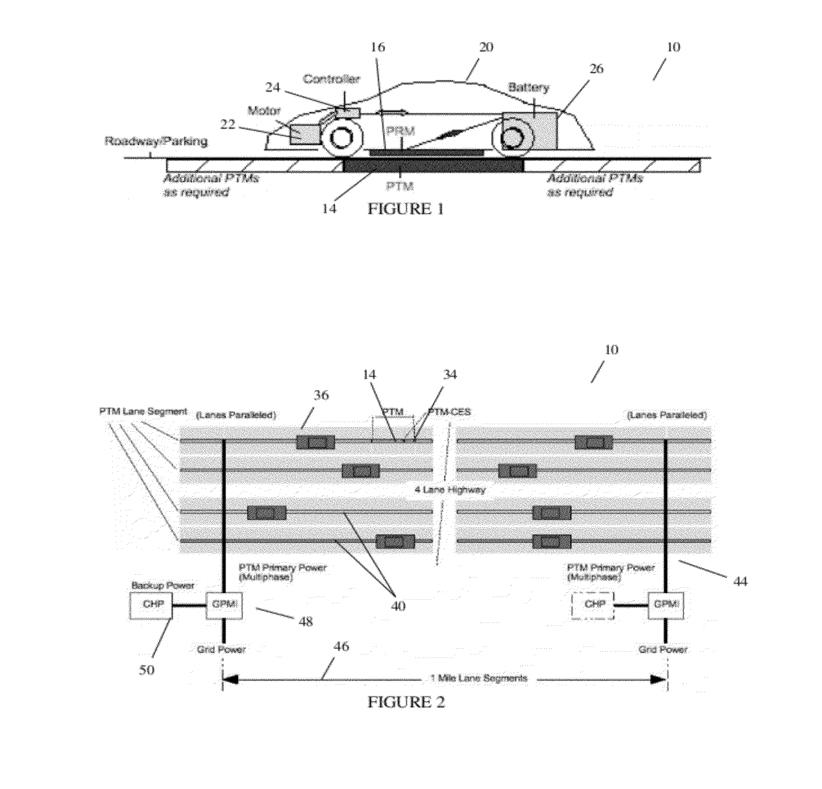

As seen in FIG. 2, a typical WAVES 10 system for roadway 36 is composed of continuous chains of PTMs 14 forming PTM lanes 40, with each PTM 14 containing many individual PTM coils and their associated PTM-CES units 34. PTM-CES units 34 provide the alternating magnetic fields that are the source of power coupled to vehicle mounted PRMs 16 as well as providing control and critical communications links. PTMs 14 thus create PTM Lanes 40 that are centered within vehicle driving lanes. A multi-phase primary power line 44 is routed within each PTM Lane 40, powering in parallel all PTMs 14 within a given PTM Lane 40. PTM Lanes 40 may in turn be paralleled for a given roadway to form segments 46 of WAVES 10. The boundary of each WAVES segment 46 becomes a potential grid interface point, implemented by grid power converters that bridge between the grid 18 and roadway segment 46. Due to the multi-phase nature of PTM 14 primary power interface provided by grid power converters, they are referred to as Grid Multi Phase Interfaces (GPMIs) 48.

The number of highway lanes and/or highway traffic density and type will determine the segmentation distance and the corresponding number of GPMIs 48 present. Combined Heat and Power (CHP) units 50 may be employed at GPMIs 48 to provide power backup to grid 18, peak power shaving for grid 18 during periods of intense overall usage (e.g. during rush hours and at noontime), or on grid 18 continuously, given favorable net metering contracting with the utility. It is not necessary to provide CHP 50 capability at each GPMI 48 to provide a significantly large margin of robustness to WAVES 10.

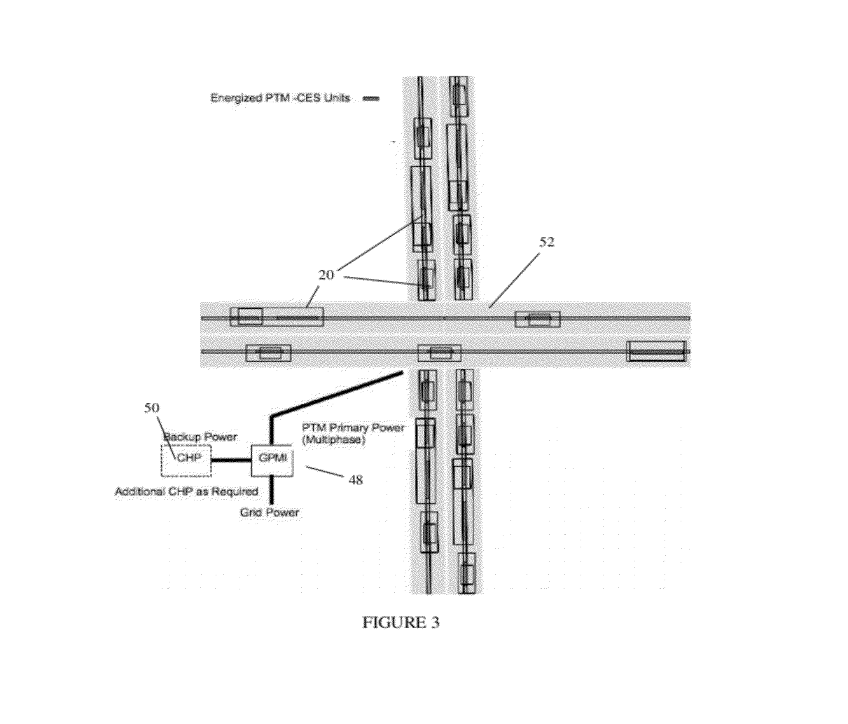

As seen in FIG. 3, power transfer at intersections 52 is a critical first step in the process of establishing a WAVES 10 roadway infrastructure. Given priorities of traffic density and grid interface proximity, such installations provide a relatively low cost and compact roadway installation format with a significant return on investment. The approach is to install PTMs 14 that fully “energize” the normal lane lengths associated with cueing and acceleration through and surrounding intersection 52. This arrangement allows stationary electric vehicles 20 to receive maximum battery charging while waiting for an intersection light to change, and full charging energy plus acceleration energy transfer when vehicles 20 leave intersection 52. The energy demands of accelerating vehicles 20 represent a significantly disproportionate battery energy drain that can be nearly eliminated via a WAVES 10 energized intersection 52. Furthermore, electric vehicles 20 that are simply passing through intersection 52 on a green light also benefit by a relatively short period of full charge rate and full electromotive energization. Since the cruising energy demands for EVs are modest at urban speeds, a network of such WAVES intersections 52 within a city environment can nearly fully provide the energy needs traffic without having to electrify gaps between intersections 52 such as would be the case in a full WAVES roadway 36 installation.

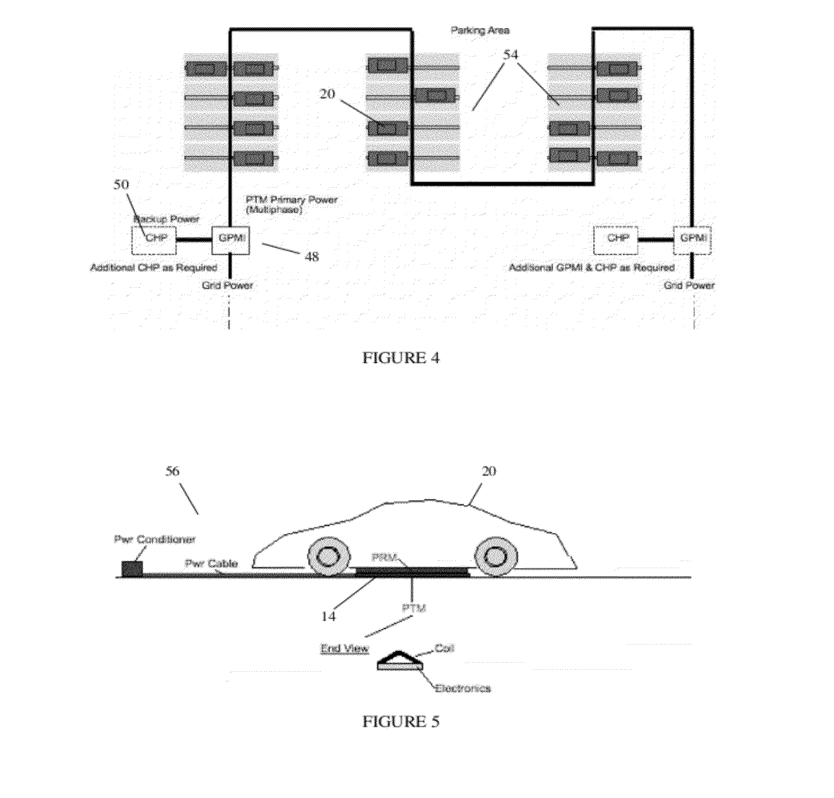

Parking lots 54 can be served by single or multiple GPMIs 48. The power demands of vehicles 20 associated with parking lots 54 can be on the same order as the per vehicle power demands of a highway, since battery charging alone can readily be in the kilowatt level. CHP units 50 may also be employed at parking lot systems, as seen in FIG. 5, for the same reasons as for highway installations. Additional loads such as from vehicle air conditioning or heating could also be significant power additions. As seen in FIG. 4, there is flexibility in PTM 14 and GPMI 48 configurations for parking lots 54.

As noted within Table 2 below, parking lot individual car charging rates are conservatively limited to 15 KW while larger vehicles 20 are limited to 45 KW such that the continuous per PTM coil power is limited to approximately half of a coil's peak power rating. Note also that a 1 to 10 ratio of Plug-in Hybrid Electric Vehicle (PHEV) or all electric (EV) trucks & buses to cars has been maintained for the purpose of this analysis.

Given approximately a 70%-30% split between battery charging power and auxiliary power (e.g. air conditioning and heating) there remains significant power to provide upwards of 10 KW or 10 KWh/hour of battery energy recovery. This would be sufficient for approximately 20 miles of travel in a car traveling at 70 mph, or correspondingly, 160 miles of travel for an 8 hour work day charge. The ratio of battery charging to auxiliary power for trucks and buses may be different depending upon refrigeration and other demands.

TABLE 2

| | 100 | 200 | 400 |
|---|---|---|---|
| Parking Medium Sized Car | Spaces | Spaces | Spaces |
| Per Vehicle Charging + Aux. Power - | 15 | 15 | 15 |
| kilowatts | | | |
| Continuous Total Power - kilowatts | 1500 | 3000 | 6000 |
| Total energy for 8 hours - kilowatt | 12000 | 24000 | 48000 |
| hours | | | |
| Continuous Power - kilowatts | 1.07 | 1.07 | 1.07 |
| per PRM Coil (14 coil PRM) | | | |
| Parking PHEV or EV Bus/Truck | 10 Spaces | 20 Spaces | 40 Spaces |
| Per Vehicle Charging + Aux. Power - | 45 | 45 | 45 |
| kilowatts | | | |
| Continuous Total Power - kilowatts | 450 | 900 | 1800 |
| Total energy for 8 hours - kilowatt | 3600 | 7200 | 14400 |
| hours | | | |
| Continuous Power - kilowatts per | 1.07 | 1.07 | 1.07 |
| PRM Coil (42 coil PRM) | | | |

It is useful to consider the case of retrofitting an average interstate highway system such as the New York State Thruway (I-90) as an example of the implementation of a WAVES 10 according to the present invention. The typical peak vehicle density for this particular highway under normal driving conditions is approximately 160 vehicles 20 per mile across a total of 4 lanes, 2 lanes running in each direction. With an average traffic mix of 90% cars and 10% buses or trucks traveling at 70 mph it is estimated that the instantaneous peak power demands of a one mile interval would be 5 megawatts. This 5 megawatt primary power demand is satisfied by a single power converter station or GPMI 48 that is grid interconnected at its input side and outputs multiphase power as primary power input to connected PTMs 14. Thus, a 6 phase GPMI 48 would produce 6 PTM primary power lines at 5 MW/4 Lanes/6 phases for approximately 200 KW per lane phase, as seen in Table 3 below:

TABLE 3

| | | | |
|---|---|---|---|
| Vehicle Traffic @ 70 MPH | Light | Medium | Heavy |
| 90% Cars 10% Trucks and Buses | | | |
| Vehicles/mile (4 Lanes) | 40 | 80 | 160 |
| Avrg Vehicle Spacing within Lane - | 528 | 264 | 132 |
| Feet | | | |
| Average PTM-CES Duty Cycle - % | 10.18 | 20.36 | 40.73 |
| Kilowatt Hours per Mile | 22.508 | 45.016 | 90.032 |
| Continuous Power - Kilowatts | 1280 | 2560 | 5120 |
| Lane Power per Phase - Kilowatts | 53.33 | 106.67 | 213.33 |
| Current per Phase @ 4 KV - Amperes | 13.33 | 26.67 | 53.33 |
| DC Ohmic Loss of #10 Gauge Wire | 0.88 | 1.77 | 3.53 |
| per Mile - % | | | |

Four kilovolts (4 kVAC) has been chosen as the PTM primary power distribution voltage as a reasonable compromise between the need for low (Î2)*R losses and requirements for high voltage safety and reliability. At 4 kilovolt per phase, the maximum current drawn by each lane phase would be 50 amperes which is sufficiently low to ensure low losses with modest gauge conductors. Note that the #10 gauge conductor reference in Table 3 is an “equivalent” reference and will be made up of individually insulated metal foils with sufficient area to achieve bulk resistance and skin effect losses equal to the DC resistance associated with a #10 gauge solid round copper conductor. Skin effect begins to be a significant loss factor for power transmission frequencies that are within the VLF band as detailed in Table 4 below.

TABLE 4

| | Estimated | | | | | Al Foil Width @ 1 |
|---|---|---|---|---|---|---|
| Aluminum | Resistivity | Resistivity | Combined | #10 | Area | skin depth thick |
| Foil | Incr. | Increase | Area | gauge | required | t@ 60 kHz eqv DC |
| 1 skin | due to skin | Ratio to | increase | Area | for Al Foil | Resistivity to #10 |
| depth thick | effect | Cu | factor | (inch\hat{ }2) | eqv | gauge Cu |
| 0.0106 | 1.2 | 1.64 | 1.968 | 0.00817 | 0.01607856 | 1.51684528301887 |

A GPMI 48, spaced nominally at an interval of 1 mile along a highway, such as 1-90, forms a 4 lane PTM segment 46. In cases where peak power demands of a particular segment might exceed the capability of a given GPMI 48, the connectivity between GPMIs 48 along the multi-phase PTM primary supply lines provides a means for borrowing energy from adjacent segments when available. The multiphase wiring of the PTM primary supply line provides an additional degree of redundancy since individual phase failures gracefully degrade the power transmission capability of any affected PTMs 14.

From a backup power perspective, natural gas/fossil fueled micro-turbine electrical power generation may be used and spaced strategically, at perhaps 20 mile intervals, in conjunction with a GPMI 48 located perhaps at service/rest stop areas. For example, a micro turbine generator capable of 1 MW available from Capstone Turbine Corporation of Chatsworth, Calif. can be readily grid inter-tied to produce efficient (28% natural gas to electrical efficiency) and continuous grid power in parallel with an operating grid or as the case may be, emergency backup power for both a roadway segment and an associated service area. A 1 MW micro-turbine generator can also be configured as CHP unit 50, supplying the heating and air conditioning loads of the service area itself. A quantity of six such CHP units 50 can continuously provide 6 MW of electrical power (grid tied or backup) while also producing 100 million BTU per hour (@580 deg. F.) of thermal energy. Given the availability of natural gas or another suitable fuel, such CHP units 50 can pay for themselves during normal operating periods, while insuring the availability of vehicle charging power under grid failure conditions. During grid outages the availability of backup lane segments spaced every 20 miles gives vehicles 20 an opportunity to acquire a full charge at an associated rest stop parking area or, if sufficient energy exists within the vehicle's battery 26, continue on with the original journey with some assurance of periodic future boosts in charge.

From a renewable energy perspective, photo-voltaic (PV) powered grid inter-tied inverters, co-located along the highway, may be used to mitigate greenhouse gas generation as well as shave some of the peak grid loads during daytime periods. Shaving one half, or 2.5 MW of the GPMI's worst case vehicle traffic load, using PV power generation, would require an array (@ 20% efficiency) that is 1 mile long by 20 feet high (the entire segment length). This is not a totally unreasonable requirement for many areas along a typical interstate highway system and could readily pay for itself in energy savings alone over a 20 year period.

WAVES Household Installation

Referring to FIG. 5, household WAVES installations 56 differ from roadway and parking lot installations by the need for lower cost and a more simplified PTM 14 installation. PTM 14 for household garage or driveway may be constructed as a raised mat-like assembly 58 that can be simply laid down upon a flat surface, over which the vehicle's PRM 16 is centered. The raised midsection houses a row of PTM-CES units 34 in a sealed, waterproof housing 60.

Transmitting coils are located at the top-most portion of the rib-like midsection 62 of PTM 14 such that it reaches within 3″ of the vehicle's PRM 16 (while retracted). Rib 62 has a triangular cross-section pointed upward forming an easily cleaned top surface that prevents debris or animals from resting thereon. PTM 14 is designed to interface directly to 220 VAC 60 Hz power mains, and is capable of continuous vehicle charging at a rate of 6.6 kW. The design of household installation 56 could be similar to the electrical design of the current 3 coil demonstration prototype described below, with additional power amplifiers & Tank Coils, as also described below.

WAVES Light Rail and Electric Transit Bus Installation

WAVES technology according to the present invention provides a means for supporting light rail and electric bus systems by minimizing electrical and control infrastructure while enhancing efficiency. The use of PTMs 14 embedded within trackways or bus lanes facilitates the use of electric motor drives fed wirelessly, without overhead wires, hot rails or associated moving mechanical contacts. Control system automation uses the existing PTM data link 30 allowing spacing and other vehicle data to be managed in a way to provide real-time feedback for collision avoidance, scheduling and integration with other roadway traffic. Positional, velocity and vehicle ID data is particularly effective in maintaining safety in cases where light rail or bus traffic is interspersed with normal traffic. In such traffic, vehicles 20 of all types share a common PTM 14, however may have individual PRMs 16 optimized for particular applications. Batteries 26 on board light rail and bus vehicles 20 provide a means for storing braking energy and otherwise limit peak energy demands. Distributing PRMs 16, motors and energy storage within each “car” of a transit vehicle 20, inherently scales its ability to meet transport propulsion needs. In this way, long trains of many cars are possible with minimal added integration.

WAVES Return on Investment

It is important to consider how investments in WAVES infrastructure will be paid for, and the fairness doctrine that can be employed to insure long term acceptance. Grid energy has a cost that varies with the type and location of power sources which in turn can vary throughout the day and days of the week. The instantaneous cost of energy to the driver can and should be adjusted both to provide fair price to the grid but also as a way to provide adaptive choices that drivers can use to minimize their driving expenses while at the same time providing the power grid with greater capacity margins. Thus at peak driving times such as early morning, noontime and early evening, the cost per kilowatt-hour passed to the driver may be substantially greater than at other times of the day. The driver may in turn choose other commute times or avoid engagement the PRM during these times.

The cost of the grid supplied energy is however only one factor in determining the final cost per kilowatt-hour passed along to the driver. A toll can be assessed in addition, that reflects the long term investment infrastructure required to put WAVES in place on a given highway as well as shorter term maintenance costs.

A third factor added to the final cost per kilowatt hour is that of the peak power utilized by vehicle 20 such as to achieve optimum utilization of WAVES power supplying equipments. The objective of the peak power utilization surcharge is to reduce the probability of having to increase existing capacity or of over-stressing existing power generation and distribution equipments. Such a surcharge can be dynamic in that the charge is traffic density based with a utilization cost assessed as a factor of the energy used at any one interval of time and associated with traffic density or instantaneous electrical load on the system. Thus, higher energy users such as trucks and busses end up with higher costs for the energy that they use during times and locations of intense overall energy use.

On-board vehicle computer controller 24 can be programmed to consider all of these cost factors in deciding what route to take or when to activate the vehicle's PRM 16, which of course would include the vehicle's battery and its state of charge.

Parking lot located WAVES 10 offer some additional billing considerations. Parking lots associated directly with businesses may wish to incentivize use based to attract customers. The cost of delivered energy could be made artificially lower to accomplish greater visitation and/or be based upon a customer's purchases or history. Other factors that may be additionally attractive or simply deemed parking services, is that of supplying energy for vehicle air conditioning or heating while the vehicle is left unattended. This promotes safety and comfort while at the same time reduces the amount of energy required to overcome the accumulated environmentally induced loads once the vehicle leaves the parking area. WAVES 10 provides opportunities to employers wishing to pass along perks or incentivize certain employee habits by providing smart parking lots.

And finally, it must be stated that as with highway GPMI grid power backup, CHP micro-turbine generation can be used at businesses local to parking lots. This grid parallel inter-tie form of connection not only provides emergency backup electrical power for both business and WAVES during grid failure events, but also increases the level of overall net efficiency of heating, cooling and electrical power to nearly 90% for CHP GPMI associated businesses and highway vehicles 20.

It is also viable to consider the addition of renewable energy sources as a way to reduce environmental impacts associated with fossil fueled power generation and shave daytime load peaks from the grid. Specifically, regarding the use of PV renewable sources, it can be noted that typical parking areas represent extremely large areas of real estate, capable of receiving PV arrays with minimal impacts upon vehicle 20 use. Thus such a large amount of renewable energy, in direct proximity to point of use represents an efficient power source while at the same time offering an additional source of revenue and payback.

WAVES Grid Power Interface

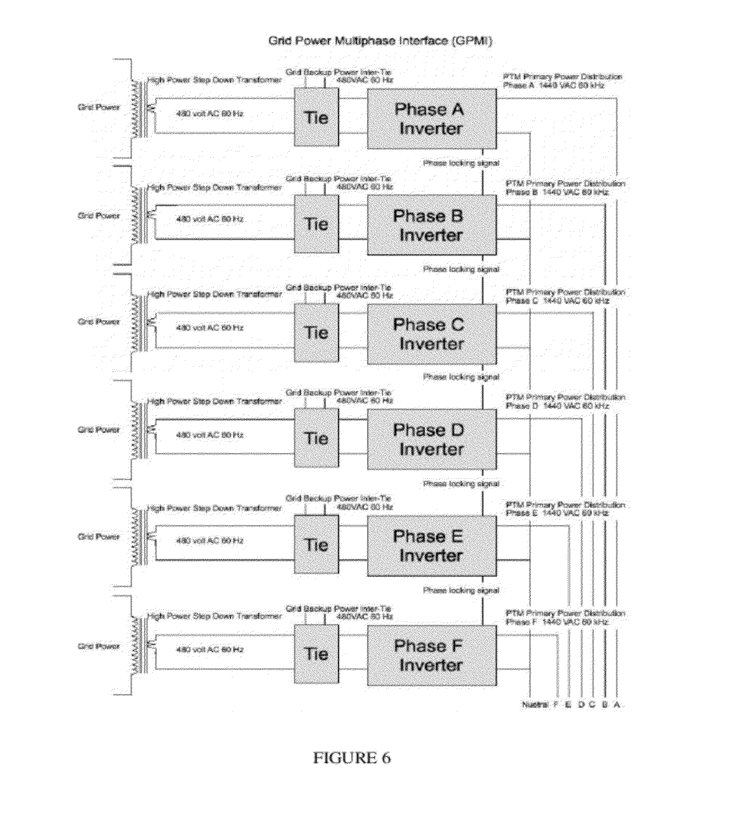

Referring to FIG. 6, grid power 18 is interfaced nominally at mile lane intervals using high efficiency multi-phase solid state inverter units (GPMIs 48) that transform 60 Hz grid power to kV level high frequency multi-phase AC for PTMs 14. Normally a single GPMI 48 supports 4 lanes of PTMs 14 over a mile interval, providing up to 300 KW of high voltage & high frequency multiphase power to a nominal string of 5000 PTM-CES 34. GPMIs 48 also bridge fiber data to and from the internet for billing, status, control and other purposes. GPMIs 48 can be connected in parallel for added robustness and reliability within a given PTM interval or segment. This can be done at each GPMI by bussing one PTM string to the following one, simultaneous with each GPMI interface. GPMIs have capabilities to disconnect from the power grid and from each other during failure conditions.

Normal grid power is in the form of high voltage and current 3 phase 60 Hz grid power to a set of lower voltage 480 VAC, 3-phase power, using 6 transformers 64 (or a single 3-phase transformer). A subsequent tie circuit 66 associated with each of the 480 VAC Phase Inverter 68 feeds allows for the decoupling of a given 60 Hz phase from the grid under failure or maintenance conditions, or the introduction of alternate sources of power. Such alternate sources can be an external CHP 50 whereby grid power 18 is supplanted entirely (grid failure mode) or simply “or-tied” for purposes of peak load sharing and net metering. Additionally, since the phase inverters 68 are insensitive to 60 Hz phase relationships (each having internal AC-DC rectification), there is the capability to simply bring in another source of 60 Hz power as a backup. The following set of 6 Phase Inverters 68 (A through F) are phase synchronized to produce properly phased relationships on their outputs that directly feed PTM 14 segments.

The design of the Phase Inverters 68 may be based on a “transformerless” IGBT approach. In a concatenated roadway segment implementation, each Phase Inverter 68 will be phase-locked to its respective incoming phase from the adjacent segment, thus allowing for a direct inter-tie between segments. This is not a firm requirement because segments can be operated independently; however, by inter-tying segments, power can be passed between segments or otherwise directly shared, thereby enhancing overall robustness of the roadway energizing system. Furthermore, such an inter-tie prevents an open transmission line effect which may require active termination (variable load via multi-phase AC to DC to grid (or other) inter-tie inverter(s)) to reduce reflections back through the segment.

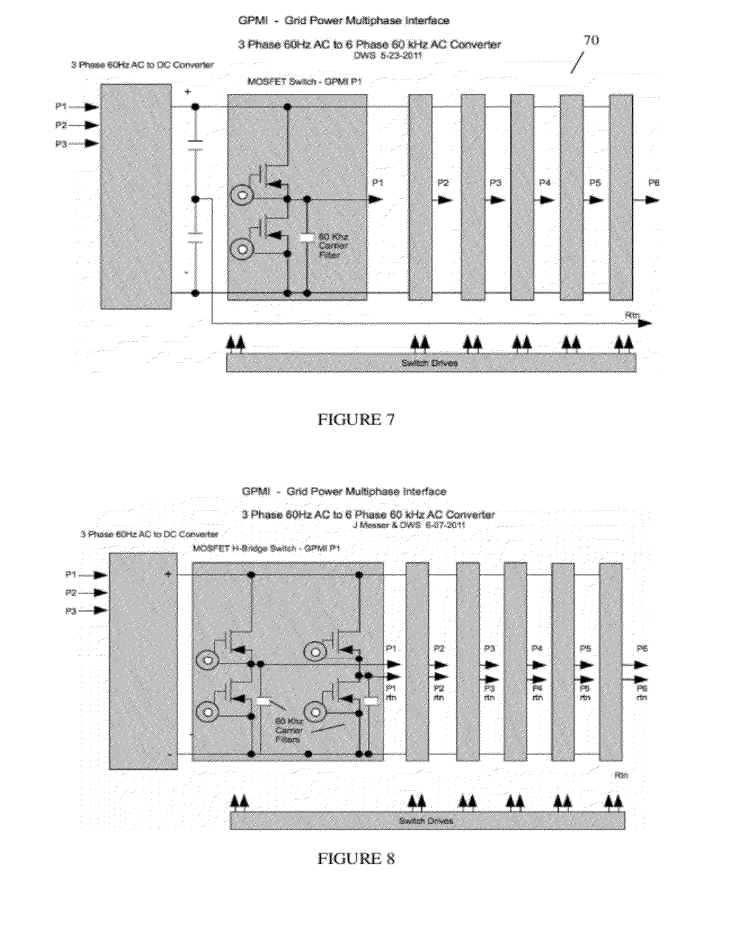

Alternative GPMI 48 designs can be configured that do not employ transformers. This promotes reductions in GPMI 48 cost, weight and size. FIG. 7 depicts a series of 6 half H-Bridges 70, one for each phase being generated. A common return is established by a split capacitor 72 on the 60 Hz primary feed. FIG. 8 depicts a full H-Bridge configuration wherein separate returns are available from each phase bridge. In both configurations resulting high-frequency power carrier phases from each phase pass through respective output filters that reduce harmonics associated with the square-wave switched waveform. The full H-Bridge configuration is particularly attractive and fits nicely with proposed RTC magnetic connector based step-down transformers feeding PTM loads.

Power Transmit Module (PTM) Primary Power Distribution

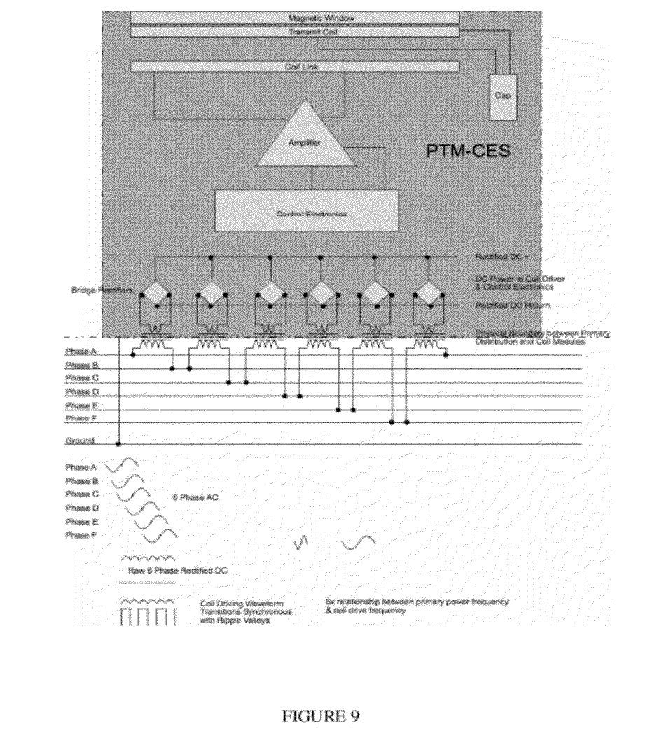

Referring to FIG. 9, high frequency multiphase (6 phase) PTM primary power is magnetically coupled to each PTM-CES 34 in a phase parallel configuration throughout a given energized roadway lane or parking area. Transformer/magnetic links for each phase at each PTM subassembly efficiently step down the multiphase 4 kVAC primary distribution voltages to the order of 400 VAC per phase at each PTM-CES 34. This same transformer mechanism provides a conductor-less connector for routing primary power to the input of each PTM-CES 34. The multiphase primary power frequency is preferably an exact division by 6 of the PTM carrier frequency to thus provide a rectified ripple waveform which is in exact synchronism with the switching waveform that generates the PTM coil magnetic power field. A way to guarantee such a relationship is to individually “phase lock” each PTM-CES 34 High Power Amplifier drive signal to the rectifier ripple frequency or incoming AC phase power waveform. In this way DC filtering requirements are significantly reduced by the matching coincidence between power amplifier peak power demands at each ½ cycle to the peak of the rectifier ripple/each of the rectifier conduction peaks. Subsequent DC filtering thus can be limited to that of the much higher frequency switching transients while at the same time the lack of significant mismatch between voltage and current demands maintains a unity power factor load on the 6 phase Primary Power. Unity power factor is particularly important in minimizing PTM primary power distribution losses associated with non-unity induced reactive currents. The multiphase nature of this power distribution also allows the AC transmission frequency to be lowered by a factor equal to the number of phases, thus reducing AC transmission losses including both dielectric and skin effect losses by using this lowered frequency. This intermediate 6 phase power remains significantly high to allow the manufacture of relatively small, efficient and low cost step down transformers within the RTC. Thus, the important factors leading to an efficient PTM lane based primary power distribution system that are addressed by the present invention are: KV level distribution voltages and associated PTM-CES local step-down transformation to reduce IR transmission loss; Sufficiently high phase frequencies to minimize step-down transformer size and loss but not too high (essentially providing a sweet spot in cost/performance); Multiphase rectification synchronous with magnetic field generation to achieve unity power factor with minimized filtering and conditioning electronics to prevent reactive current circulation; and Multiple phases to lower distribution frequency thus reducing AC skin effect, dielectric and radiated field losses.

Ripple in Full Wave Rectified Waveforms for Multiple Phases

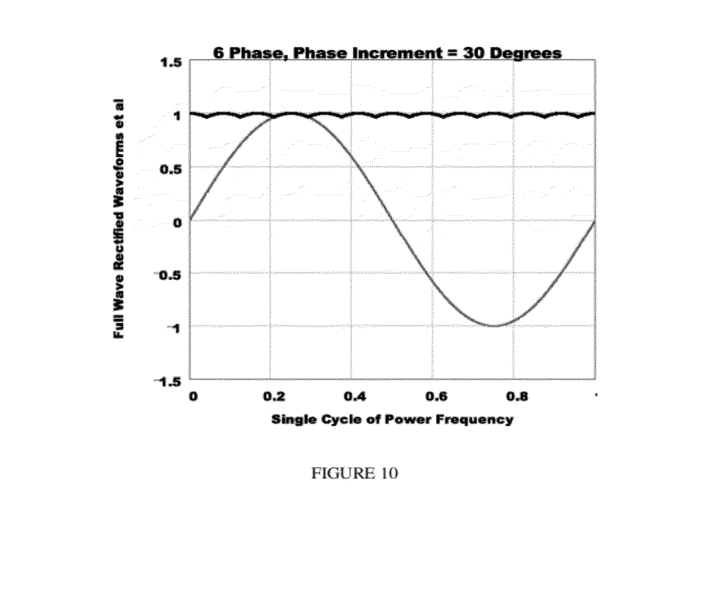

Each phase of a multiple phase system is full wave rectified and the outputs combined to provide a DC power source. When all six rectified phases are combined the resulting DC waveform has a ripple as shown in the subsequent waveform of FIG. 10. In high power applications it is especially difficult to effectively filter out such ripple.

Historically, all high power multiphase generation was achieved with rotating machinery. Under these conditions, mechanical constraints on coil winding and placement in the alternator forced generated phases to be uniformly spaced over 360 degrees. That is, the phase increment between adjacent phases was 2 π/N_{φ} degrees, where N_{φ} is the number of phases. Thus a 3 phase system had 120 degrees between phases, a 4 phase system had 90 degrees between phases, etc.

With modern high-power solid state inverters, the interval between phases can have any desired value. This phase is no longer constrained as it was in the past with machinery based multiphase alternators. This flexibility is used within WAVES 10 to synchronize ripple peaks in the rectified dc output voltage with demands for maximum power transfer at the coil amplifier. This insures that maximum power transfer is achievable without energy storage or costly filtering requirements. In particular, in WAVES 10 it is desirable to have a phase increment equal half of what it would have been for rotating machinery. Table 5 below summarizes ripple peaks for electronic and rotating machinery generation, where N_{φ}=Number of Phases.

TABLE 5

| Increment Between | Number of Ripple Peaks per Cycle of Power Input | |
|---|---|---|
| Adjacent Phases | Odd Number of Phases | Even Number of Phases |
| 2 π/N_{φ} | 2 N_{φ} | N_{φ} |
| π/N_{φ} | 2 N_{φ} | 2 N_{φ} |

Thus, the number of ripple peaks per cycle is 2 N_{φ} for all combinations of phase intervals and even or odd number of phases, except for the larger phase interval combined with an even number of phases (where it is reduced to N_{φ}).

Power Transmit Module (PTM) Magnetic Power Transmission Control

Vehicle mounted PRMs 16 contain a first proximity wireless link 28 that is used to enable power transmission at each roadway PTM 14 as PRM 16 passes over them. This power enabling signal is demodulated at each PTM 14 subassembly to reveal the vehicle's ID that is used in conjunction with a valid vehicle ID obtained from a fiber cable based Data Link (routed internally within each PTM) to enable power transmission to vehicle 20.

The degree of power coupled to a given vehicle 20 is limited by the maximum power capability of each PTM 14, aggregated by the number of simultaneously enabled coils and their respective instantaneous magnetic coupling coefficient (as expressed between PTM 14 and PRM 16). Furthermore, due to the parallel resonant transformer primary formed at each PTM-CES Tank Coil 74, the power required by each coil driving amplifier within the associated PTN-CES 74 subassembly is directly equal (minus relatively minor losses) to the power coupled to the vehicle. The amount of energy (power×time) provided by each PTM 14 is thereby measured for each vehicle passage and reported over the internet for billing purposes, along with other status information that has been acquired both organic to PTM 14 and from wireless data link 30 derived data. It should be noted that PTM 14 segment power demands can be capped at a power limit, as for example during above normal traffic loading, by purposely inhibiting individual or groups of PTM-CES units.

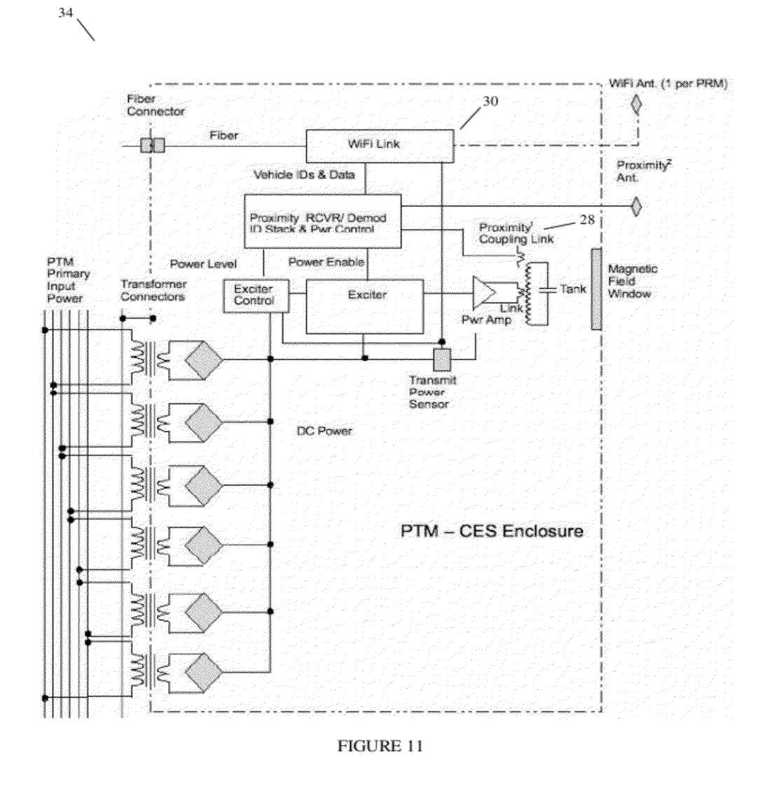

There is seen in FIG. 11 PTM-CES 34, including data links 28, 30, and 32, power control 76 and reporting 78 (note a Phase to Phase Input Power cable format is shown as an option, and other options include common ground and individual paired phases with respective grounds). PTM 14 coils “light up” in rapid sequence as a vehicle PRM 16 passes over, only to just as rapidly power down again after a given vehicle's passage, ready for the next vehicle. This forms “waves” of power transfer that travel with and under each vehicle.

A high bandwidth WiFi wireless Data Link 30 is maintained between vehicle PRM 16 and roadway PTMs 14 (providing 2-way internet access, using PTM 14 contained fiber optic cables) for purposes of supplying required vehicle validation, billing and Performance Monitoring and Fault Location (PMFL). Data Link 30 has sufficient additional capacity to provide vehicle occupants with direct access to the internet while en-route. The WiFi nature of Data Link 30 communications allows for continuous access while a vehicle is on a WAVES 10 equipped highway, even while crossing lanes or otherwise not in direct magnetic power coupling range of a PTM 14. It should be noted that all highway vehicles preferably need access to this wireless Data Link 30, whether WAVES 10 equipped, fossil fueled or otherwise. Universal Data Link 30 connectivity enables features associated with traffic control, law enforcement and general communications to be available from to and from all vehicles 20 on the highway. Traffic safety, efficiency and related labor cost reductions strongly drive for the universal adoption of a generic WAVES wireless Data Link 30 standard.

Control signals are also sent via PTM 14 contained fiber optic cables to enable or disable individual or multiple PTM-CES 34 within a lane as may be required for maintenance or other purposes. Control and monitoring functions can be highly automated, centralized and remotely located from WAVES 10 equipped highways. Performance monitoring at each PTM-CES 34 is used to insure safe power generation under worst case loading and transmitted power levels as well as to report failures for future maintenance. PMFL includes thermal, over current and over voltage sensing to insure safe amplifier operating conditions at each PYM 14 coil subassembly.

Power Transmit Module (PTM) Spectrum

In a preferred embodiment of the present invention, PTM-CES 34 coils are nominally operating at 360 kHz. This is roughly in the middle of the U.S. FCC VLF sub-band from 305 kHz to 405 kHz allocated for the dual purpose of both Aeronautical Communications (radio beacons) and Aeronautical Mobile (communications). WAVES 10 will be treated by the FCC under radiated and conducted emissions regulations/standards similar to that of other electrical appliances, as in electric vehicles, computers, TVs, inverters etc. that have internal high power electronics operating within this radio spectrum. WAVES 10 wireless power is coupled as a magnetic field, through a magnetic window, with electromagnetic shielding and filtering designed to avoid unintended emissions from both PTM and PRM. The power carrier itself is narrowband with PTM-CES tank coil 74 Q's greater than 10 during full power coupling. Standard EMI verification can be conducted (similar to tests that are routinely performed on military electronics) to insure that all demonstration tests will comply with FCC regulations for both fundamental and harmonics of the power carrier.

Primary Power Distribution (6 phase) Spectrum

Direct division of six of the PTM 14 operational frequency, thus nominally 60 kHz each phase. Due to National Time Code usage of the 60 kHz channel, the suggested operational frequency should most likely be just below or above the time code spectrum. Thus, PTM 14 operating frequency would be above and below 360 kHz by a factor of 6 times the difference in primary power frequency respectfully above and below 60 kHz. The cable shielding and multiple phase nature of the primary power distribution should greatly attenuate any unintended RF radiation at 60 kHz.

Power Transmit Module (PTM) Roadway Interface

PTMs 14 are sealed and ruggedly built triangular “conduit-like” modules 80 containing 50 individual PTM 14 coils and their associated PTM-CES 34. Each PTM 14 contains a concatenated line of pre-installed PTM-CES 34 units along with associated internal power and data cables. Weather-tight electrical and fiber optic feedthroughs at each end of a PTM 14 provide the means to rapidly chain PTMs 14 in series as they are installed within a roadway.

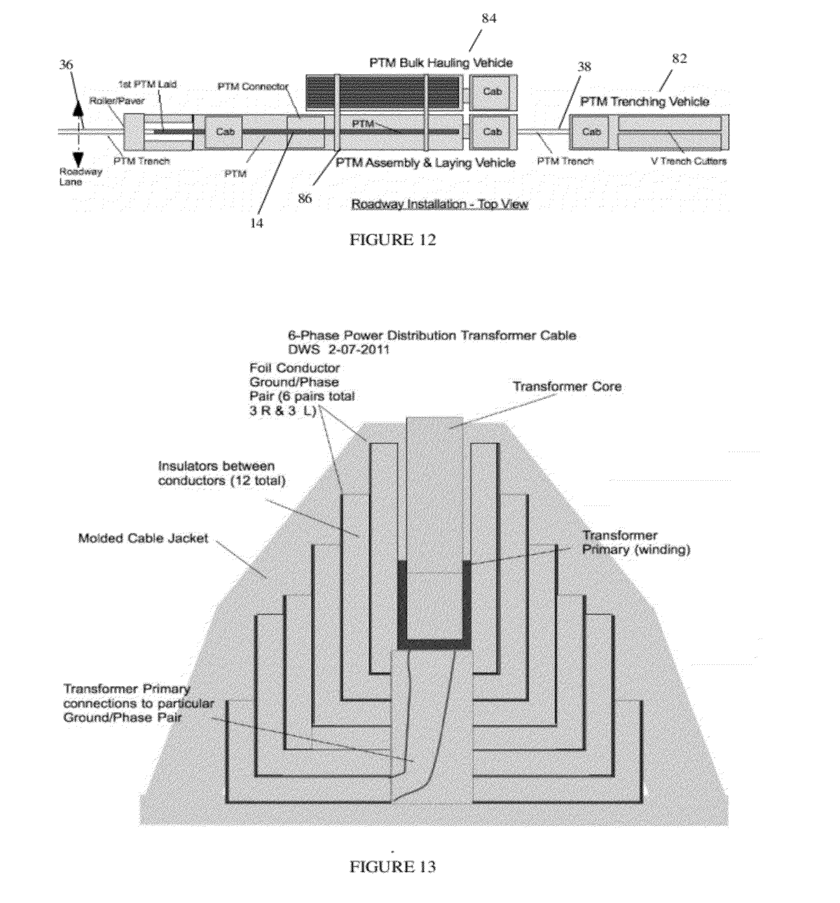

Referring to FIG. 12, installation involves preparing a V channel 38 into which PTMs 14 are laid. This operation may be performed by a trenching vehicle 82. Bulk delivered unconnected PTM modules are robotically offloaded from a bulk hauling vehicle 84 directly on to an Assembly and Laying Vehicle 86. The Assembly and Laying Vehicle 86 lays a primary electrical power cable (RTC) 88 followed by successive PTMs 14. PTMs 14 are nested end to end to form a continuous assembly within roadway 36. Joined PTMs 14 are then pressure and electrically tested prior to and after the last operation which lays the PTM 14 assembly into the previously prepared PTM Trench, sealing it against the trench walls and rolling it flush to the roadway surface. This process produces a contiguous, operational PTM lane from the rear of the Assembly and Laying Vehicle as it progresses down the highway.

Note that PTM-CES 34, pre-installed within each PTM 14, are designed to be separately removable/replaceable for in-field servicing of roadway installed PTMs 14. The multi-phase primary input power to PTM-CES 34 units utilize magnetically coupled transformer links and blind-mated electrical and fiber connections to promote ease and reliability of this process. Table 6 below details the preferred specifications for PTMs 14:

TABLE 6
PTM Physical Specifications

| | |
|---|---|
| Length - Feet | 40 |
| Width - Feet | 1.3 |
| Depth - Feet | 1.5 |
| Basic Shape - Cross Section | Triangular |
| Weight - Pounds | 500 |
| Volume - Cubic Feet | 46.8 |
| Pounds per Cubic Foot | 10.68 |
| Power Leads - # | 7 |
| Power Lead - Connections at Each End | Pigtails - Weldable |
| Data Leads - # | 2 |
| Data Leads - Connections at Each End | Pigtail - Fusable |
| Mechanical Connection at Each End | Flange - Weldable |
| Number of PTM-CES Units per PTM - # | 50 |

Power Transmit Module (PTM) Interface to Roadway Transformer Cable (RTC)

PTM 14 electrical components include multi-phase power wiring that supports not only the entire electrical power demands of a given PTM but also carries significantly higher levels of power required to sustain an entire lane segment. Utilizing high voltage AC power distribution minimizes currents and respective Î2R and skin effect losses associated with powering PTM 14 segments. Each PTM-CES 34 is connected to the multi-phase distribution running through a given PTM 14 by a set of six magnetically coupled transformer links 90 that serve to provide a safe, weather resistant, contact-less and reliable connector. Thus, this multi-phase power wiring is referred to as a Roadway Transformer Cable (RTC) 92. Magnetically coupled RTC transformer power connectors 94 are located below each PTM-CES 34 of a PTM 14. Each individual phase link forms a transformer with a physically separable core that enables a tight magnetic flux connection from primary to secondary when the core halves are brought together as PTM-CES 34 units are seated within the roadway. The primary side of each transformer link 90 is connected between one of the six multi-phase power lines to a neutral or paired ground conductors and performs a voltage step-down function (current step-up), in addition to the connection function, as a result of the ratio of turns between primary and secondary halves of the transformer.

To facilitate the manufacture of the RTC 92, individual transformer primary windings contain programmable taps 96 that are welded to respective phase conductors within the RTC 92. Each primary within a 6-phase sequence will select a unique ground/phase pair via programmable bonds thus allowing for a common transformer primary and associated cable construction. The use of multiple ground in parallel, paired with an appropriate phase allows for further reliability in these phase connections. Final molding of a surrounding insulating weatherproof outer jacket during manufacture encapsulates bonds, conductors and transformer primaries, as see in FIG. 13.

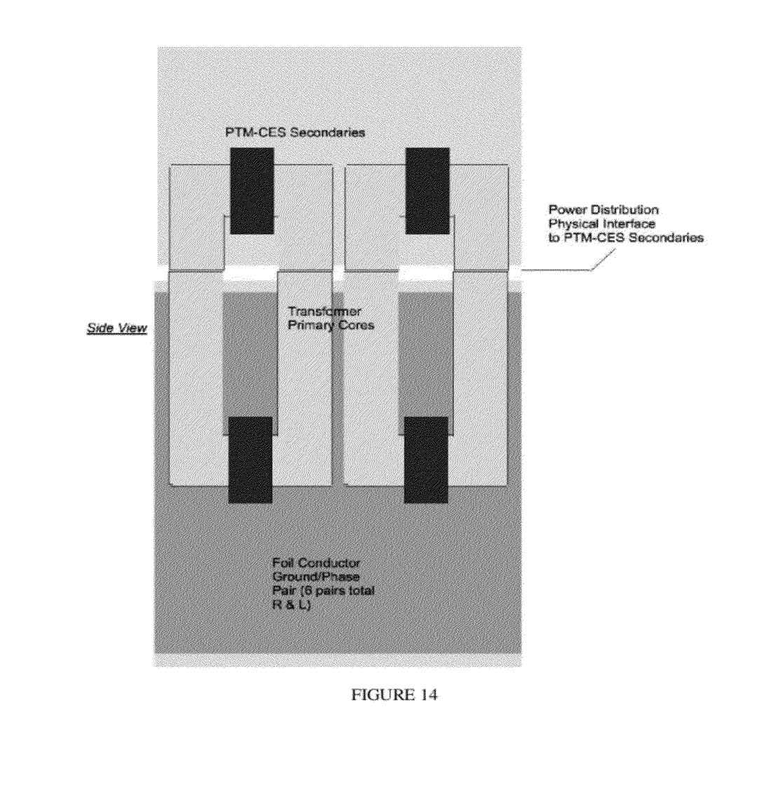

Multiple PTM-CES 34 sets of magnetically coupled transformer links 90 are thus molded directly into the primary power phase lines during RTC 92 manufacture. They form repeating sequences of qty 6 phase transformer primary links that align with above secondaries respectively located within each PTM-CES 34 unit, as seen in FIG. 14. Mechanical fixturing associated with each 6 phase transformer link sequence allows PTM-CES 34 units to be guided into position as a blind-mate connection. This produces a Zero Insertion Force (ZIF) connection to each PRM-CES 34 module while also facilitating individual module replacement for maintenance. Moisture at transformer link core physical interfaces have no effect upon the magnetic coupling and all electrical connections, both on the cable side and within the PTM-CES 34, since the cores of each transformer windings are highly insulated and electrically isolated from both primary or secondary voltages. Similarly, the manufacturing installed and mated blind-mated fiber optic data line connectors at each PTM-CES 34, co-located with the transformer connector, are also isolated from the effects of moisture due to high degrees of electrical and environmental isolation common to such connectors.

The employment of 6 multi-phase power lines allows the power frequency to be ⅙th that of a single phase power line while achieving the same rectified ripple percentage for an equivalent rectifier on each phase. This lowered power frequency in turn reduces skin effect losses on the power distribution cable and allows the Multiphase Power Interface Unit (MPIU) 96 to be designed using more readily available and lower cost components operating at higher operational efficiencies due to lowered switching transition losses at correspondingly lower phase frequencies. The relatively high operational power frequencies as compared to 60 Hz drive RTC phase conductors 94 to be able to compensate for the increased skin effect conduction loss. Phase conductors implemented as metal (e.g. aluminum) foil or thin film conductors can satisfy this requirement while simplifying cable manufacture and lowering costs. Such implementations include depositing a film conductor on insulating (e.g. plastic) ribbons, that can be sandwiched for lower cost and higher reliability. Large scale RTC 92 to PTM-CES 34 power interface connectors 94 can employ transformers at each phase to ensure safe, reliable voltage isolation combined with efficient voltage step-down within this power interface, such as that seen in FIG. 14.

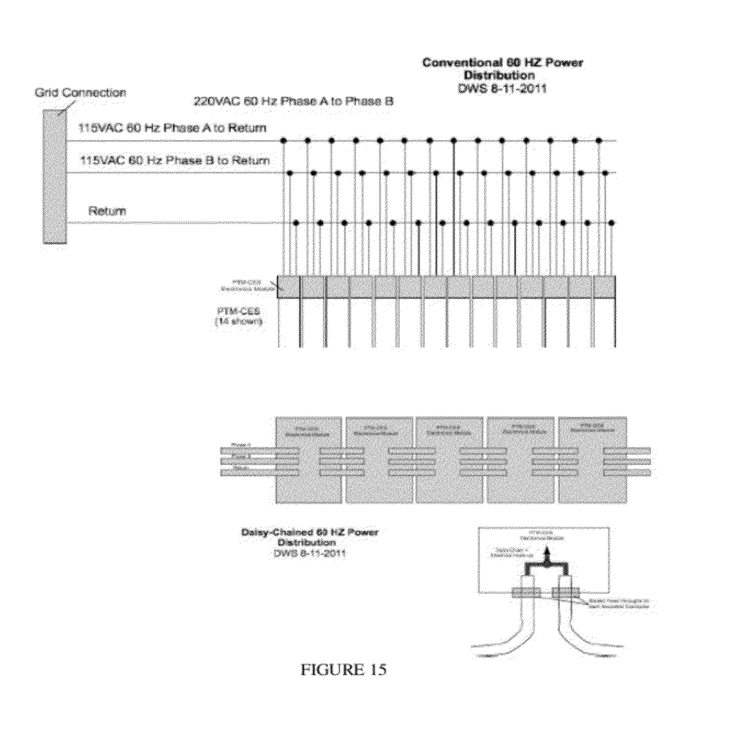

Some variants (e.g., a parking lot) of PTM-CES 34 can employ a more conventional direct wired connection to each PTM-CES 34 for smaller scale installations and lower cost alternatives, especially within initial prototypes and demonstrations, as seen FIG. 15. In such installations, one can employ a 220 VAC 60 Hz power distribution cable with suitable environmentally sealable connections to the PTM-CES 34. In either MPIU 96 or 60 Hz configurations, a ground fault circuit interrupter can be utilized that provides immediate power shutdown and safety protection in the circumstance that an environmental breech has occurred either along/within the power distribution cable or PTM-CES 34.

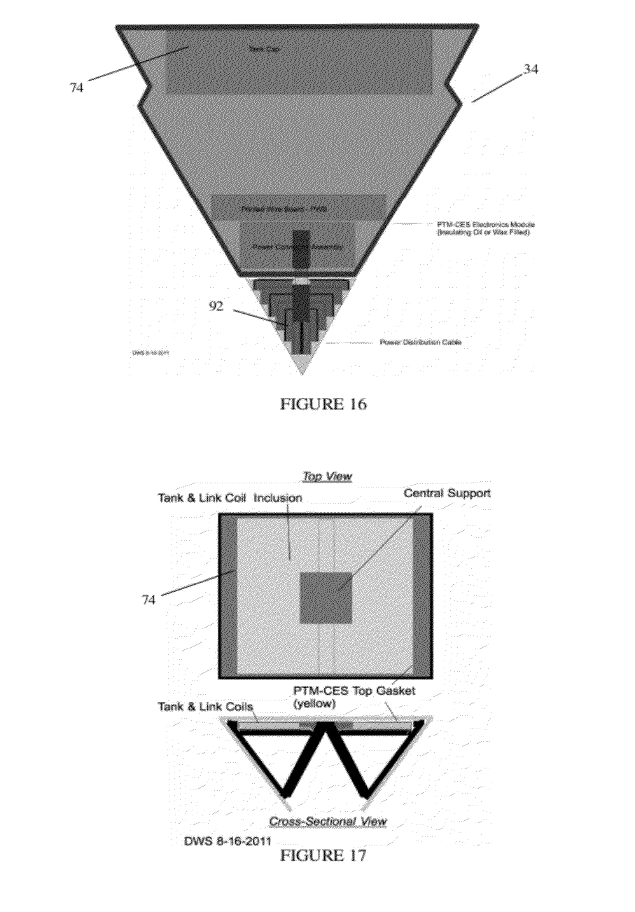

FIG. 16 depicts the cross-section of a triangular RTC 92 married to a PTM 14 in a configuration that fits directly into the apex at the bottom of the PTM trench 38. Closely fitting the trench as such, this cable format reduces the overall volume involved in the total PTM 14 installation. It facilitates pre-connection of RTC 92 to PTM 14 prior to trench installation, particularly when PTM 14 is to be used as a “self-form” during installation, while still enabling separate RTC removal if so desired during maintenance.

Power Transmit Module (PTM) Design Trades

A fundamental trade space surrounding PTM 14 design is that of design center gap distance between roadway/parking lot PTM 14 and vehicle mounted PRM 16 coils. This gap distance drives many design factors and related reliability and costs. The size of the coils within PRM 16 and PTM 14 can be relatively equal for wide ranges of gap distance however there exists a relatively linear relationship between coil size and gap distance for a fixed amount of power transfer/coupled power. The cost of roadway or parking lot installation is at least directly related to PTM 14 coil size in that a doubling of the width or cross-lane dimension of the PTM 14 coil doubles the amount of material that must be removed and doubles the physical volume of the PRM 16 assembly. Coil size also impacts the upper resonant frequency limitation of the associated Tank Coil 74 perhaps lowering this by a factor of 2 for each doubling of coil aperture area. Higher resonant frequencies reduce power supply ripple filtering requirements and allow efficient and small sized power transformers on the primary power side of PTM 14 ensuring the availability of magnetic connectors.

On the other hand over four times the reactive PTM 14 transmit power is required if the power transfer between PTM 14 and PRM 16 is to be maintained over a doubled gap distance. This increased reactive power is in turn a primary stressor for PTM 14 electronics reliability and raises component costs perhaps by a factor of 8. The chosen design center for PTM 14 to PRM 16 coil gap within the current design is 6 inches which is sufficient to allow a net roadway clearance of approximately 5 inches. Clearances greater that this will result in a rapidly decreasing falloff of power transfer. Clearances less than 5 inches will cause a disproportionately greater coupling factor between PTM 14 and PRM 16 coils resulting in the need to regulate or “fold back” the reactive power within the PTM 14 coil to maintain a fixed power. Therefore the 6 inch gap specification really determines the maximum gap at which a specified maximum power can be transferred. Initial experimentation has been with PTM 14 (Tank) coil dimensions of approximately 12 inches long (along lane) by 16 inches wide (across-lane) allowing a nominal 16 inch wide trench requirement for roadway or parking lot installation. It is possible to gain some design margin or reduction in reactive power (a main cost driver for PTM 14 implementation) by increasing the PTM 14 coil aperture, to perhaps a 16 inch by 16 inch dimension without significantly impacting the ability to operate at currently high magnetic power frequencies, specified maximum power transfer or roadway installation costs. This could result in an estimated 25% reduction in reactive power for the same gap specification. Table 7 below depicts an attempt to rationalize a set of basic ratios of PTM 14 size and power to cost.

TABLE 7

| Gap coil- | Reactive | PTM | PTM | PTM coil | Gap coil- | Reactive |
|---|---|---|---|---|---|---|
| coil | power | coil | coil | area, | coil inches | power per |
| inches | per coil | width | length | square | (normalized | coil |
| 6 | 2 | 16 | 12 | 192 | 1 | 1 |
| 6 | 2 | 16 | 16 | 256 | 1 | 0.75 |
| 6 | 2 | 16 | 24 | 384 | 1 | 0.5 |
| 5 | 1.66666666666 | 16 | 16 | 256 | 0.833333333 | 0.625 |
| 5 | 1.66666666666 | 16 | 24 | , 384 | 0.8333333333333 | 0.416666666666667 |

| Gap coil- | PTM Coil | | PTM |
|---|---|---|---|
| coil | width | PTM coil | Electronics |
| inches | (normalized | area, square | cost basis |
| 6 | 1 | 1 | 10.1 |
| 6 | 1 | 1.33333333333333 | 8.13333333333333 |
| 6 | 1 | 2 | 6.2 |
| 5 | 1 | 1.33333333333333 | 7.13333333333333 |
| 5 | 1 | 2 | 5.53333333333333 |

PTM Assembly

PTM 14 is comprised of included PTM-CES 34 units which are themselves individually environmentally sealed. In the preferred embodiment, separately manufactured and individually tested PTM-CES 34 units are attached to one another, in numbers that establish the modularity desired (e.g. 14 for parking lots and 50 for roadway installations). Note that certain PTM-CES 14 end-caps contain a locking mechanism which both draws the entire PTM 14 down into trench and while also securing it into position, as described in further detail herein. While a minimum of 2 locking mechanisms at each end of a PTM 14 may be adequate for the short parking lot PTM 14 configuration, this may be too few to be adequate in continuous roadway PTM 14 applications. It therefore is desirable to maintain a periodic spacing of the locking mechanism (that is fixed, perhaps to the parking lot PTM 14 interval) within the roadway PTM 14 configuration. Gasketing and fasteners are employed to additionally seal interfaces between PTM-CES 34 end caps and locking mechanisms shell. Each of the PTM 14 contained PTM-CES 34 exterior allows the enclosed electronics from the lower apex of each PTM-CES 34 to protrude into the trench bottom thereby allowing it to maintain direct thermal contact with the trench walls and with the power cabling directly below, within the apex of the “V” trench 38. Use of metal thermal through-wall vias into each PTM-CES 34 enclosed electronics area promotes good thermal transfer of heat generated from internal electronics while also providing possible electrical grounding and electromagnetic shielding for contained PTM-CES 34 electronics. For certain installations it can be desirable to “pre-mate” RTC 92 or other power cabling to the bottom of the PTM 14 assembly prior to installation within its trench. This insures proper physical and electrical mating while not inhibiting the “blind mating” capabilities of the PTM 14 during maintenance swapping, once initially installed.

PTM-CES Assembly

Individual PTM-CES 34 units are designed to be structurally rugged, with an internal truss structure that fully supports worst case traffic loading without significant deformation or degradation from environmental and load cycling. The top of the PTM-CES 34 incorporates a Tank and Link Coil 74 filled containment cavity which produces a flat and well supported underlayment for the top roof/roadway surface area PTM-CES 34 within a typical roadway installation. The Tank and Link Coil 74 underlayment is further sealed against moisture by the incorporation of an electrical insulating and encapsulating agent such as a resin, wax or oil filling, that ensures mechanical and electrical stability under all operating conditions. The Tank and Link Coil 74 subassembly further contains spacer material that adds compressive and shear strength to the truss supported roof structure, as seen in FIG. 17.

PTM Trench Installation

A “V” trench 38 is used to mount PTMs 14 flush with the roadway surface. Preparation of the trench proceeds by initially rough cutting a “V” cross-section with saws or other means into the road bed or parking lot bed. This is followed by a finishing coat such as concrete to achieve accurate, smooth and debris free sidewalls. Vibrating forms can be used to compress and rapidly form this finish coating. To prevent water intrusion once PTMs 14 are installed (mainly for freeze and corrosion protection), a waterproofing sealant coating can be applied to the side walls of the trench prior to PTM 14 installation. (Note: appropriate gasketing as applied to the exterior of PTM 14 may accomplish the same sealing property) If desired a power cable can be separately laid into the bottom of the trench with connectors facing upward at a spacing that mates with each PTM 14 or PTM-CES 34 as the given configuration requires. Otherwise the power cable can be pre-attached to PTM 14 prior to installation within the trench. PTMs 14 are then mechanically secured within the “V” trench at strategic locking points, including at minimum PTM 14 ends, as well as periodically along the length of PTM 14 in cases where longer PTM 14 lengths, with greater numbers of PTM-CES 34 units are employed. Locking also secures all primary power connections. The locking mechanism allows PTM 14 to be drawn down into the trench while simultaneously being secured to the trench walls as the locking mechanism is tightened. The locking (and unlocking) mechanism is operated from the roadway surface for both installation and maintenance.

An alternative to separately applying a finishing concrete or other appropriate material to the initially cut trench wall, necessitating the use of separate forms and possible added time, a more rapid finishing may be obtained by use of PTM 14 itself as the form. In this way a release coating can be applied to the sides of PTM 14 prior to it being pressed into the Trench which has had newly applied finishing material (e.g. concrete). PTM 14 locking pads or pawls are extended from their unlocked position upon installation, and serve as elements of the “selfform” for creating sidewall detents. Removal of PTMs 14 requires that these locking pads/pawls are first retracted away from Trench side walls and vertical mechanical force applied to lift PTM 14 out of the Trench.

PTM Locking Mechanism Design

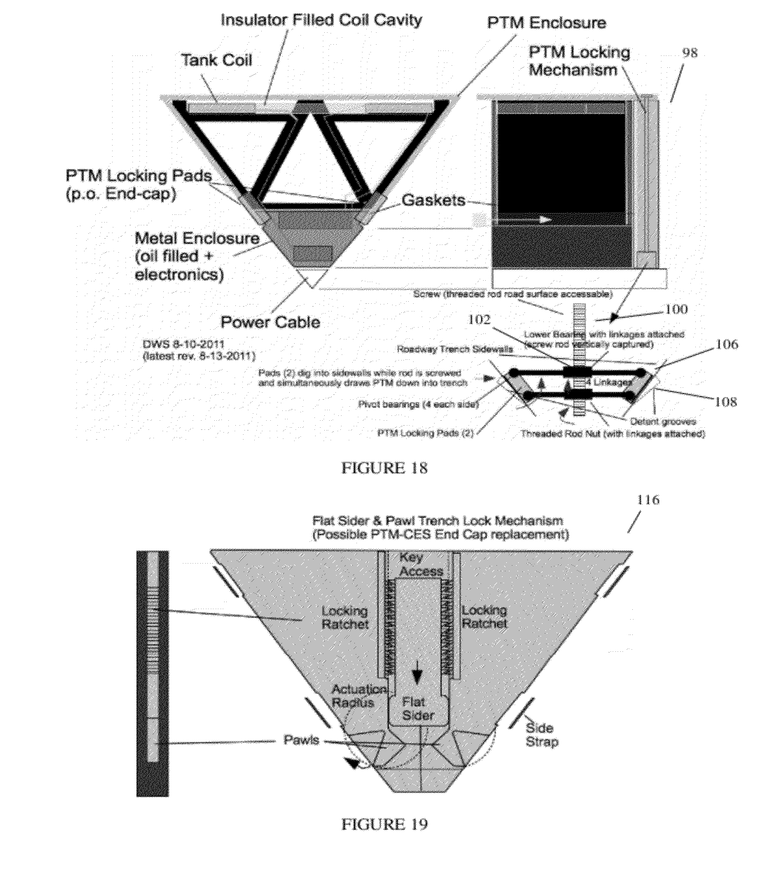

FIG. 18 depicts one means for implementing a PTM 14 locking mechanism 98 (within an end-cap or otherwise distributed throughout a given PTM 14) is with a rotatable screw rod 100, being vertically captured within a bearing 102 just below its head, being countersunk within the top of PTM 14, below the roadway. This upper bearing 102 locks the screw rod 100 vertically and is in the form such as can be implemented with a groove machined through the upper section of the rod, just above the threads wherein an attached lock ring 104 can be captured within the slip bearing 102 wherein rotation resultant upward and downward vertical forces are applied to the entire PTM 14 as the screw rod 100 is turned CCW or CW respectfully. A clearance hole 104, downward through the locking mechanism, allows the screw rod 100 to freely turn while being attached to a lower located set of linkages 106 and associated pads 108, which come into direct contact with the side walls within the trench 38. In this lower set of linkages the screw rod 100 is vertically captured at a top control rod bearing 110 such as can be implemented with a groove machined through a section of the rods threads wherein (as in the screw head located bearing) an attached lock ring can be captured within the bearing and via associated linkages to the upper pivot bearings of two opposing pads, can in turn release or apply pressure against opposing side walls of the “V” trench. The threaded screw rod 100 then passes down through a threaded nut 112, which is in turn attached to bottom pivot bearings 114 of each pad via lower linkages, such that when the screw rod is turned clockwise, both of the pads are tilted, under added leverage from the lower linkages, and digs into the trench side walls with great pressure. This creates a locking pressure against which a simultaneously downward drawing force is produced to vertically drive the PTM into the trench. This locking pressure occurs as a result of screw induced pressure as transmitted through the lower pad linkages leveraged by the pivot spacing on the pads and the actuating force produced as the threaded nut moves upward towards the slip bearing.

The thread pitch and starting depth of the locking assembly is such that the vertical movement is sufficient to fully draw the PTM down into the trench being securely braced by both pads against respective side walls, conversely securing the PTM, within and against the trench, against traffic loads and other forces. The PTM is removed simply by a counterclockwise rotation of the screw rod inducing the reverse of the afore described locking action. A “detent” providing a more positive sensory indication of proper screw rod and pad depths, greater tolerance in the locking range and an enhanced locking force can be produced by an introduction of suitable parallel grooves down the entire length of each sidewall within the trench. Such grooves can mate to the top of each pad, fixing the desired PTM seating depth while accommodating significant locking by pad tilting and resultant detention of the pads within the side walls during installation/locking. Such grooves can be produced by cutting into finished, cured and/or partly cured side walls during trench formation.

The use of a recessed screw rod head, when combined with a uniquely keyed head and mating rotating tool or tool sets can provide a fundamental level of theft protection. Other electronic means and mechanical key locking means at sporadic intervals can provide a further deterrent.

Alternative PTM Locking Mechanism Design

Another embodiment of the end cap locking mechanism 116 is depicted in FIG. 19. It is comprised of a flat slider-driven set of pawls that swing out into the trench wall as the slider is depressed downward. Such a slider mechanism can potentially be made cheaper (e.g. entirely of plastic and thinner to minimize roadway “dead-space” while at the same time serve as a PTM-CES End Cap or End Capsbetween adjacent PTM-CES units). Pawls on either or both sides of this Locking Mechanism apply direct frictional pressure to the trench sidewall(s) thereby securing the PTM within the trench. A trench wall inclusion designed to be located at the pawl engagement depth can further enhance the degree of the mechanical locking and seating forces that are generated during installation. Again access to such locking and unlocking can be protected by the need for a unique mechanical key and/or electronic controls.

Integrated Tank and Link Coil Design

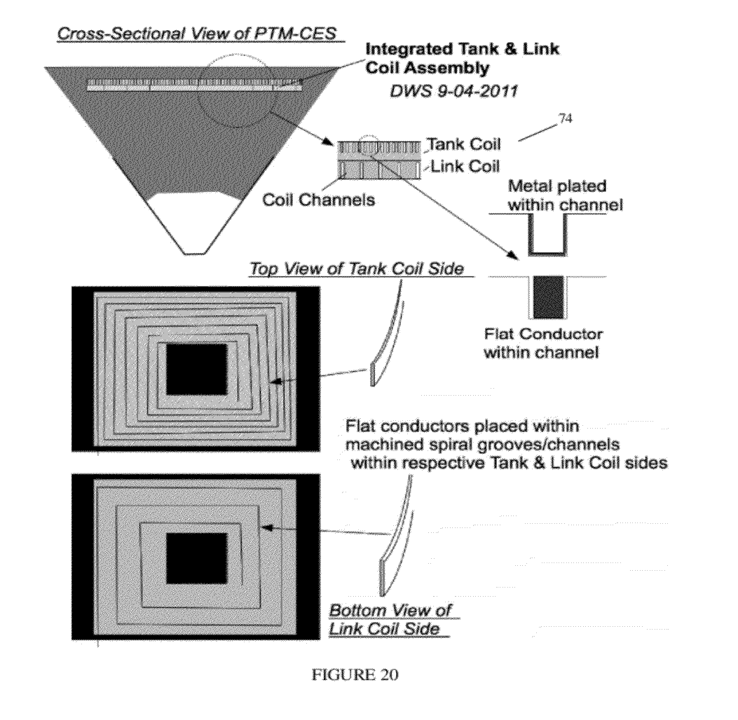

Tank and Link Coils 74 can be integrated within a common assembly as shown in FIG. 20. One such integration machines or otherwise forms spiral Tank and Link Coil 74 channels into opposing top and bottom sides of a solid sheet of insulating material such as plastic. Machining or forming grooves on each side to a total combined depth less than the thickness of the sheet insures that the assembly remains as a single sheet during all phases of manufacture. It also insures that an electrical insulating layer of material separates each coil once installed. Flat conductors such as metal foil are then inserted into each spiral channel to separately form Tank and Link Coils 74. Coils 74 can then be electrically connected to suitable leads and filled with a suitable electrical insulating resin or other compound to form a finished subassembly. The use of a physically robust sheet material within which channels are formed adds considerable strength—both compressive and sheer, to PTM-CES 34 unit once installed within its Tank and Link Coil 74 cavity. Additional coils such as used for magnetic field sensing can be also integrated within the same subassembly, in an analogous manner. Flat conductors facilitate significantly lower conduction losses at the higher frequencies utilized within this subassembly. Such foil conductors can be highly cost effective both in raw material costs and in assembly labor. Thin flat metal stock can be pre-formed into a spiral (e.g. via rollers) then conveniently fit into respective spiral channels. Alternatively, coils 74 can be formed by metal deposition within said channels, with top and bottom sides suitably machined or abraded to remove any possible winding to winding shorts. This deposition technique can accommodate further current crowding control due to magnetic field intensity by introducing conductive path scrambling within the metal deposited within grooves/channels by selective machining and/or periodically inserted bridging conductors within a channel. The sheet material within which Tank & Link Coils 74 are embedded can contain ferromagnetic material designed to enhance the generation and shape of the generated magnetic field as well as provide the overall electrical insulation properties required.

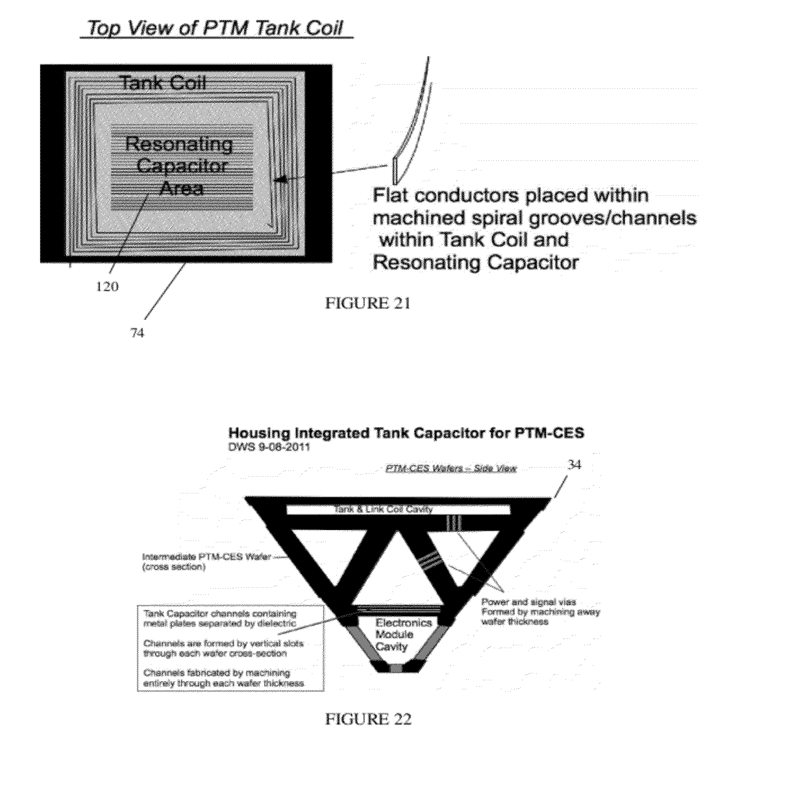

The Tank Capacitor 120 can also be integrated within the assembly of Tank Coil 74 as seen in FIG. 21. Alternatively all or a portion of the required Tank Coil Resonating Capacitor 120 may be embedded within the PTM-CES 34 housing itself as seen in FIG. 22.

WAVES Power Transfer Regulation

The loosely coupled air core resonating design of the WAVES power transformer dictates the generation of high reactive power within the PTM Tank Coil 74 and associated Tank Capacitor 120. This is problematic from a safety and reliability standpoint as it increases the costs and development difficulties of these key components. Further adding to operational difficulties on one hand is the significant variability in magnetic coupling to the user vehicle and on the other hand the need for regulated, standard power waveforms at the vehicle charging or energizing interface. This prompts the need for an automated feedback based regulation approach developed for WAVES 10. There are two main aspects to this approach: first, the maintenance of a “safe operating area” for the PTM based power amplifier and, second, generation of a regulated standard voltage and frequency output to the user vehicle and associated electrical systems. These aspects are related to each other in the sense that the time varying vehicular waveform and load demands as modulated by varying magnetic coupling across the roadway gap will in turn reflect a time varying load demand upon the PTM Tank Coil 74 and associated amplifier which needs to be included within its “safe operational area” capabilities. This is further complicated by the loosely couple air-core design utilized by WAVES 10 as it avoids the use of high-permeability materials.

The key is that the voltage waveform experienced by the Power Amplifier/Tank Link side of the Tank Coil 74 may not indicate the waveform expressed by the Tank secondary winding which may experience significantly more variable voltage swings especially under light loads. To insure safe the establishment of a safe operational area, the Power Amplifier Drive 122 needs to be inhibited by feedback whenever this voltage waveform exceeds specific limits. Additionally, power amplifier current sampling infers real power (not reactive power) delivered in real-time. An added feedback loop around this current sampled signal can also inhibit the Power Amplifier Drive 122 thereby accomplishing regulation (and/or safe high current shutdown under failure or faults) that is inclusive of both vehicle loading and safe area operation. On the vehicle side, a time varying waveform may be generated by active circuitry within the PRM 14. This circuitry can also self regulate within an acceptable operational range of power transfer to insure proving a standard power waveform to the vehicle e.g. 220v @ 60 Hz. The demands of PRM load power (waveforms et. al.) are, of course, reflected back to the PTM Power Amplifier 122 as a time varying real power demand that requires seamless incorporation within its regulation.

WAVES PTM Tank Capacitor Design

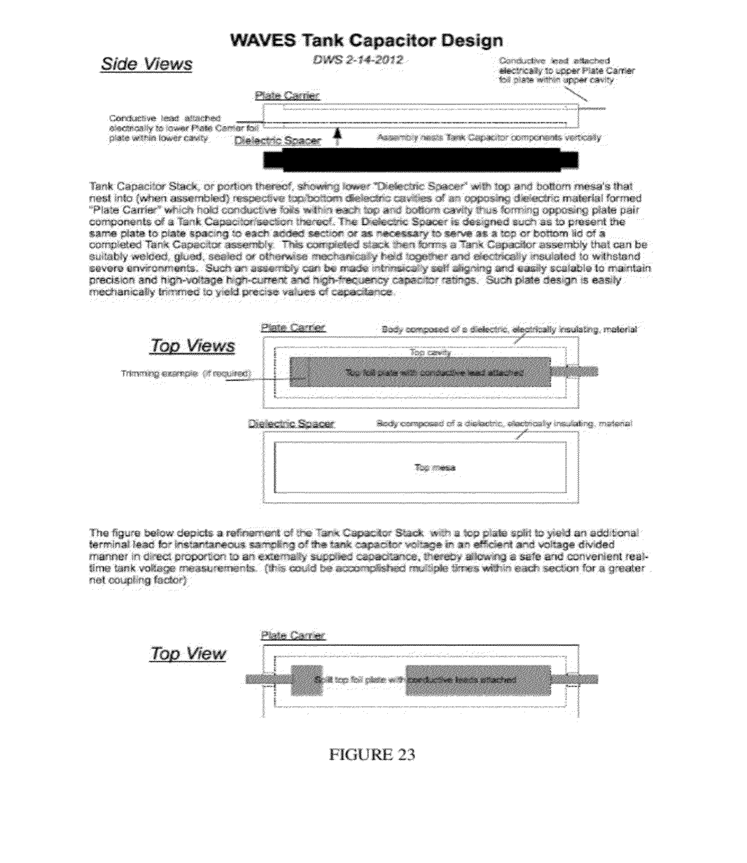

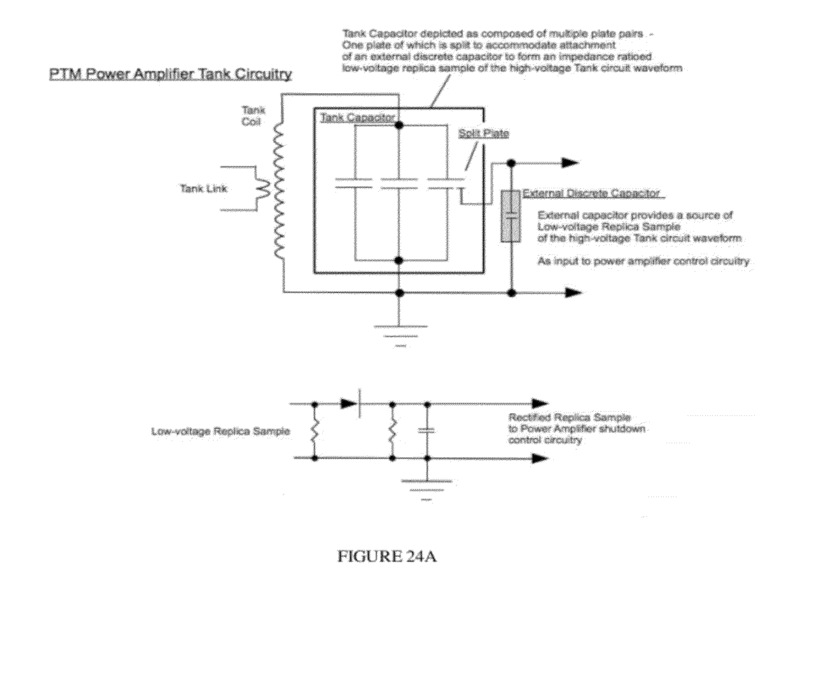

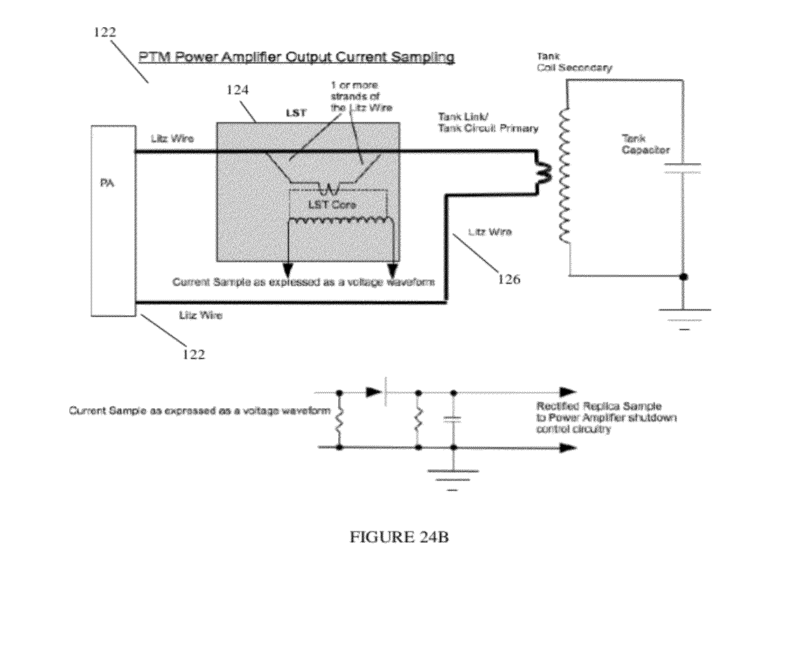

Referring to FIGS. 23 and 24A, a key critical component to the high power and long-term reliable operation of the WAVES PTM 14 is the Tank Capacitor 120. The reason for this is the extreme voltages (many thousands of volts) and high frequencies (many hundreds of thousands of cycles per second) coupled with high currents (ampere levels) that that this capacitor is required to handle on a continuous basis during active power transfer. These requirements dictate a conservative voltage and power dissipation & loss design which is satisfied by the precision machined assembly of stacked components comprising the WAVES design. Low loss dielectric material is utilized throughout. The “nested” configuration captures and encloses interior plates to provide a high degree of corona resistance which is a major factor in reliable operation. A long and secure dielectrically encompassed path is thereby provided which is easily sealed from the outside environment. The parallel plate design of this capacitor lends itself to thick conductive foils or plates for the elimination of expensive metals, with corresponding lighter weight, and facilitates mechanical trimming to achieve precision capacitance values. The WAVES Tank Capacitor 120 design is easily scalable in electrical ratings to accommodate differing power transfer requirements even at multi-kilowatt levels. Additionally, as embodied in a split-plate design, the WAVES Tank Capacitor 120 provides an integrated, safe and low-loss means for sampling and measuring tank voltage during operation.

Referring to FIG. 24B, a key critical component to the high power and long-term reliable operation of the WAVES PTM 14 is the real-time control of the output of the Power Amplifier 122. FIG. 24B depicts a means for achieving an economical, efficient and small sized implementation of deriving such a control signal. In particular, a Litz Strand Transformer (LST) 124 design yields an important means for instantaneous sampling of Power Amplifier (PA) output current (as input to the Link primary of the Tank Circuit 74) in a small, efficient and voltage divided manner, with sample voltage in direct proportion to the LST turns ratio. Such a means limits the saturation of the LST 124 core by restricting the flux of the sampled current to a ratio of the PA output current. This ratio is set by the ratio of the total number of strands in the Litz wire 126 formed primary of the Tank Circuit 74 to the number of strands used/split off as routed through the primary of the LST 124, and the number of turns that these strands make in the primary of the LST 124. This approach takes advantage of the nearly equal current sharing that exists within the strands of the Litz wire 126 formed Tank Circuit Primary and resulting split off strands within the LST 124 primary. Obtaining such a PA output current measurement is key to the safe and regulated control of the PA within the PTM 14 and its subsequent variable loading imposed by any PRM pickup. As depicted, the LST 124 secondary provides a sample voltage output in direct proportion to the PA output current with this proportionality set by the number of strands within the Tank Circuit Link and the turns ratio within the LST 124. Such a sample voltage can be subsequently rectified to provide a real-time feedback control signal to the PA 122 to shut it down in cases of safety or protection under adverse circumstances or simply to afford regulation thus insuring that a stable power is deliver to the PRM 16 load under normal variations.

Extruded PTM-CES Construction

Individual PTM-CES 34 units can be constructed from a continuous plastic or other insulating material extrusion that is subsequently sliced to the proper length to form the chassis for PTM-CES 34 units. Such an extrusion process allows the inclusion of internal 3D structure designed to be structurally rugged while minimizing overall weight. Extrusion promotes the low cost, mass-fabrication of PTM-CES housings. End Caps with appropriate gasketing then provides environmental sealing to contained integrated electronics. Single or multiple PTM-CES 34 containing units can be formed within each extruded slice, to be environmentally sealed by end caps during assembly. Heat sink and electrical vias can be formed with machining of chassis penetrations. Heat sink components can be inserted from internal and external areas of each PTM-CES 34 electronics area, through sealed penetrations to be subsequently joined or riveted together during unit assembly to form a complete thermal path from internal electronics to trench side walls. PTM-CES 34 contained units are separately tested and numbers of such completed units mechanically held together to form a PTM 14 assembly suitable for parking lot or roadway installation within prepared trenches.

Power Transmit Module (PTM) Environmental Heat

PTM roadway and parking conditions are exposed and can receive heat loading from ambient air temperatures and direct solar absorption. This heat gain can result in severe temperatures at the surface of the PRM 16 which can lead to lack of mechanical stability of related housing materials, especially when combined with vehicle traffic weight loading. The addition of reflective material along top PRM 16 surfaces may help reduce such increases in concert with appropriate housing material choices. This “cover” material could also have thermal insulation properties that isolate internal housing structure from potentially significant surface temperatures. Another possibility is a more active method of cooling, based upon phase transfer of heat at a common temperature, located within the internal housing volume. Materials such as wax absorb considerable heat in transitioning from a solid to a liquid. An active pumping system can be employed within the housing that allows a fluid (e.g. oil) to convey heat to from the exposed top area of the PRM to lower/subsurface areas. Heat sink vias located within these areas can then conduct heat to exterior side wall areas of the Trench that are at significantly lower temperature.

PTM & PRM Fabrication Material

High Density Poly Ethylene (HDPE) has important properties that are suited to the manufacture of PTM-CES 34 and PRM 16 housings. Fastening is one option, but various parts are preferably joined by hot air or nitrogen welding. Also, ultrasonic, laser, and infrared welding may be used. HDPE can be injection molded as well as being available from recycled sources at lower costs. Glass material can be embedded within the top layers to enhance strength and achieve a proper degree of UV and thermal protection. Furthermore the excellent electrical properties make it possible to create high voltage/high frequency resonating capacitors within the housing structure itself, inserting conductive plates within slot cavities formed within the housing material, thus eliminating the need for separate dielectric materials or associated mechanical fixturing. The lack of glue-ability does not preclude the use of glue or rubber-like compounds between components that serve in a sealing gasket function so long as additional mechanical means are employed to hold components together.

Alternative PTM-CES Laminate Construction

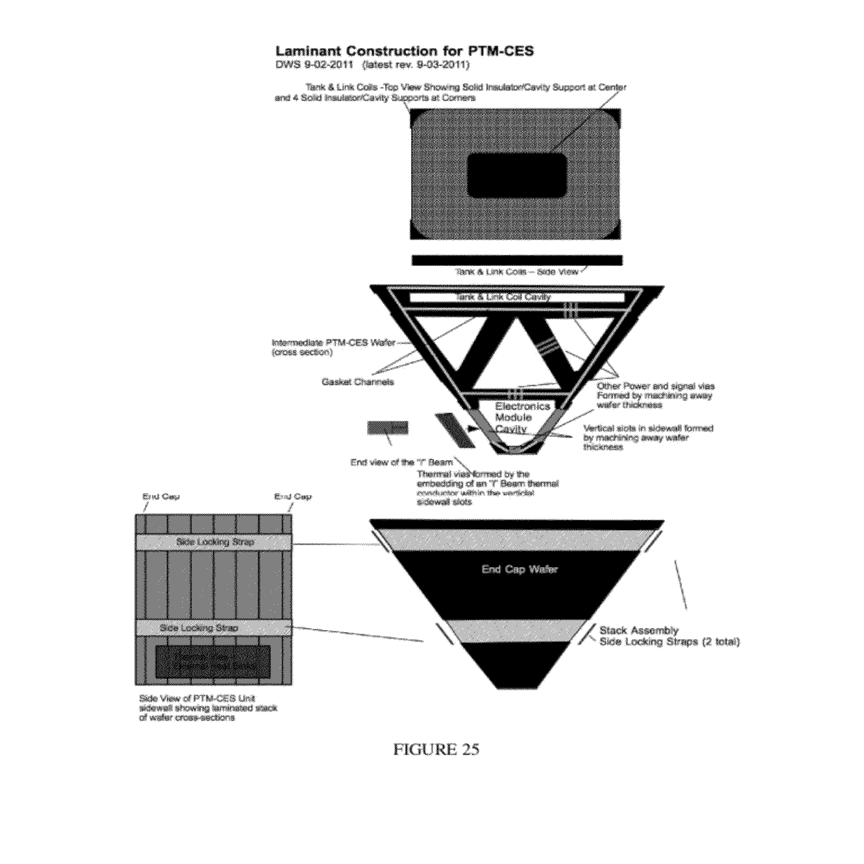

Individual PTM-CES 34 units can be constructed from a set of cross-sectional wafers, as seen in FIG. 25, that when aligned stacked and laminated form a solid PTM-CES 34, complete with environmental sealing and heat sinking to form an integrated electronics module. Such a laminating process allows the inclusion of internal 3D structure designed to be structurally rugged while minimizing overall weight. Lamination promotes the low cost, mass-fabrication of the entire housing while enabling easily formed heat sink and electrical vias between laminate layers through machining of individual channels (shallow depth cuts). One way of producing such a PTM-CES 34 laminate stack is by the stamp cutting, router milling, or saw cutting of individual wafers from sheet stock plastic (including recycled plastic composite sheet stock). Wafers can then be stacked and bonded together along with included thermal and electrical vias to form a completed assembly with electrical components inserted prior to final assembly, testing and installation of environmental sealing end caps (also formed as wafers using the same machining process options referred to earlier).

FIG. 25 shows a simplified representation of the laminating approach wherein 2 basic cross-section types of wafers (solid end cap type, internal type) are stacked to form a given PTM-CES 34 unit. PTM-CES 34 wafers are bonded to one another to form a structurally sound and water-tight unit. The use of a bonding agent effectively eliminates the need for gaskets. Sidelocking straps provide added strength to hold individually bonded wafers together within a unit. Individual units can be in turn joined to adjacent PTM-CES 34 units by use of extended side-locking straps. Such straps preserve the smooth continuous side walls of the triangular exterior of the PTM 14 while making the entire assembly cohesive with a appropriate degree of rigidity. A bonding agent, mechanical hardware and high strength strap material can strengthen the degree of cohesiveness within and throughout a chain of physically linked PTM-CES 34 units. Once bonded, stacked and strapped together the resulting PTM-CES 34 units can be machined (e.g. sanded) on the exterior to enhance trench fit accuracy that can result in better distribution of roadway induced loading against the side walls of the “V” Trench. Furthermore if the slope of the trench makes the included angle of the bottom of the “V” slightly more acute than that of the respective “V” profile of PTM-CES 34 in this respective bottom “V” area then the bottom are of each PTM-CES 34 can be made to come under higher compression than that of the rest of the module as it is installed into the trench, thereby insuring good thermal contact in that area (as well as enhanced physical protection of bottom trench located power and data interfaces). The slightly increased fit tolerances on the remaining upper portions of the side walls can be easily overcome by intervening sealant and/or ultimate unit deformation under roadway loading. Heat sinking and electrical and optical vias can be introduced into the resultant PTM-CES 34 by suitably machining across the thickness of given wafer(s) of the stack prior to lamination. In this way both external and internal openings can be introduced at given locations wherein conductive material can be embedded and sealed during the lamination process. Considering the heat sink, a succession of vertical slots through both lower side walls of each PTM-CES 34 allow the embedments of a series of “C” or “I” beam like metal heat conductors which can form nearly continuous internal and external heat transfer regions within the Electronics Module portion of each PTM-CES 34 unit. The center portions of such “C” or “I” beams provide the thermal vias through the insulating side walls of the Electronics Module. Again, the outer surfaces of the “C” or “I” beams form heat conduction to the “V” Trench walls and can be machined (including sanded” flush to the exterior of the module affording optimized heat transfer. Additional considerations of such formed thermal vias include machining/relieving exterior and perhaps interior module housing material under the non-via portions of each “C” or “I” beam thermal via. In this way the resulting depth allows for enhances sealing area and enhanced mechanical resistance to sidewall compressive forces, thus strengthening and better sealing these critical electronics containing areas of the module. Likewise, a similar approach can be utilized for the installation of other power and signal interface components to ensure reliability.

The Tank & Link Coil 74 is integrated with strong winding separators and a strong central core to form a robust component that slips into and fills the associated PTM-CES 34 cavity during assembly (from an open side of a PTM-CES 34 unit). Additional intervening sealant then completely fills the cavity which when enclosed by end caps, the coil completes the formation of a solid strength member parallel to the its roadway exposed surface, being supported immediately below by truss-work within PTM-CES 34. The utilization of truss-work as opposed to solid cross sections is three-fold, high vertical strength at significantly reduced weight, overall material savings and the ability to form internal cavities and structure that fixture and fabricate internal components.

Heat Sink Via Designs Suitable for Laminate and Extrusion Implementations

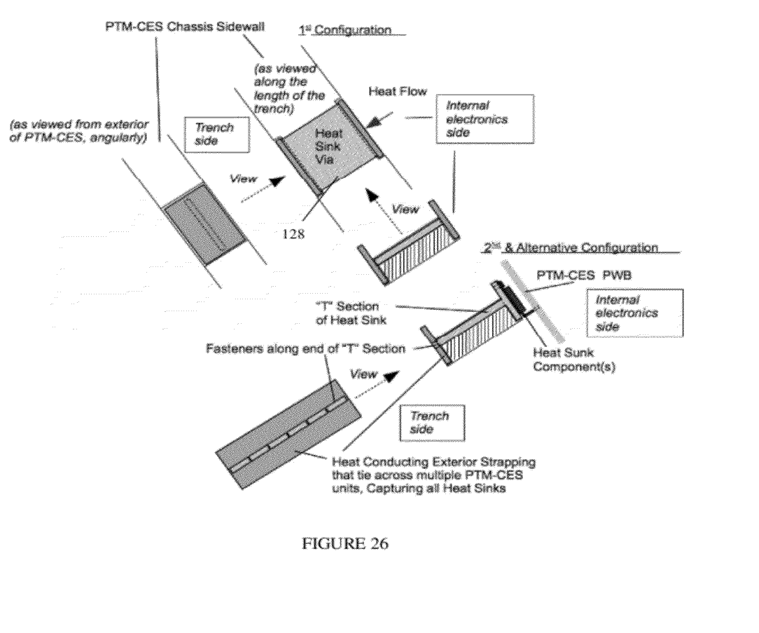

FIG. 26 illustrates two embodiments of the heat via 128 embodiment, both of which are suitable for laminate forms of constructions; however, the second embodiment is suitable for extrusion implementations because it can be inserted (e.g. like a staple) through an existing sidewall with minimal effort. The heat via 128 is designed to provide a good heat flow path from higher ambient temperatures of directly mounted power electronics (having high heat concentrations) and indirectly heat coupled internal electronics to PTM-CES 34 exterior and adjacent trench side walls of a lower ambient temperature without compromising the waterproof integrity of PTM-CES 34 housing.

The first embodiment is an I-beam configuration that neatly fits into prepared (2D) indentations within a laminate slice and is further captured and sealed by an opposing laminate slice within the stack of slices comprising a PTM-CES 34 unit. The second embodiment is a T-beam configuration for insertion through a relatively narrow opening through a PTM-CES 34 chassis side wall. In this instance the outside (or perhaps interior side) heat flow surface must be suitably fastened to the penetrating “T” end section to form the via 128. Suitable fasteners include riveting or otherwise cold forming T material or spot welding or screw fasteners. The intent is to provide a flush exterior with good sidewall contact for heat flow and minimal inclusions that may serve to inadvertently lock the PTM 14 in place preventing future extraction. An additional attribute to the second design is that of being capable of strapping across the multiple slices of a stacked laminate constructed PTM-CES 34, such as to provide individual unit integrity before being strapped or otherwise secured into a given PTM 14 configuration prior to subsequent installation.

Power Transmit Module (PTM) Electrical Specifications

PTM 14 electrical specifications include peak and average power for the entire module as well as average power dissipations from electrical/electronic losses which is manifested as heat. Heat will be conducted away from the PTM 14 along two paths, one is to the subsurface of the roadway (primary path) and the other is through the transmitting coil at the roadway surface interface (secondary) which will only be significant when roadway surface temperatures are well below subsurface ground temperatures. Table 8 below details the electrical specification for PTM 14:

TABLE 8
PTM Electrical Specifications

| | |
|---|---|
| Electrical Power - Kilowatts Peak | 125 |
| Continuous Power - Kilowatts | 75.00 |
| Power Dissipation Total - Kilowatts | 7.5 |
| Power Dissipation Per Foot - Watts | 187.5 |

It should be noted that the nearly 200 watts (peak) per foot dissipation is a significant amount of heat within a confined (0.75 cubic foot) volume as exists within a one foot long triangular section. This implies the need for a good thermal path between internal electronics within PTM-CES 34 components as well as a good thermal path to and through the side walls of the PTM 14 to the roadway subsurface. Also note that during the summer and in areas of direct sunlight the top or roadway surface of the PTM 14 is a potential source of high heat loading that must be avoided. Underlaying thermal insulation immediately below each PTM-CES 34 coil prevents this path being a major heat load to electronics below.

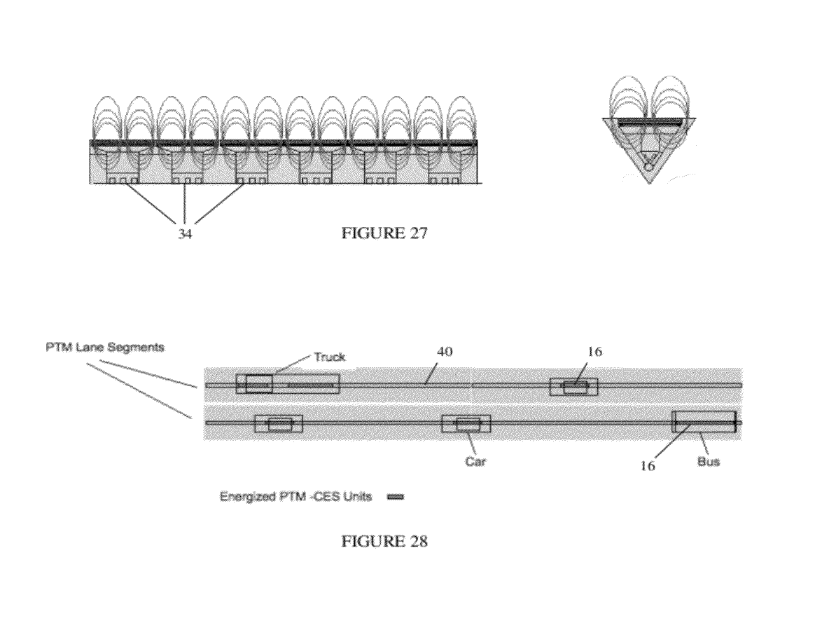

PTM-CES 34 units are the common denominator for transmitting the magnetic fields that are the source of power coupled to vehicle mounted PRMs 16, as well as the source for control and critical communications links to those vehicles. Multiple PTM-CES units 34, when simultaneously energized by a reasonably aligned passing PRM 16, couple increased power to the associated vehicle in direct proportion to the number PTM-CES 34 units energized, as seen in FIG. 27. The coil drive waveforms at adjacent PTM-CES 34 coils are synchronized and phased to oppose magnetically, resulting in a bunched or vertical fountain-like structure to the resulting fields along the axis of the PTM 14. The vertical structure optimizes power transfer to respective pickup coils within the PRM 16 and eliminates any short circuiting of field lines directly to adjacent coils. This structure forms a rugged Magnetic Field Window 130 that isolates the Tank Coil 74 from the physical environment at the roadway surface while virtually magnetically displacing the coil to the very top surface of the roadway, thereby maintaining the smallest possible coupling gap to a vehicle's PRM 16 above. In this manner the coils on both roadway and vehicle are protected without adding the thickness of the PTM 14 housing/window to the air gap through which magnetic field coupling occurs.

PTM-CES 34 electrical specifications include required peak and average or continuous electrical power as well as loss related dissipation, manifested as heat. Heat is conducted internal to each PTM-CES 34 by both structure and insulating oil to its apex or lower triangular point. This apex area is thermally conductive and in good thermal contact, through adjacent PTM 14 side walls, to the sub surface at the bottom of the roadway trench. In this way cooling is maintained without sacrificing environmental integrity of the PTM 14 and its subassemblies.

The secondaries of magnetically coupled transformer links, located entirely within each environmentally sealed PTM-CES 34, feed rectifiers for the generation of DC power used by internal electronics. DC power is at nominally low voltages and moderate currents (see Table 9). Transmitting tank coil and capacitor AC voltages are however quite high due to associated Tank Coil Link transformer step-up and resonance effects. This is especially true when the Tank becomes lightly loaded under worst case low magnetic coupling instances. Therefore coil and capacitor components are high voltage insulated within the PTM-CES 34 by an internal oil bath and there is no direct exposure from coil to roadway as a result of employing a magnetic window material seal at this interface. The electrical specifications for PTM-CES 34 are set forth in Table 9 below:

TABLE 9
PTM-CES Electrical Specifications

| | |
|---|---|
| Electrical Power - Kilowatts Peak (incl. losses) | 2.16 |
| Continuous Magnetic Field Power - Kilowatts | 2.00 |
| Power Dissipation Total - Watts | 160 |
| DC Primary Power Supply Voltage - Volts | 480 |
| DC Primary Power Supply Current - Amperes pk | 4.50 |
| DC Secondary Power Supply Voltage - Volts | 12 |
| DC Secondary Power Supply Current - Amperes | 5 |
| AC Coil & Cap Voltage - VAC pk | 6000 |

The determination of the exact number of PTM-CES 34 units that are energized at any one time is in turn the role of the proximity links. The first proximity link is initiated by a magnetic field based data transmitter located within the vehicle PRM, such that PTM-CES 34 fields are only produced when there is the potential for adequate coupling to the PRM 16. The first proximity link data transmitter within vehicle PRMs 16 operate on a frequency separate from that of the PTM 14 and employ a pseudo-random modulation designed to limit power carrier interference. The signaling frequency is made appropriate to be easily combined with all coils of PRM 16 in a manner that each PRM 16 coil radiates a magnetic field from vehicle to roadway having a spatial shape and coupling factor nearly identical to that of the PTM 14 power carrier (emanating from roadway to vehicle). This independent signaling frequency allows first proximity link receiver within each PTM-CES 34 to detect a proximity signal in the same coil used for power transfer to the vehicle and in the presence of a power carrier, thus insuring that the pickup coupling is analogous to that experienced during power transmission. Filter networks within the first proximity link receive path of each PTM-CES 34 and each transmit path of the PRM 16 are designed to be anti-resonant at the power carrier frequency but series resonant at the signaling frequency. This design effectively isolates subsequent signaling components from the high level power carrier, allowing reliable signaling carrier to interference ratios. Furthermore, the bandwidth of the signaling channel thus formed is made sufficiently broad (nominally 30 kHz) to accommodate transmission of multiple copies (10 minimum) of a psuedo-random modulated vehicle ID word within the minimum interval of a single PRM 16 coil to PTM 14 coil passage (nominally 0.01 seconds).

Since the proximity link 28 function is critical to both human safety and to the proper operation of PTM-CES 34 modules, insuring adequate magnetic coupling is always present before energizing, additional proximity link hardware is included such that two valid proximity links are required in real time to generate an enabling signal. This second (additional) proximity link operates on an entirely different principle and employs a separate PTM-CES 34 UHF transmit signal and receiver analogous to that employed in store antitheft security systems, wherein a very simple chip is embedded within each vehicle PRM 16 coil that is activated as it passes over an interrogating PTM-CES 16 coil. Thus, three separately generated enabling signals must be present before any energy activation occurs

Referring to FIG. 28, the ability of PTM 14 to literally track a vehicle's PRM 16 via proximity links 28 and 32, only powering up a PTM-CES 14 when it will be able to usefully couple power to an external and specific PRM 16 load, maintains overall efficiency and safety. Proximity enabling produces energized magnetic field “hot spots” or waves of power that travel down the PTM Lane 40 at vehicle velocities, with power transfer maintained on a continuous basis directly under vehicle PRM 16. There may be more than one PRM 16 placed on a vehicle as may be the case for trucks, trailers and other articulated vehicles that require proportionally greater power transfer. This proportionality in power transfer is a powerful feature in that the power transferred is a direct function of the number of PTM-CES 34 units that are energized. So a larger vehicle such as a bus having the requirement for a greater power transfer, also has an ability to carry a greater number of PRM 16 pickup coils (longer PRM). Large vehicles can thereby be effectively powered from the same standardized power PTM-CES 34 units that power lighter vehicles within a common driving lane.

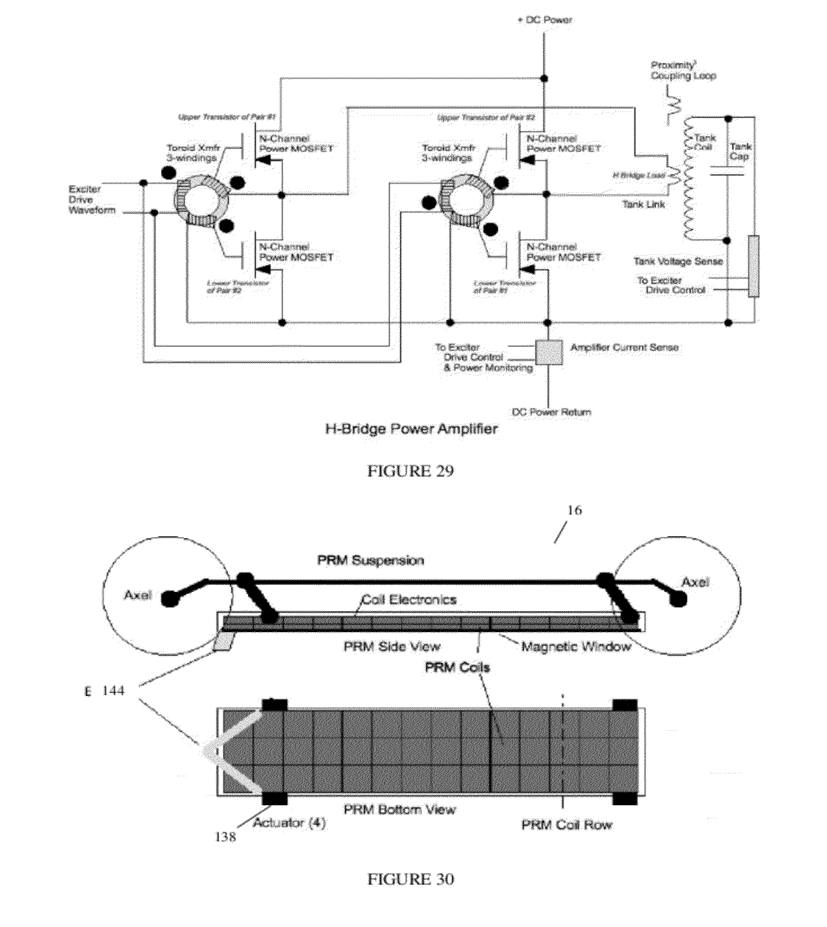

Referring to FIG. 29, the PTM-CES 34 magnetic field generation design incorporates a MOSFET power amplifier and direct coupling to an associated resonant tank circuit to efficiently generate very high AC magnetic fields within the space between roadway and vehicle PRM 16. The MOSFET amplifier is in turn fed from a lower level signal generated by a gated exciter.

The MOSFET H Bridge configuration utilized as a power amplifier output stage derives its name from the “H” formed when two sets of vertically stacked transistors are joined horizontally between their respective center connections by the load. The load in this case being the Tank Link Coil 74.

The use of a transformer coupled H Bridge MOSFET configuration 70 for the power amplifier allows the presence of an exciter output to directly enable the amplifier's power generation. With no exciter driving signal, all four of the amplifier's MOSFETs are turned off and virtually no current flows. This is true whenever the exciter output is gated off. Thus a (low level) “Transmit Enable” logic level signal is used as a low power, low voltage gating of the exciter output to energize each PTM-CES 34.

When the amplifier is gated on, diagonally opposite MOSFET pairs of the H bridge 70 (pair #1—upper left & bottom right; pair #2—upper right & bottom left) are alternately switched on and off during each half of the power carrier cycle (one pair switched on while the other pair is switched off). This switching arrangement causes high alternating currents to flow within the Tank Link Coil 74, currents that switch direction at each half cycle in unison with alternating MOSFET pair conduction. The resulting alternating magnetic field of the link coil 132 is tightly coupled to the resonant tank coil 74, a coil having a significantly larger number of turns than the Link Coil 132. This turns ratio produces a large voltage step up from link to tank. The tank circuit is made parallel resonant at the switching frequency by the paralleled Tank Capacitor 120. Therefore, the net result is that the tank voltage builds rapidly with each cycle of link current. In normal operation, tank circuit loading is primarily from nearby (passing) vehicle PRM 16 coils which act as a loosely coupled transformer secondary winding. Reactive currents within the tank circuit are passed alternately from Tank Coil 74 to Tank Capacitor 120 as the magnetic field collapses through the Tank Coil 74 and back to the Tank Coil 74 as the increased rate of Tank Capacitor 120 charge occurs on the next half cycle. The relatively loosely coupled vehicle PRM 16 coil presents an increasing real power load in proportion to the level of reactive power exchanged within the tank circuit, until the amount of real power coupled to the PRM 16 load matches the real power provided by the MOSFET amplifier Tank Link Coil 74 circuit (less minor losses). At this point constant maximum real power is exchanged wirelessly by the alternating magnetic field coupling between Tank Coil 134 and PRM 16 coil. Once the PRM 16 coil moves out of range as determined by the Proximity Link 28 to the PTM-CES 34, the PTM-CES 34 is gated off again and de-energized, allowing the tank resonant energy to rapidly decay to zero based on residual coupling to PRM 16 and tank circuit losses. It should be noted that a vehicle PRM 16 may be many coils long, therefore a given PTM-CES 34, once enabled, will remain energized for the entire duration of passage (several PRM 16 coil times). At 70 mph, with a 14 coil PTM, this energization would be for a time duration of 0.11 seconds.

Power Transmit Module (PTM) Charge Controller Function

The vehicle charge control function can be addressed wholly or in part by the PTM-CES 34 units within the PTM 16. When a vehicle is coupling energy whether statically or dynamically there must be a throttle on the amount of energy transferred, such that the vehicle's battery is not overcharged or discharged when sufficient power is available, or charged at a rate that exceeds specifications. An on board, vehicle based charge controller can accomplish this battery charging control by inhibiting the flow of power in the battery charging circuit to exactly match the instantaneous needs of the vehicle. If the vehicle is in motion there are motor power demands added to battery charging power demands. There may also be demands from vehicle accessories such as lights and air conditioning. The charge controller monitors the battery's state of charge and motor power to establish a battery terminal voltage that continuously balances wireless power input with the needs of the combined total vehicle electrical load. This implies that there will be a variable amount of wireless power coupled to vehicles under both static and dynamic roadway conditions. If the PTM-CES 34 units were to do nothing in response, the tank coil and capacitor voltages would be higher under light loads and lower with heavier loads as they are energized by the passing vehicle. A range of loading is acceptable so long as tank and pickup coil voltages are maintained at safe levels and the fringe fields above the pickup coil are sufficiently attenuated before reaching vehicle or occupants. Over-voltage conditions at the PTM-CES 34 tank can be sensed and made to gate the amplifier drive to better match amplifier output energy to light loads. Sensing means can be a sense coil within the Tank Coil 134 field or a capacitive or resistive AC voltage divider from the ungrounded side of the Tank Coil 134. A spark gap in conjunction with a fast acting over-current shut-down can be further employed as an added safety feature that puts an ultimate limit on tank voltage swings.

Current monitoring can be effectively monitored using a current sampling transformer in either or both of the Link Coil 132 leads to the high power amplifier. The resulting AC waveform can be rectified and filtered if necessary to be used in comparison with control derived threshold voltages to inhibit amplifier drive and thereby power.

A particularly interesting mode to consider is the incorporation of a greater degree of charge controlling functionality within each PTM-CES 34 such as to shift the majority of this function from vehicle to roadway or parking lot. This provides a means to simplify vehicle charge controlling while archiving a degree of commonality from vehicle to vehicle. This works by using the WAVES Data Link 30 to transmit vehicle power needs in conjunction with vehicle ID such as to allow programing of PTM-CES 34 amplifier drive gating. Programming will in turn cause the proper amplifier power output when it is subsequently enabled by the WAVES proximity links 28 and 32 during vehicle passage. This in effect produces a closed loop around the magnetic power coupled to the vehicle battery and motor (dynamic). In the dynamic case, the Data Link 30 is sufficiently real-time to prime upcoming PTM-CES 34 units with the proper power level, in advance of their being enabled by the passing vehicle. Since this forms a closed loop, errors in coupled power (from instance to instance) can be corrected by changing power level programming of power transfers from continuously engaged PTM-CES 34 units (static) or subsequently enabled PTM-CES units (dynamic). In initial applications, wherein parking lot and household operation is sufficient, a static charge control function is all that is necessary.

Power Receive Module (PRM) Design

PRM 16 is required by any electric vehicle choosing to receive magnetically coupled power from roadway or parking lot embedded PTMs 14. Referring to FIG. 30, the PRM 16 contains pickup coils rectifiers 136, deployment actuator 138, and monitoring and communications electronics 140 in an environmentally sealed composite housing 142. Since the PRM 16 is suspended below each vehicle, exposed to the airstream and the environment, design considerations must address minimizing weight and cost, while being rugged, and corrosion resistant. Cost and weight push the PRM 16 (and PTM 14) coils to be made from copper-nickel clad aluminum stranded cable wherein each strand is separately cladded and insulated to minimize skin effects and corrosion.

PRM 16 length varies with the vehicle to be able to match driving power requirements. Two lengths are suggested 11 feet for mid-sized car vehicles, and 34 feet for trucks and buses. The width, 3 feet, is the same in each case to accommodate 3-coil rows, to make pickup coupling less sensitive to lane position errors. The 4 point actuator allows PRM 16 to quickly swing down, in a road-surface parallel manner, towards the roadway during deployment. Similarly, when disabled actuators swing PRM 16 quickly back up to securely nest into a cushioned pocket located along the horizontal underside of the suspension. This “gears up” action can be manually initiated by the driver or automatically initiated by improper roadway clearance and debris. Part of the automatic retraction can be accelerated by the inherent up-swinging motion induced by physical pressure exerted by obstructions during forward motion of the vehicle. A forward facing PRM brush 144 normally clears the roadway surface under normal driving conditions. This brush may augmented by an additional brush or “air dam” like appendage mounted directly beneath the front of the vehicle, in line with, but apart from, the PRM 16. In this way small roadway debris can swept away without retraction. Major debris, obstructions or unsafe clearance conditions will however cause the brush to trigger a retraction thereby preventing serious harm to PRM 16. The heads-up display provides an indication of the state of PRM 16 deployment or retraction. Table 10 below provided the physical specifications for a preferred PRM 16.

TABLE 10

| PRM Physical Specifications | Car | Truck/Bus |
|---|---|---|
| Length - Feet | 11.2 | 33.6 |
| Width - Feet | 3 | 3 |
| Depth - Feet | 0.5 | 0.5 |
| Basic Shape - Cross Section | Rectangular | Rectangular |
| Number of PRM Coil Rows - # | 14 | 42 |
| Total Number of PRM Coils - # | 42 | 126 |
| Coil Width - Inches | 12 | 12 |
| Coil Length - Inches | 9.6 | 9.6 |
| Weight - Pounds | 20 | 60 |
| Volume - Cubic Feet | 16.8 | 50.4 |
| Pounds per Cubic Foot | 1.19 | 1.19 |
| Power Leads - # | 2 | 2 |
| Data & Aux Power Leads - # | 8 | 16 |
| Data & Aux Power Leads | Pigtailed Female | Pigtailed Female |
| | Conn | Conn |
| Mechanical Connections - for | 4 | 8 |
| suspension | | |

A further consideration is the use of a “brush” mounted in a “V shaped cowcatcher” fashion at the front of the vehicle and/or on the leading edge of PRM 16 in a manner as to just clear the roadway, brushing small debris away from PRM 16 as well as assisting in and triggering the vertical movement of PRM 16 away from roadway obstructions as might occur at slower speeds. In this manner, PRM 16 vertical distance to the PTM-CES 34 is safely maintained at nominally 3 inches. Both PTM 14 and PRM 16 coils are sealed and covered with a thick layer of tough plastic, fiberglass, carbon fiber, asphalt or other like material, made magnetically permeable by being heavily loaded with ferrite. Table 11 below sets forth the preferred PRM electrical specifications.

TABLE 11

| PRM Electrical Specifications | Car | Truck/Bus |
|---|---|---|
| Electrical Power - Kilowatts Peak | 28 | 84 |
| Continuous Power - Kilowatts | 28 | 84 |
| Power Dissipation Total - Kilowatts | 1.4 | 4.2 |
| Power Dissipation Per Foot - Watts | 125 | 125 |
| DC Primary Power Output Voltage - Volts | 400 | 400 |
| DC Primary Power Supply Current - Amperes pk | 70 | 210 |
| DC Secondary Power Supply Voltage - Volts | 12 | 12 |
| DC Secondary Power Supply Current - Amperes | 5 | 20 |

The output voltage and currents shown above are nominal and can vary from vehicle to vehicle as a specific vehicle's battery charge controller interface requirements may dictate. A worst case power dissipation can occur when the vehicle is parked or static over an activated set of PTM-CES 34 coils. In these instances there may be no moving air to assist in cooling. Therefore parking lot magnetic power transfer is limited to 1 KW per coil. Secondary power is supplied to the PRM 16 to power internal electronics such as actuators, proximity links and Data Link.

Power Receive Module (PRM) & Vehicle Interfaces

A vehicle's PRM 16 consists of a set of pickup coils, each with associated inductive reactance canceling AC capacitor and following high frequency bridge power rectifier and series parallel wiring of DC outputs to the vehicle's battery charge controller. Three wireless links—two proximity links and a data link provide for energy transfer interlocking, billing data and passenger internet communications. These components are housed in a rugged weatherproof enclosure that when enabled for power transfer by the driver, is lowered and suspended below the vehicle at a nominal 3″ fixed distance above the roadway.

Mechanical interface is accomplished by a suspension from the vehicle's front and rear axels and further augmented by roadway brushes that normally end 1″ above the roadway that serve both as a means for debris removal and as a means to trigger raising of the PRM 16 to a “stow” position when major obstructions are encountered, such as a bump at moderate speeds or a rough roadway condition at normal highway speeds. The front and rear ends of PRM 16 are tapered to a V-shape to further limit the impact from roadway debris under all conditions. A dash panel control is used by the driver to lower PRM 16 towards the roadway and otherwise enable PRM power transfer. The mechanical actuator and controller for this deployment mechanism is located within PRM 16 itself and operates through the mounting points where the vehicle's axel extensions meet PRM 16.

PRM control electronics insures that actual power transfer occurs only when the vehicle's ID has been deemed valid and PRM 16 is in a proper alignment with PTM 14 coils as determined by the proximity links 28 and 32. Proximity links 28 and 32 include a low frequency magnetic signaling transmitter that utilizes the vehicle's power pickup coils themselves as transmission elements. This arrangement naturally limits the coupling coefficient of the proximity signal to a given PTM 14 coil in a manner that corresponds closely to that of the actual power transfer coupling coefficient between PTM 14 and PRM 16 coils. This insures an efficient transfer of energy. Additionally, the Proximity Link 28 signal from the vehicle is modulated with the vehicle's ID, that is demodulated at each PTM-CES 34 within local magnetic coupling range. This allows a further check on the validity of transferring power during the period of a PRMs 16 actual proximity to a given PTM-CES 34 coil. Normally each PTM-CES 34 coil maintains a dynamic stack or list of valid IDs in its neighborhood as established via the Data Link 30, a wide band LAN based communications link between vehicles and the roadway. Real time Proximity Link IDs are then matched from within this list to enable real-time power transfer. Eventually, IDs are dropped from the ID list as a vehicle leaves a given PTM-CES 34 neighborhood and new IDs are stored from approaching vehicles. In this manner there is a real time ID determining element having a non-complex and low data rate requirement.

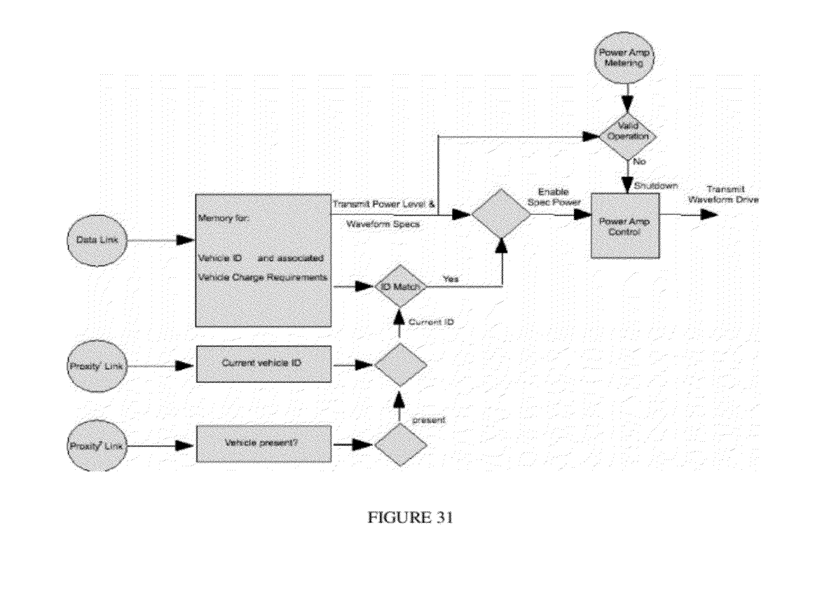

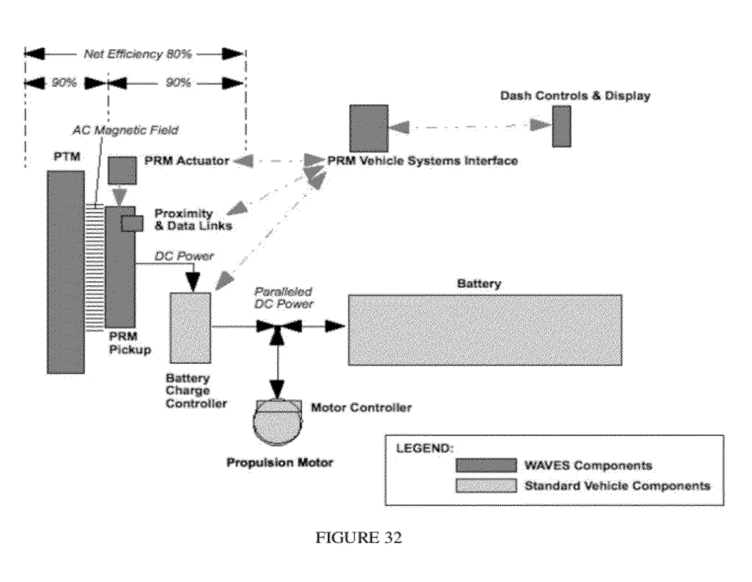

The data link 30, with its greater flexibility, is dedicated more towards non-time critical functions of enabling and billing functions and vehicular internet communications. The data link 30 is a wireless microwave RF link between PTM-CES 34 mounted and vehicle PRM 16 mounted transceivers with associated antennas. PTM 14 segment interfaces then contain necessary routers and network adapters that link PTM 14 fiber data lines (with data to and from passing vehicle PRMs 16) to the internet network in a manner that effectively achieves continuous connectivity between vehicles and the internet. The PTM 14 power control logic may be seen in FIG. 31 and the data link interfaces in FIG. 32.

The DC power output from PRM 16 is at a voltage and current which is directly compatible with the vehicle's battery charge controller. The charge controller is capable of handling the combined power for both battery charging and the vehicle's electric propulsion motor demands while underway. The vehicle's battery supplies energy in parallel with the charge controller, and is therefore able to cover peak power demands of the vehicle, leaving PRM 16 driven charge controller to supply the average demand for both battery charging and propulsion. This cooperative energy sharing arrangement takes advantage of the best of both energy sources while minimizing stressful requirements. The resulting net efficiency of the WAVES energy transfer is therefore high, nominally 80%. This efficiency can be broken down into two multiplicative components: (1) PRM 16 and magnetic field generation; and (2) PRM 16 and charge controller efficiency, both of which are better than 90%.

As explained above, there are both static and dynamic applications for WAVES 10. From a market development perspective it may be advantages to begin with static parking lot or household charging applications since they avoid the need for comparatively large effects upon infrastructure, cost and government involvement. Given that initially there will be no electric or electric hybrid vehicles available with an integrated PRM 16, PRM 16 may be offered as a manufacturer add-on or as an aftermarket add-on to the vehicle. As such it is important to minimize mechanical and electrical interfaces to the production vehicle thereby minimizing costs. Especially regarding electrical interfaces, it is useful to consider that PRM 16 be able to supply voltages and currents that are directly compatible with the vehicle's existing “plug-in” battery charging port, thus eliminating the need for vehicle charge controller modification and warrantee restrictions.

One way to accomplish this is to allow PTM 14 to be amplitude modulated (AM modulated) at 60 Hz such that the rectified and power carrier filtered PRM 16 output delivers 60 Hz standard voltages e.g. 110 VAC/220 VAC and currents e.g. 15 A/30 A. Note that this offers respectable charging rates of 1,650 watts/6,600 watts. AM modulation is simply and directly accomplished within each PTM-CES 34 by a 60 Hz logic level gating of the power carrier using the exciter “Carrier Enable” control signal. In this manner the parking lot or home market is served in a manner transparent to the magnetic link coupling employed by WAVES. Vehicle ID data within the PRM's Proximity Link 28 determines the use of this modulation. Thus the same PTM roadway 36 embedded hardware is made to work with both early static market PRMs 16 and later, dynamic and vehicle integrated PRMs 16 without change thereby providing a seamless path towards the end goal of a ubiquitous roadway infrastructure.

Power Receive Module (PRM) Magnetic Power Coupling and Control

PRM 16 unit is suspended below the vehicle in a manner that allows vertical deployment towards the roadway when the driver enables WAVES to be used to couple power from the roadway. It is preferred that PRM 16 be flexibly suspended such that roadway obstructions cause an immediate and dampened retraction and preferable that the main suspension be from the wheel axels as opposed to underbody to minimize vertical motion effects from the vehicle's suspension. In this manner PRM 16 vertical distance to PTM 14 coils can be safely maintained at nominally 3 inches. It can be noted that both PTM 14 and PRM 16 coils are sealed and covered with a thick layer of tough plastic or other like material, made magnetically permeable by being heavily loaded with ferrite. This magnetically permeable layer forms a rugged Magnetic Field Window that removes the Tank Coil 74 from the physical environment at the roadway surface while virtually magnetically displacing coil 74 to the very top surface of the roadway thereby maintaining the smallest possible coupling gap to the vehicle PRM 16. In this manner the coils on both roadway and vehicle are protected without adding the thickness of the plastic to the air gap through which magnetic coupling occurs.

PRM 16 consists of several coils made resonant at the PTM operational power frequency to cancel the inductive reactance of each coil and thereby maximize coupled power. The total power coupled is the sum of coupling to all the PRM coils at any one time. By arranging PRM coils in a contiguous line down the center of the vehicle, from front to back, one can achieve this maximum power coupling with a similarly arranged line of PTM coils, located along the middle of the driving lane, by centering the vehicle within the lane. The more PRM coils that are in alinement, the more power is coupled. This highly useful attribute of WAVES to essentially provide greater power coupling in proportion to a larger number of coupled coils, such as on larger vehicles, inherently matches power demands across a range of vehicle types utilizing a common roadway PTM.

Integrated Power Receive Module (PRM) Design

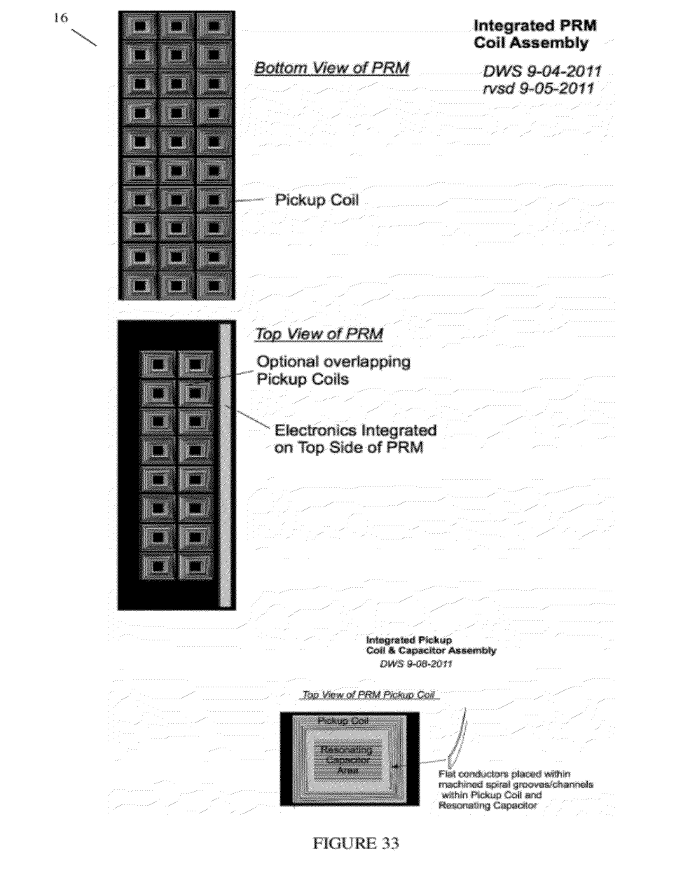

An integrated pickup coil and rectifier assembly for PRM 16, as shown in FIG. 33, can be designed using techniques described previously within the above referenced Integrated Tank and Link Coil Design section. Grooved channels for each pickup coil can be machined or otherwise formed within an electric insulator sheet and subsequently filled with conductor material as previously described. Such a sheet can then be used as the substrate for mounted/integrated electronics required to interface with the vehicle's electric system. Such a formed sheet assembly can contain one and up to an entire PRM's contingent of coils, machined and assembled as a single unit. An outer cover can serve to envelop, protect and stiffen the entire PRM producing a robust sealed unit suitable for suspension under a moving vehicle.

Additional coils can be integrated within PRM 16 sheet assembly to serve as magnetic signaling pickup sensors that for instance can enable roadway or parking lot power transfer or transmit vehicle ID and/or other data from the vehicle to PTMs 14. One interesting design using multiple overlapping PTM 14 coils an minimize scalloping or misalignment losses during power transfer from associated PTM 14 coils. Rectifier/DC outputs from such interstitial and overlapping coils are or tied with other outputs to achieve graceful power summation as alignments between PTM and PRM change, sometimes continuously. Separate coil channels can be made from both sides of an electrical insulating sheet as one way to achieve coil overlap consistent with the previous implementation.

Note that the sheet material within which PRM 16 Pickup Coils are embedded can contain ferromagnetic material designed to enhance the concentration and coupling of the received magnetic field as well as provide the overall electrical insulation properties required.

It is possible to integrate pickup coil resonating capacitors within each coil to reduce size and cost. Furthermore such capacitors can be fabricated within the same material utilized to form the PRM 16 chassis (e.g. HDPE) and could be compactly located within the center area of each pickup coil. One such fabrication is to mill vertical slots into the (insulating) chassis material to into which metal capacitor plates are subsequently inserted to form the resonating capacitor. The separation between plates forming the required dielectric separators between opposing plates of the capacitor.

PRM to Vehicle Interface Design

Initial PRM 16 design and demonstration development focuses upon static charging capability, capable of supplying up to approximately 6.5 kw of continuous power through the vehicles conventional 60 Hz AC power connection. A PRM output interface can be provided that duplicates 220 VAC 60 Hz input such as to minimize wiring changes to the vehicle's charging circuitry. This can be accomplished by PTM waveform control wherein either the magnetic power carrier waveform is modulated or preferably, PRM 16 rectifier outputs are switched in polarity at a 60 Hz rate to form a (filtered) square wave suitable for direct connection to the vehicle's grid compatible input. Regulation to maintain standard peak to peak AC voltages can be accomplished by circuitry within PRM 16 (e.g., duty cycle modulation of rectified output) or within a feedback loop to PTM 14 magnetic waveform power regulation or both.

As requirements to demonstrate greater energy transfer to the vehicle are presented, there will be a need to interface high DC power transfer to the vehicle's propulsion battery. Depending upon the vehicle's existing charge controller design and battery technology, separate charge controlling circuitry may be required within PRM 16 battery interface, along with associated wiring, software and circuit changes within existing vehicle components. The issue becomes one of making sure that the battery is always protected from receiving more energy than it can safely or effectively use. If the vehicle is under motion, some or perhaps all of PRM 16 power can be utilized by the vehicles motor with any excess power available for battery charging.

The preferred embodiment is that an additional (Class III) charging port is available within the vehicle's onboard charge controller and that this can be enabled while the vehicle is underway. In this way significantly high power charging can occur at all times and under proper supervision to insure safety and battery lifetime. PRM 16 electronics would then appropriately interface to this port as required (e.g. several hundred VDC at high currents netting high power transfer capability). Baring the availability of such a high capacity port, it may be possible to slave PRM 16 charge control circuitry to the vehicle's charge controller current regulation signal or other proxy signal such that a parallel battery charging circuit can be wired directly from PRM 16. This parallel circuit would of course be separately fused and current controlled to inhibit catastrophic failure from occurring. Alternatively, there may be a way to essentially mimic the operation of the vehicle's dynamic braking energy recovery system wherein associated circuit paths can be energized by PRM 16 in lieu of the vehicle's motor-as-generator energy source.

Dual Mode—Power Receive Module Charging or Physical Plug in Charging

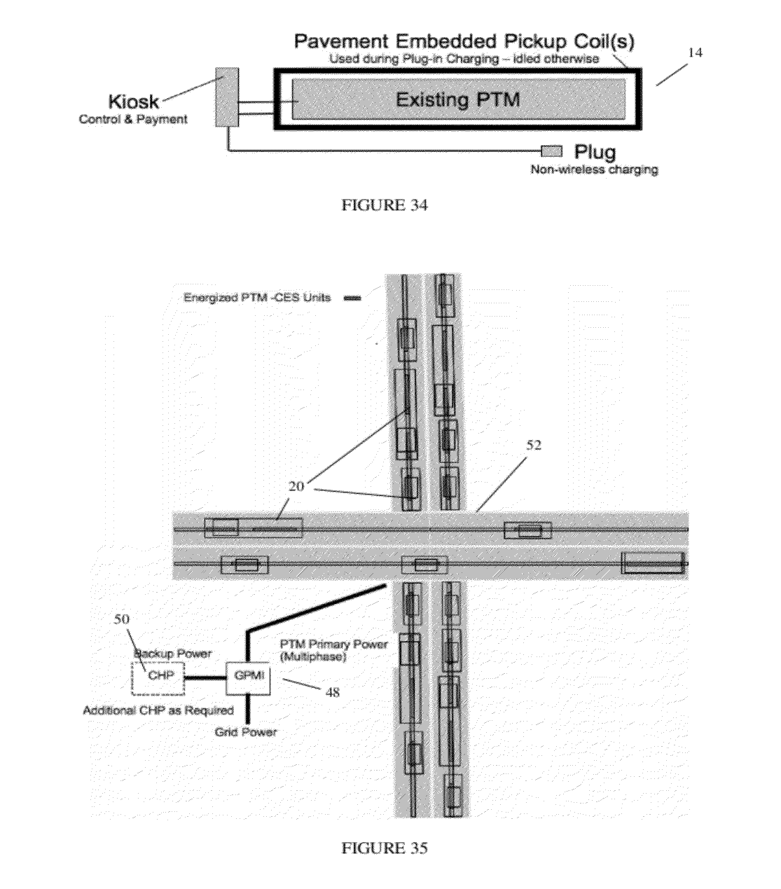

There may be a need to be able to support both wireless and hardware plug in charging at a common parking site. This could be a way to ease market penetration, especially during the early phases of market acceptance where the majority of EVs are set up to only interface with plug charging. Referring to FIG. 34, a dual mode may be accomplished by essentially locating an auxiliary PRM 16 pickup coil(s) and associated rectification/60 Hz waveform generation within/near the roadway located PTM 14 and appropriately combining and interfacing the embedded PRM 16 power to a plug station mounted adjacent to the parking area to be serviced. FIG. 34 depicts one such method of achieving dual mode charging. A WiFi billing interface normally associated with PRM 16 can also be co-located with this kiosk or plug station to serve as an external energy metering and billing interface for the vehicle's driver. PTM internal charge control logic automatically adapts and insures that an appropriate power level is utilized in charging, same as would occur during wireless operation, however in this case the coupling between internally mounted PRM 16 and the tank coil 74 of the PTM 14 would be significantly higher. Therefore when the plug mode is enabled the external magnetic (leakage) field would be very low.

Conversely, when the wireless mode is desired, the vehicle's PRM 16 is utilized, the Plug and associated WiFi is disabled and PTM pickup coil within PRM 16 simply idles with essentially no power being supplied to an external (plug) load. The influence of the imbedded idling PTM pickup coil can be controlled in terms of capacitance within the design by appropriate spacing from the Tank and Link coils 134 and 132, respectively. Furthermore, due the availability of significantly greater coupling between these co-embedded coils, one may dispense with a resonating cap on the internal pickup coil, thereby decreasing it's influence in this regard, even further.

Roadway Intersection Installation

Intersection installations as depicted in FIG. 35 offer a key transitioning and long-term solution to urban wireless electrification for vehicular traffic. It allows vehicles that are waiting at intersections to receive high rates of charging as well as receiving energization and charging during acceleration upon leaving. Through or opposing traffic can also receive high rates of energy transfer while passing through such intersections. Given that successive intersections are electrified, vehicles traversing a series of such intersections can be entirely compensated for, indeed net charged, for their energy needs while traveling. Since a continuous PTM roadway installation is not required, intersection electrification becomes an excellent intermediate step in highway electrification, requiring significantly less investment in infrastructure while at the same time having good grid access. It is important to note that this city environment can also benefit from the incorporation of CHP for WAVES in cooperation with the needs of heating, cooling and powering of nearby buildings.

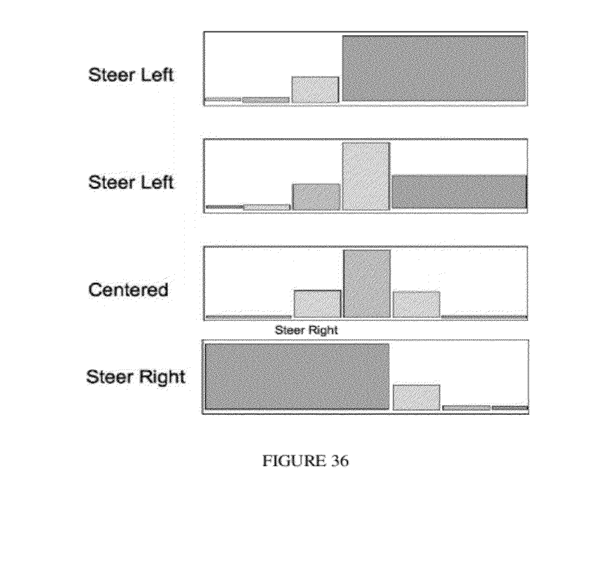

Referring to FIG. 36, a simple “heads up” indicator notifies the driver where to steer within the lane to achieve maximum energy transfer based upon field sensing within the vehicle's PRM 16. It is anticipated that following a relatively few hours of use the driver will unconsciously refer only sporadically to this display, having been accustomed to driving with PRM 16 centered on lane and with knowledge that it is not critical that power transfer needs to be present 100% of the time. This sensing, in the future, can linked to steering and automated to the degree allowed by the safety and reliability of a future WAVES coordinated traffic flow system. In the initial phases of such development a servo-like linkage from lane sensing to steering would induce a “sweet spot” or slight inclination torque that gives the driver a steering wheel based sensory feedback that indicates steering for optimal power transfer.

Note that the future is very bright with regards further driving automation. Since individual PTM-CES 34 modules relay real-time vehicle ID and position within the roadway and operate as a 2-way data link to the vehicle, a highway system could indeed issue real-time commands to the vehicle to control steering, velocity and spacing to adjacent vehicles. This type of system would of course require safety backups such as now being deployed with vehicular radar, in a manner that produces a truly robust automated system.

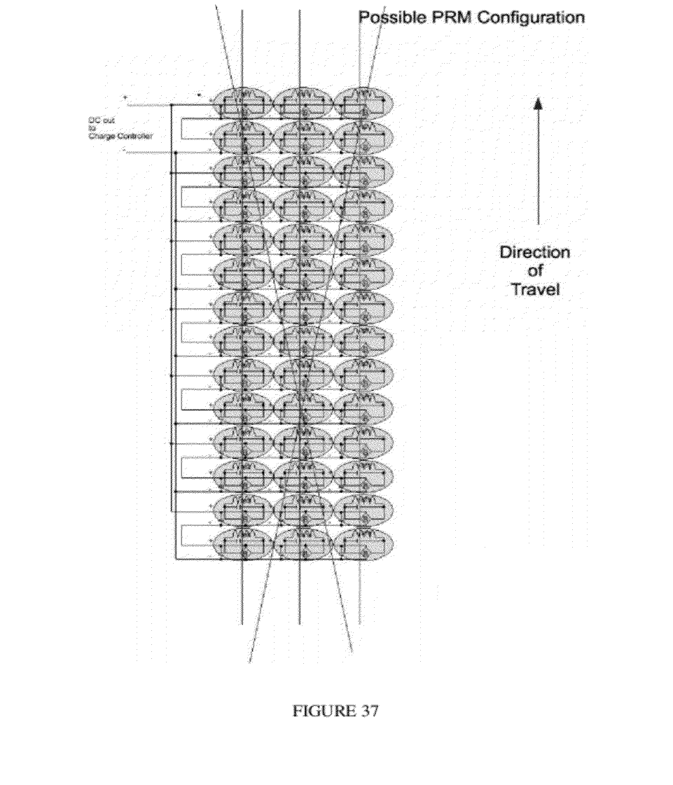

Referring to FIG. 37, the ability to widen the coupling aperture of PRM 16, such as to reduce driving accuracy requirements, requires additional parallel lines of PRM 16 coils. Each parallel line of coils effectively adds directly to the cross-roadway pickup aperture in a passive manner given an appropriately designed interconnection between pickup coils.

For the 1.0 foot wide×0.8 foot long coils at both PTM 14 and PRM 16, the useful lateral driving accuracy requirements are 1.0 foot (+−0.5 foot) per line of parallel PRM 16 coils. The nominal number of parallel PRM 16 coils on a vehicle is 3, yielding a 3 foot driving accuracy requirement for optimum power coupling, or +−1.5 feet either side of the center of a given lane. This is a minimal system for accommodation of driving errors and could be linearly expanded by the addition of parallel lines of coils with minimal additional cost to PRM 16.

An appropriately designed interconnection non coherently combines the AC power from separately roadway coupled individual PRM 16 coils. First the AC power carrier frequency resonant PRM 16 coils are individually rectified to produce DC power at nominally 200 V RMS @ 10 A RMS per coil. Then, individually rectified (potential) coil power sources are then parallel wired laterally across the three lengthwise running (column) PRM 16 lines of coil rectifiers to instantiate the required widened coupling aperture. This widened aperture is achieved since any one or more of the three lateral (row) coil sources can feed DC power to the PRM's output. This paralleling of coil rectifiers creates Row-DC power outputs, one for each row of PTM 14 coils (laterally across the vehicle's direction of travel). Row-DC outputs are then wired in a series parallel arrangement to achieve the desired voltage and current for input to the vehicle's battery charge controller.

WAVES 10 is a way to immediately normalize peak battery energy demands to allow them to become, at most, average energy demands for the majority of driving modes and applications. This energy normalization increases overall transportation system efficiencies while at the same time eliminates electric vehicle “range anxiety”, charging time and effort. Thus WAVES accelerates DOE's critical drive to electrify ground transportation by the promotion of a broader and more robust electric vehicle market through lowered cost, increased performance and convenience.

Wireless Automated Vehicle Energizing System (WAVES) Prototype

An aggressive prototype development program has resulted in the design, construction and testing of a 3 Coil Demonstration Unit (3CDU). 3CDU Prototype Performance—Testing has produced a compact 115 VAC powered prototype capable of being transported to a non-laboratory based meeting where 115 VAC 20 A fused standard wall plug power is available. It is capable of wirelessly transmitted (magnetically linked) power transfer of approximately 1.5 kW across a 6″ gap to a resistive load bank consisting of 36 incandescent light bulbs. The operational frequency is nominally 360 kHz. In addition to the power transfer function, power management circuitry is incorporated to maintain a fixed power transfer at gaps less than 6 inches so as to maintain a safe power level at these closer coupling distances. Internal remote actuation, GFI and fusing are added safety features embodied within the design. The overall operational efficiency is estimated to be greater than 90% based upon light brightness and DC power levels input to amplifier modules. Lack of significant heating in power electronics and Tank Coils and Capacitors provides confirming evidence of very high operational efficiency.

3CDU Prototype Detailed High Level Design

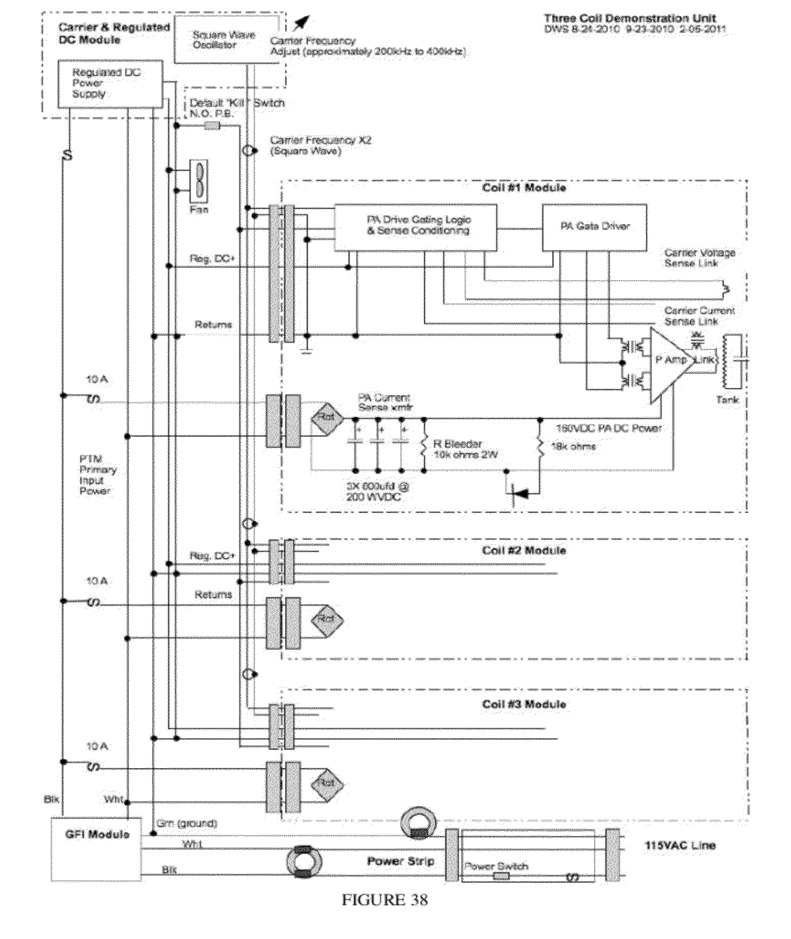

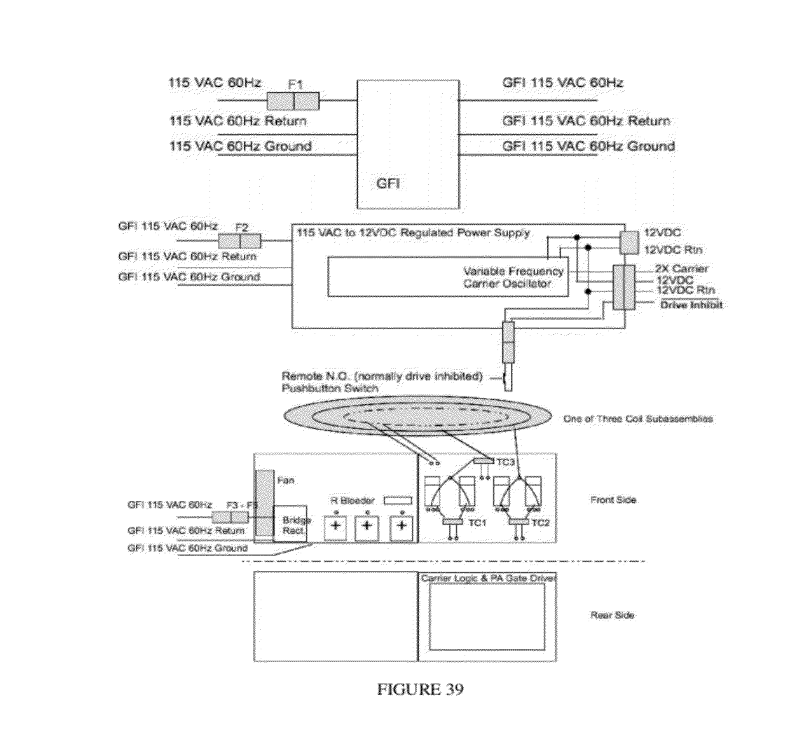

FIGS. 38 and 39 illustrate the 3CDU as comprised of 3 power amplifier modules, each with associated power transformer-less power supplies (AC-DC 3.5 A@ 150 VDC). A common oscillator and 12 VDC control electronics power supply module provides carrier drive and control electronics power to each amplifier module. This subassembly forms PTM 14. A separate pickup coil and load bank subassembly forms PRM 16. PRM 16 is “floated” above PTM 14 on roller spaces to establish a 6″ air gap between them.

3CDU Prototype Power Amplifier Schematic

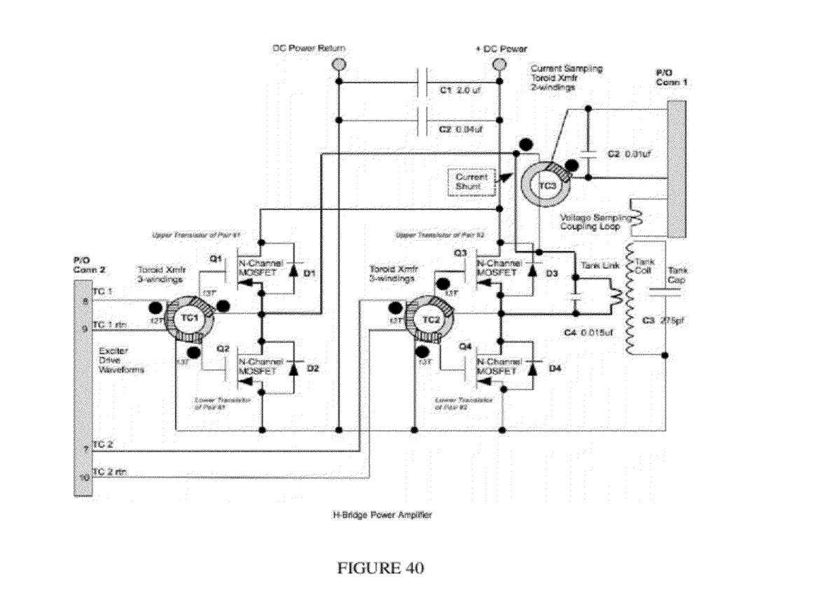

FIG. 40 shows the 3CDU power amplifier as an H-Bridge configuration 70 of 4 commercial off the shelf low cost power MOSFET transistors. A current sensing transformer within one leg of the H-Bridge 70 is used to provide feedback to associated power control electronics that can suppress 1 or more half cycles of carrier generation to accomplish power regulation. Also shown are tuning capacitors that cancel Tank Coil Link 132 inductance to enhance efficiency. Tank Coil 134 and Tank Cap 120 are shown in a parallel resonant configuration (important to minimize power and voltages with under-coupled of PRM load cases) to complete the magnetic energy generation process associated with the PTM function. High frequency toroidal gate drive transformers provide the voltage isolations, phase relationships and low impedances necessary to adequately drive power MOSFET gates.

The use of an H-Bridge 70 effectively doubles the voltage swing on the Tank Link as related to the HBPA DC supply voltage, thereby allowing a factor of 4× power increase over single ended switch configurations. This is very important in reducing PA primary supply voltages for any given power output demand. Furthermore the ratio of Tank Coil 74 turns/Link (or autotransformer primary) turns is a further source of voltage increase and resultant V̂2 increase in reactive power availability within the Tank Coil 74 field. Thus, by halving the number of Link turns for a given Tank Coil 74, the reactive/magnetic field power will increase by 4. This of course places voltage related stresses upon the Tank Coil 74 and Tank Cap 120 and corresponding insulation requirements all around, including link to Tank Coil 74 insulation. Furthermore, not immediately obvious, the net reactive energy cycling and stored within the parallel resonant tank circuit, similarly increased by such means, and available for (PRM) load coupling can also feed back in reverse, back to the power MOSFET switches during periods of normal (gate drive modulation for power control) and abnormal (load failure or rapid changes) conditions. Thus stored energy related transients can generate reverse voltage spikes and current surges that can be immediately and catastrophically destructive to MOSFETs within the HBPA. Reverse voltage spikes can defeat the nominal capability of intrinsic MOSFET diode designs and stimulate the parasitic generation of a destructive avalanched transistor within the FET junction monolithic structure, permanently destroying said structure and producing severe current surges in surrounding components. Furthermore, gate “shoot through” due to before mentioned load related “spikes” can also destroy FET junctions with similar catastrophic results. High-voltage ultra-fast diodes have been paced in reverse bias across each MOSFET to inhibit the introduction of reverse voltage “spiking”. Direct gate transformer drive connections are also made to a low inductance secondary and low voltage step up toroid transformer driven by a low impedance bipolar transistor driver configuration as a means for reducing the possibility of “gate shoot through”. Additionally (discrete and other) capacitance has been reduced surrounding each MOSFET and high voltage rated (2× to 4× supply DC) MOSFETs are employed to reduce transient current requirements while increasing intrinsic voltage standoff capability. It has also been learned that it is important to maintain phase matching between (especially) adjacent HBPAs and associated Tank Coils 74 in order to reduce the possibility of outer Tank Coil winding to adjacent Tank Coil arcing and transient generation. This phase match is controlled by both HBPA drive signal phase relationships and by Tank resonant frequency matching (not immediately obvious). Future designs can mitigate such Tank to Tank phase shifts by closing a phase locked loop solution around a measurements of instantaneous phases within each tank magnetic field such as to accommodate load dynamic and circuit related phase mismatch.

3CDU Tank Coil Design

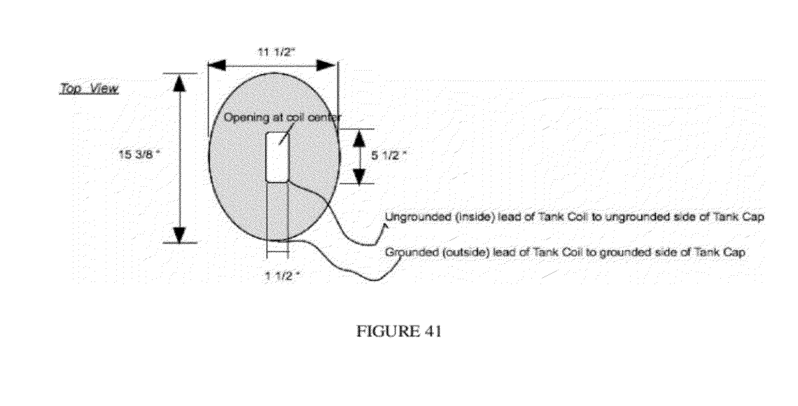

FIG. 41 illustrates the Tank Coil 74 design associated with each 3CDU Power Amplifier Module. High frequency AC skin effect and resistive losses are important factors to control within the design. The design is a single spiral coil constructed in a flat plane from hand formed Litz wire 126 comprised of 4 strands of #20 insulated coated solid copper of circular cross-section. Winding to winding separation and insulation within the Tank Coil 74 is important to withstand high voltage per turn differentials.

3CDU Prototype Tank Cap Design

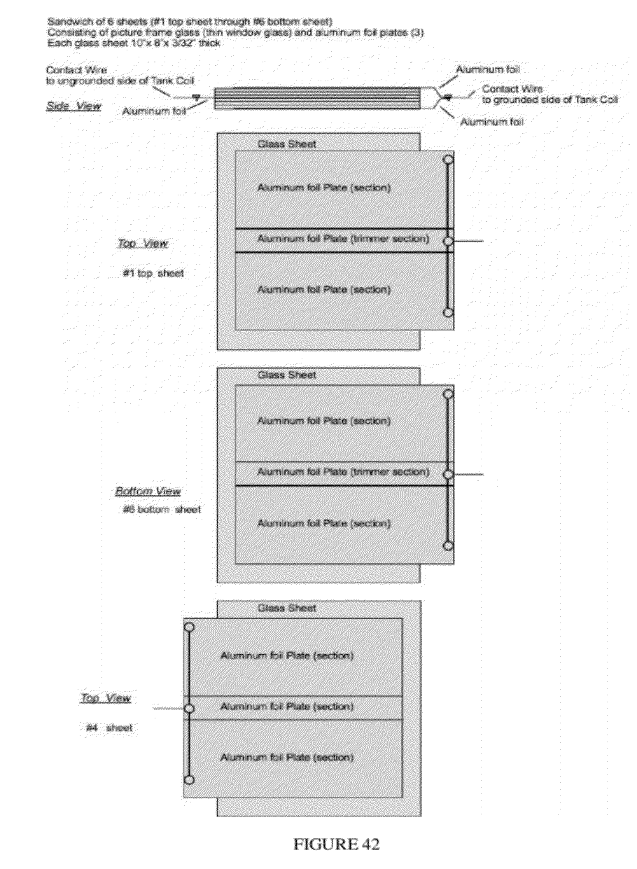

FIG. 42 shows the 3CDU Tank Cap 120 design that provides critical high voltage rated and low dielectric and conduction losses necessary for reliable and efficient operation. Note the center “trimmer” section critical to being able to match Tank resonance to desired operational frequency.

3CDU Prototype Pickup Coil Design

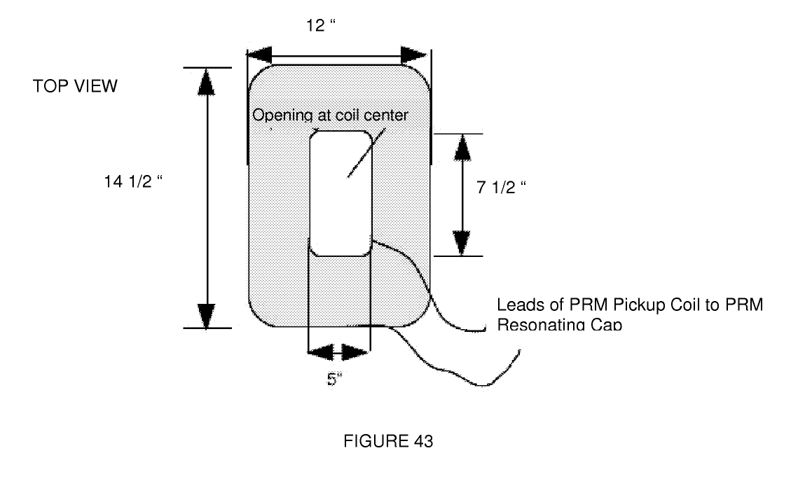

FIG. 43 illustrates the 3CDU pickup coil design within PRM 16. This is a critical function in achieving a maximal coupling and efficient energy transfer from PTM 14 to PRM 16. High frequency AC skin effect and resistive losses remain important factors to control within the design. The design is a single spiral coil constructed in a flat plane from hand formed Litz wire comprised of 6 strands of #20 insulated coated solid coper of circular cross-section.

3CDU Prototype Pickup Coil Resonating Cap Design

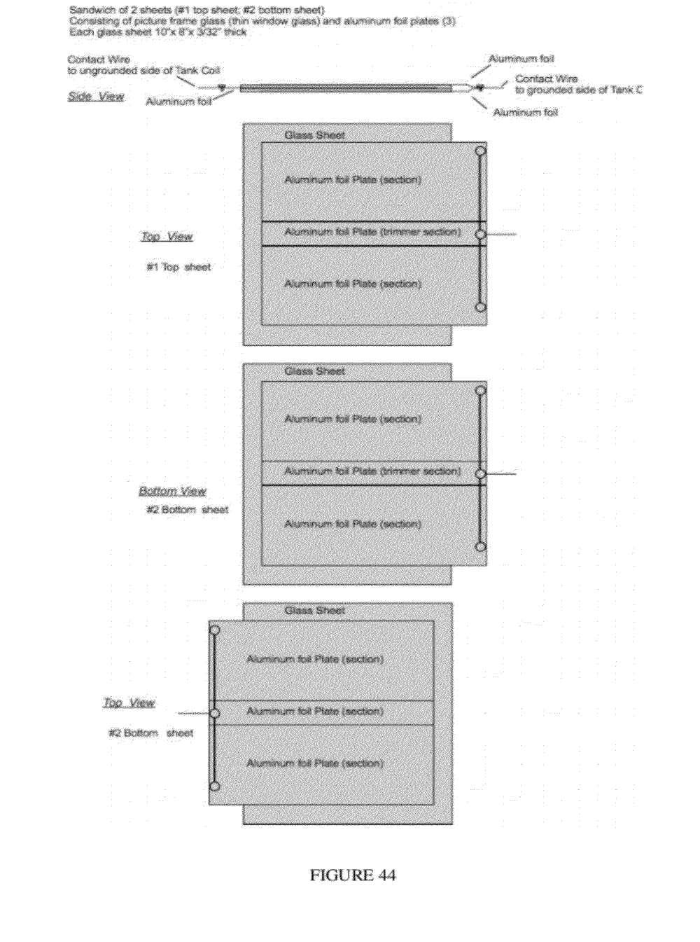

FIG. 44 illustrates the 3CDU pickup coil resonating cap design within PRM 16. This is a critical function in cancellation of the pickup coil's inductive reactance and achieving a maximal coupling and efficient energy transfer from PTM 14 to PRM 16. High frequency AC dielectric and resistive losses are important factors to control within the design. Note the center “trimmer” section critical to being able to match Tank resonance to desired operational frequency.

3CDU Prototype Power Amplifier Control Electronics

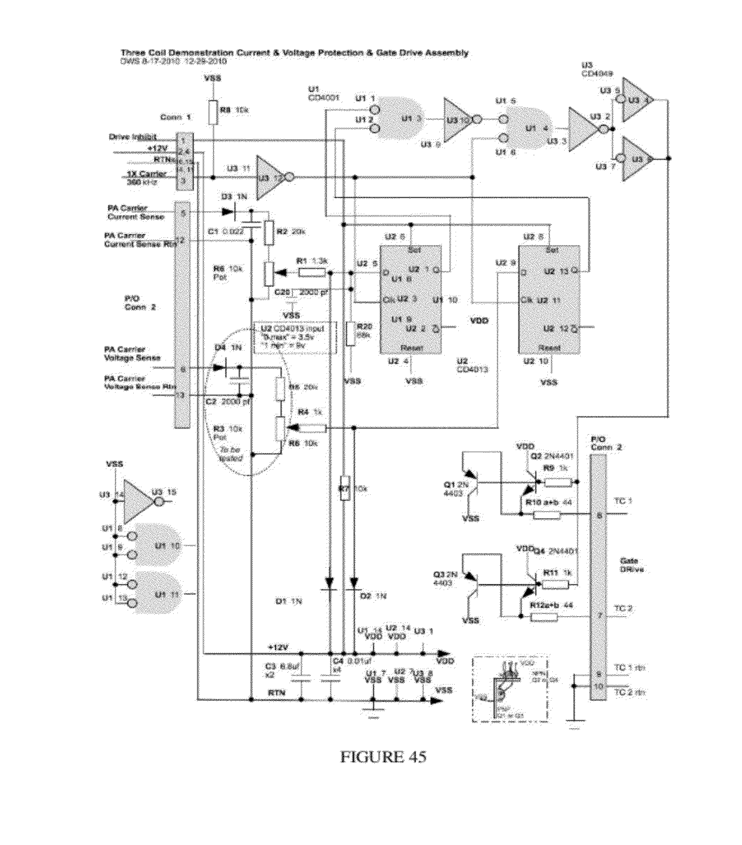

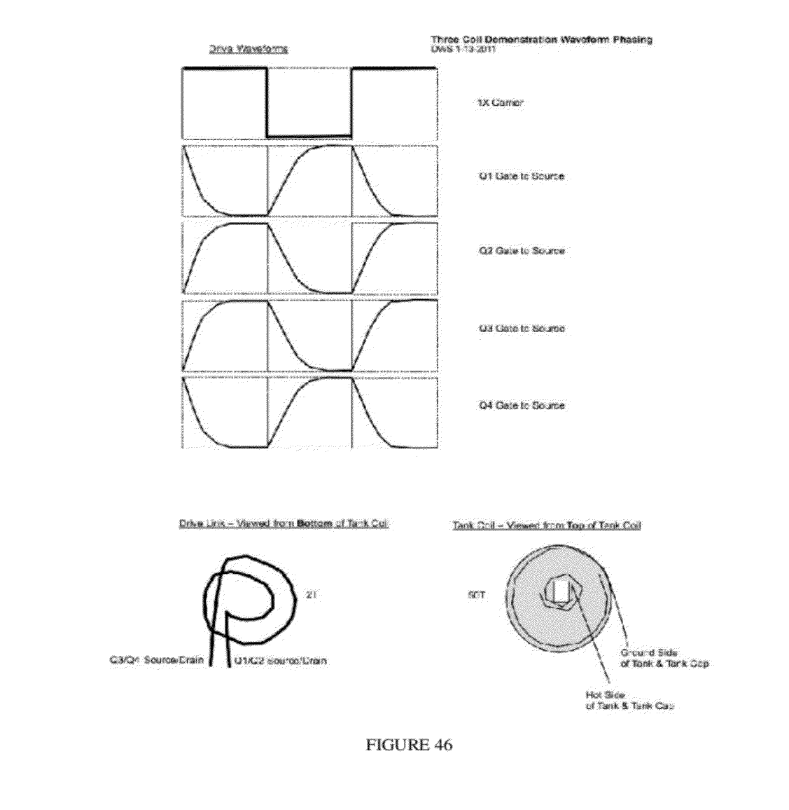

FIG. 45 illustrates the 3CDU control electronics design within the PA 122 Module. The functions include PA 122 waveform over-current threshold detection and associated PA drive gating. PA 122 waveform over-voltage threshold detection and associated PA drive gating. Drive signal inhibit from externally derived control signal. Transistor drivers suitable for driving high MOSFET gate capacitance via PA 122 located transformers. The PA gate drive and coil polarity relationships may be seen n FIG. 46.

3CDU Prototype Variable Frequency Electronics

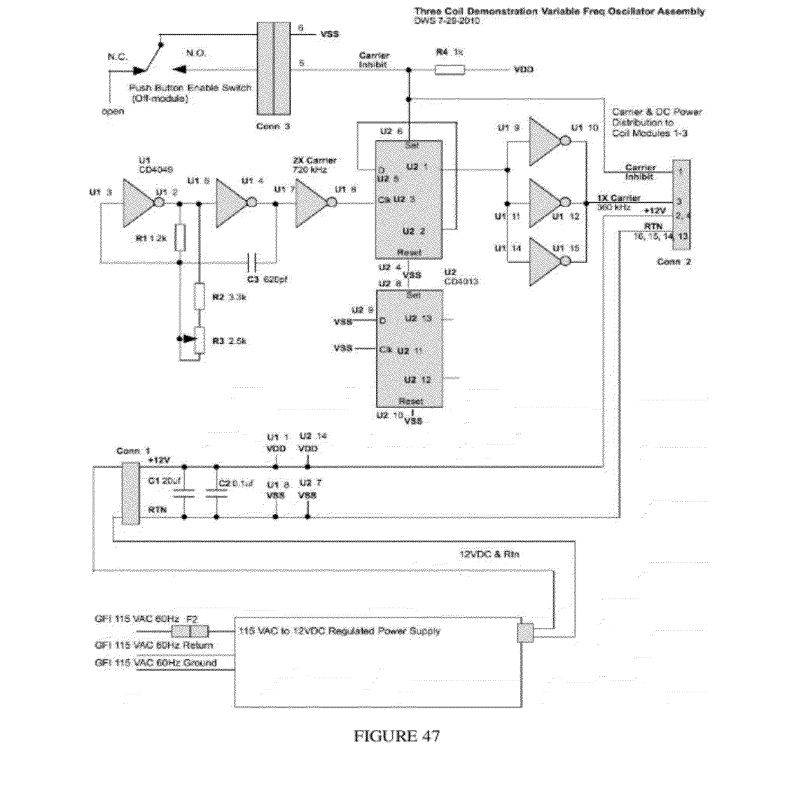

FIG. 47 illustrates the single Variable Frequency Oscillator and associated 12 VDC power supply for it and the 3 PA 122 module Control Electronics. The functions include carrier waveform generation and associated external/operator inhibit switch for PA 122 drive gating.

3CDU Prototype PTM Chassis Layout

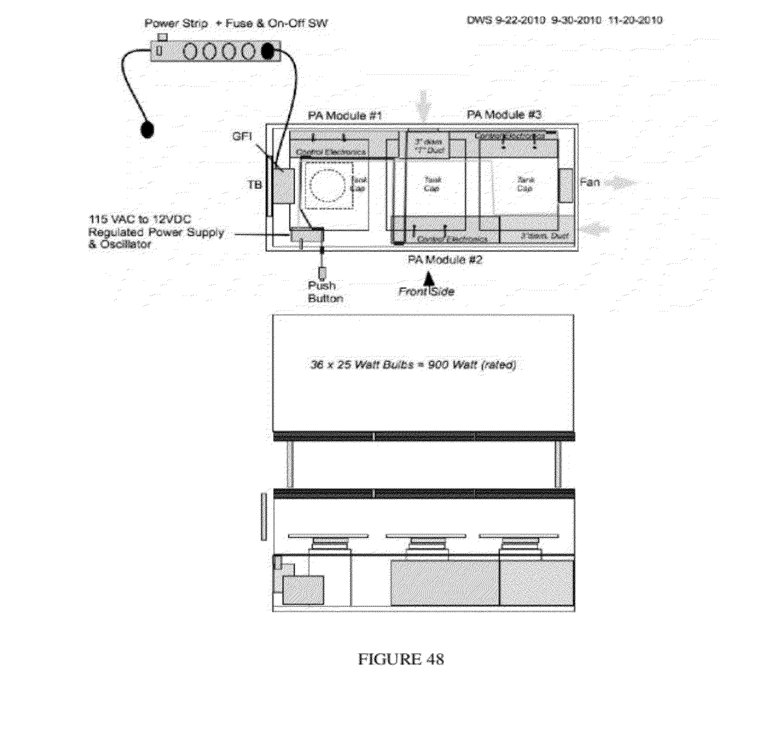

FIG. 48 shows the physical relationship between major subassemblies within the PTM chassis and relationship to PRM 16 and co-located load bank.

3CDU Prototype PRM Chassis Layout

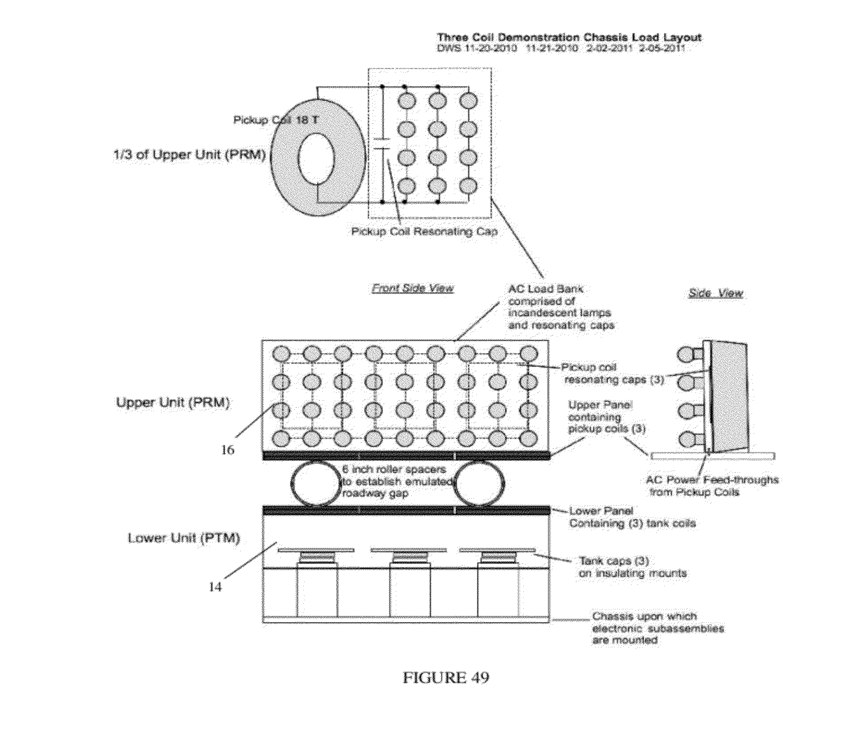

FIG. 49 illustrates the physical relationship between major subassemblies within the PRM chassis with co-located load bank and relationship to PTM 14. Three sets of pickup coils associated resonating caps and 12 incandescent bulbs are shown. Bulbs are wired as 3 subsets of 4 bulbs in series, with all subsets wired in parallel to form a single resistive load for each pickup coil. Thus a total of 3×12 or 36 bulbs comprise the total load bank. This load bank is capable of safely dissipating 1.5 kW for reasonably long periods of steady state/CW wireless power coupling during demonstrations.

It is significant to note that metal foil covered plastic has been used in the construction of the 3CDU Prototype. Rectangular cell sheets of plastic were covered with aluminum foil tape and electrically connected to power and module grounds to form a cohesive termination of residual ground current loops and shielding to help attenuate any unintended RF radiation. The additional use of individual heavy aluminum foil covers over control electronics at each PA 122 module is a means to protect sensitive electronics from power carrier magnetic field induced interference. The use of such foil conductive materials is a fundamental means for reducing weight and cost, while allowing the use of plastics and other lightweight, tough and flexible structural materials for the body of PTM 14 or PRM 16 construction. The use of foil materials are especially relevant to a resultant conduction verses weight efficiency match to the relatively shallow skin depth of the majority of conducted currents at Power Carrier frequencies.

Note that the completed prototype was successfully operated and total coupled power levels were estimated to be in excess of 1000 watts, while the operational efficiency was estimated to be greater than 90% from line to load over a 6″ air gap.

Power Transmit Module Energy Transfer and Waveform Management Features

One important aspect of the present invention is the inclusion of fail-safe & self-protection features integrated within each PTM-CES 34 enable low failure rates, performance monitoring and autonomous fault location. Included among these are the automated power fold-back and/or shutdown to protect against abnormal load conditions or component failures.

Another important feature of the present invention is the soft adaptability to flexibly meet Differing Vehicle Interfaces and Operation with minimal or no added vehicle hardware are provided by the RF Data Link 30 interactivity with vehicle electronic control systems. Critical real-time operational control is facilitated (via software) to accommodate variations in battery state of charge, apportionment of energy between battery and motor, acceleration and braking operations, traffic status and other. The ability of PTM 14 to electronically modulate bursts of energy to create 60 Hz/50 Hz or other AC power frequencies and voltages as direct output from PRM 16 allows direct charging or vehicle powering from conventional “plug in” interfaces. A “smart roadway” and “smart parking area” is created by such an environment, delivering only appropriate levels and formats of energy to the vehicle or otherwise effecting vehicle systems behavior to achieve the safe and efficient operation.

Yet another important aspect of the present invention is the high power generation efficiency achieved by power amplifier gating and parallel resonance within the Tank Coil 74. The Power amplifier 122 remains gated off when no vehicle loads are present or enabled. The MOSFET amplifier configuration allows near zero power dissipation whenever gate drives are removed. The inhibiting of Power Amplifier 122 gate drives for all times except for when the vehicular load is present is therefore a primary way of limiting losses. Additionally, the use of a parallel resonant tank circuit as the magnetic radiator allows losses at this high power point to be a percentage (small) of the power coupled to the vehicular load and not constant, thus further facilitating efficiency.

A further advantage of the present invention is the closed loop charging power regulation via interactivity between PTM 14 and PRM 16 over the Data Link 30 with data from vehicle charge sensors providing a means for controlling delivered power and consequently reducing the need for vehicle charge control hardware while increasing safety and efficiency. In this way PTM-PRM power is transmitted directly to battery 26 without passing through added high power electronic control systems onboard the vehicle, in the amount dictated by real time battery storage and environmental needs.

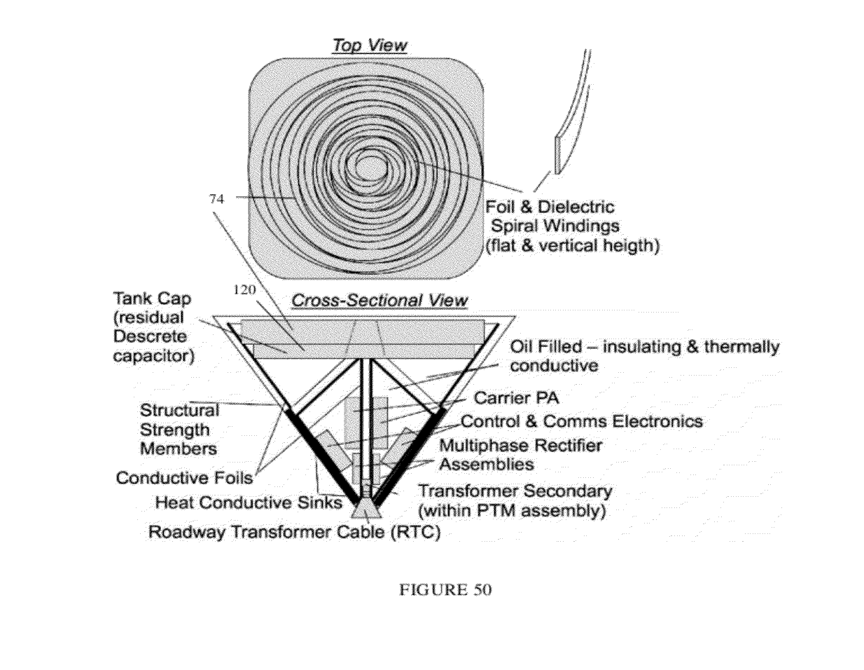

As seen in FIG. 50, yet another important aspect of the present invention is the integration of the Tank Coil 74 and Tank Cap 120 into a common single integrated component utilizing conductive foil or otherwise high area conductors with dielectric spacing to establish parallel resonance. This approach minimizes high voltage wiring and high voltage Tank Cap 120 requirements. Further integration of drive link coupling as an autotransformer at the grounded end of the Tank Coil 74 is a further reduction in discrete components (note that foils can readily serve as effective conductors within both capacitors and coils at the frequencies nominally employed within power electronics). Foil construction is especially relevant to maintaining low weight and cost while reducing skin effect losses associated with AC current transfer.

Roadway Physical Locking can be accomplished by a centralized vertical bolt with special keying to inhibit theft at each PTM-CES 34 module. This bolt travels within central reinforcement structural strength member that is environmentally isolated from internals of module. The bottom end of bolt engages with bottom of roadway trench to secure module to roadway. The attachment to roadway trench can be indirect via the RTC wherein the RTC is independently and periodically secured to the roadway trench and provides an appropriately located and spaced socket for the vertical bolts from the top of PTM-CES 34 modules.

The present invention also involves Faraday and non-resonant shielding of PTM 14 and roadway surface located Tank Coils by the use of nonmagnetic metal skins, including foils and films that surround individual PTM-CES 34 and PTM 14 components. The purpose being to significantly reduce the unintended emission or radiation of RF energy, especially at the GPMI and power carrier frequencies and related harmonics and sidebands, without significantly effecting magnetic field coupling to vehicles, either at power or signaling frequencies. The use of a metallic skin overlay over the top (roadway level) of the Tank Coil is especially significant in this regard, this skin can be patterned to provide RF attenuation while at the same time remain transparent to magnetic fields utilized by WAVES. Patterning in effect can be non-resident at power carrier and magnetic signaling frequencies thereby minimizing respective induced currents.

The present invention also includes thermal transfer and high voltage insulation by the use of an oil that surrounds high voltage & high power components (especially power carrier components such as Tank Coil Cap 120, high power amplifier components and perhaps Tank Coil 74). Oils such as silicon based oil have both excellent thermal conduction/convective/distribution properties and excellent high voltage insulating properties that when properly employed internal to PTMs 14 allows corona suppression and heat dissipation to outer and lower subsurface areas of the roadway trench where lower temperature promote efficient heat transfer at correspondingly lower operational temperatures. Such a design limits moisture penetration ant related corrosion and electrical conduction issues. Furthermore the potential exists to eliminate solid dielectrics within critical capacitors such as within the Tank Cap 120. Such oils can serve this function directly while again promoting heat transfer from high power capacitors.

The “V” Shaped PTM 14 of the present invention promotes efficient design for heat transfer from “V” bottom areas of PTM 14 to external side-walls and trench. The “V” shape is also an efficient volumetric match to the needs for a relatively large surface for roadway-level Tank Coil 74 at the top of the “V” and the relatively smaller dimensioned and volume associated with power electronics potentially located lower down within the “V” cross-section. The Tank Cap 120 could be conveniently integrated as a distributed capacitance within the Tank Coil 74 itself or given the need for added capacitance could be a separate component located directly below Tank Coil 74. High area as available within this region of the “V” is an advantage in lowering the cost and mounting of such capacitors especially at the frequencies nominally employed by the power carrier. Advantage can also be made of the vertical dimension of the “V” for such Tank Cap 120 location while overall volume is conserved over other perhaps rectangular cross-sections. The “V” cross-section also promotes ease of installation minimizing additional or difficult filing of roadway material both at surface and subsurface of PTM 14. Additionally, and critically, The “V” cross-section is inherently mechanically strong, easily internally cross-brace able to further strengthen and allows direct downward weight and related traffic loads to be distributed to the vertical side-walls of the receiving trench, providing crush resistance with minimal distortion. Such “V” trench sidewalls can readily receive sealant/cushioning/tolerance absorbing/weatherizing/sealing/heat conducting material during installation to insure proper installation and tolerances to roadway surface.

Primary Power Distribution Features

The present invention includes an efficient PTM-CES 34 power distribution architecture that minimizes GPMI 48 conversion losses from the grid 18 and/or CHP 50 and associated roadway or parking area transmission cable 92 and related PTM 14 primary power losses. The high voltage transformer-less design of GPMI 48 reduces conversion losses and the modularity allows subdivision of the load by the number (or effective number) of phase lanes of provided as load. This subdivision reduces GPMI 48 design requirements to where current technology is able to cost effectively implement this function. This subdivision also introduces redundancy within the transmission and load architecture where phase failures represent a “soft” system failure, degrading PTM 14 power generation in a more or less linear fashion. The ability to electronically optimize GPMI 48 phase power generation, based upon roadway loading, increases conversion efficiency. The provision of multiple phases at transformer primaries within RTC 92 reduces current by the number of phases thereby making the size and material of each related phase transformer practical and cost effective. The relatively high frequency (60 kHz nominal) makes the implementation of each phase transformer practical for this application. The design of RTC 92 negates skin effect losses associated with this relatively high frequency by the use of metalized plastic or metal foil conductors that in turn can provide a low cost light weight alternative to conventional cabling such as copper wire. Further geometry considerations within RTC 92 cabling allow a shielded transmission line ducting of transmitted energy enhancing EMI shielding and reducing losses. Furthermore, internal geometry of foil conductors facilitates connections to imbedded transformer primaries thereby enhancing reliability and lowering costs of manufacture. The ability of high speed turbines as utilized within current CHPs allow the migration of some or all GPMI 48 power conversion into CHP 50 function with appropriate associated electrical generator design.

The present invention also encompasses grid back-up configurations with distributed generation and peak shaving that is facilitated by the CHP 50 grid inter-tie functionality and WAVES 10 ability to “smartly” interact with vehicle loading. Grid inter-tie further enhances reliability beyond load sharing to being able to completely supply roadway or parking needs under periods of grid failures or vice-versa under CHP failures. RTCs 92 can be terminated into RTCs 92 in adjacent roadway or parking segments to produce a combined network of power distribution and distributed generation and grid connectivity that further enhances redundancy for failure mitigation. The phase locking mechanisms within each GPMI 48 readily facilitates such segment to segment inter-tie.

The present invention also provides inherently weatherized interconnection to PTM-CES 34 units by utilizing magnetic fields as the power transfer mechanism and thus allows liberal use of waterproof electrical insulation surrounding RTC 92 imbedded phase transformer primaries and associated secondaries within PTM-CES 34 units. Only the physical parting interface is exposed to the roadway/parking environment. Such magnetic material is readily formulated and/or coated to resist corrosion at these parting interfaces with minimal effect upon power transfer efficiency.

The present invention further accomplished simplified and efficient PTM 14 coil and related electronics implementation due to the modularity and construction of individual PTM-CES 34 units. The relatively large number of PTM-CES 34 units activate able per vehicle (nominally 14 for small vehicles) allows the use of low cost and electrically efficient power generation and control electronics such as power MOSFETs and diodes etc. The Tank Coil 74 is a critical component in the establishment of the roadway/parking magnetic field source for energy transfer. Since the operational frequency is in the region where skin effect is an important source of losses (nominally 360 kHz) the design of this component requires careful consideration. Current Litz wire 126 construction can be replaced with metal foil implementation wherein a spiral of metal foil and associated interwinding dielectric or other geometry coil is fabricated. The depth of this coil from the roadway can be made to accommodate the foil width required, to suitably reduce resistive losses (bulk conduction and skin effect). Furthermore, the design of this coil can be tuned to resonance at the operational power frequency through the control of dielectric spacing and material and by the number of foil turns within the coil. This can accommodate the Tank Coil 74 and all or part of the Resonating Tank Capacitor 120 function thereby decreasing cost and overall volume while simplifying the architecture.

Power Receive Module Features

The present invention may provide for passive driving error mitigation by the use of multiple PRM 16 receive coils. The energy received by two or more PRM 16 receive coils on an plane parallel to the roadway and on an axis relatively perpendicular to the vehicle's direction of travel can be coherently (AC) or noncoherently (DC) combined such as to effectively increase the PRM's energy receiving aperture in direct proportion to the combined area of the individual receive coils. In this manner, driving errors can be mitigated with minimal loss in efficiency and no physical tracking by PRM 16.

The present invention may additionally provide simplified physical and electrical integration vehicle steering sensory feedback adjuncts via the sensing of roadway magnetic fields in relation to vehicle path enables feedback to both driver and automated steering systems onboard vehicles to either allow errors to be sensed and easily manually corrected or fully automated steering. This includes automatic alerting and drive mitigation with regards adjacent lane or fore and aft vehicles in a WAVES connected roadway environment. Knowledge gained from energized PTM-CES 34 units can be collected, aggregated and disseminated by the WAVES (system) to roadway vehicles to address roadway navigation and safety issues.

The present invention further provides an integrated pickup oil and resonating cap combined into a common single integrated component utilizing conductive foil or otherwise high area conductors with dielectric spacing to establish parallel resonance. This approach minimizes high voltage wiring and high voltage PRM Resonating Cap 120 requirements (note that foils can readily serve as effective conductors within both capacitors and coils at the frequencies nominally employed within power electronics). Foil construction is especially relevant to maintaining low weight and cost while reducing skin effect losses associated with AC current transfer.

The present invention includes parallel and otherwise resonated load specific to the power carrier frequency(s) employed allow for selective power transfer to vehicle loads. This represents a fundamental means for limiting power transfer to non-intended loads such as passive metallic objects on the roadway or vehicles. This feature can be employed to selectively supply energy to specific classes of vehicles or to otherwise differentiate the power transfer mechanism.

Like the roadway surface, the present invention includes Faraday and non-resonant shielding of PRM 16 and located pickup coils by the use of nonmagnetic metal skins, including foils and films that surround individual PRM 16 and PRM 16 components. The purpose being to significantly reduce the unintended emission or radiation of induced RF energy, especially at the power carrier frequency and related harmonics and sidebands, without significantly effecting magnetic field coupling to the vehicle and roadway, either at power or signaling frequencies. The use of a metallic skin overlay over the bottom (roadway level) of PRM 16 coils is especially significant in this regard, this skin can be patterned to provide RF attenuation while at the same time remain transparent to magnetic field frequencies employed by WAVES 10. Patterning in effect can be non-resident at power carrier and magnetic signaling frequencies thereby minimizing respective induced currents.

The present invention also employs imbedded DC rectification with power summing capability for the passive mitigation of driving errors and the accommodation of different voltage/current outputs to meet differing EV energization needs. Or-tying of power carrier rectified power can in turn sum respective outputs from several PRM 16 coils with minimal loss from coils not fully excited magnetically. This is deemed non-coherent power summation. Series parallel combinations of rectified coils, in turn, provide combinations of voltage/current outputs from PRM 16 to meet differing EV energization requirements.

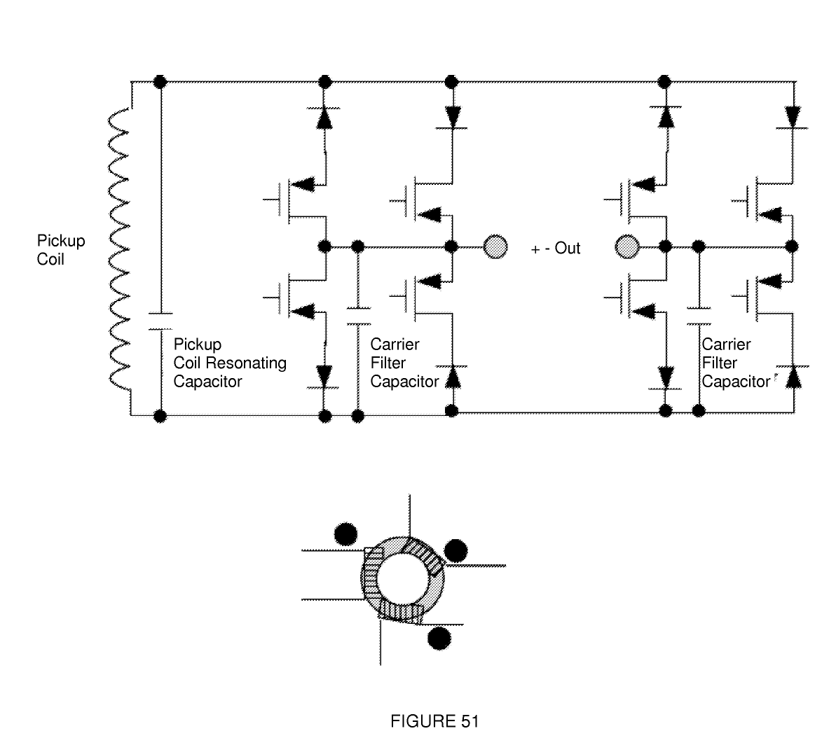

Referring to FIG. 51, the present invention provides imbedded synchronous rectification with power summing and AC voltage generation capability for the passive mitigation of driving errors and the accommodation of different voltage/current outputs to meet differing EV energization needs. Synchronous rectification is an efficient means of rectification since fast high power switching transistors such as power MOSFETs can nearly eliminate the diode voltage drops associated with power diodes, which may be typically 1.2 volts for fast high voltage diodes. By dynamically synchronizing to alternating phases of the power carrier frequency picked up by PTM 14 coils, AC waveforms of lower power frequencies can be synthesized. Of particular interest are 50 and 60 Hz which are standard AC power frequencies world wide. Such converted power is useful for direct application to existing EV charging circuitry so as to provide hardware minimal interfaces to existing charging ports.

By phase synchronizing drive signals (transformer isolated) to the power carrier waveform as received by PRM 16 from PTM 14, the polarity of the output can be controlled in both static and dynamic senses by way of the switching of appropriate power MOSFETs on each side of the output circuit. Furthermore, gate drives can be duty-cycle modulated or otherwise shaped to effect net instantaneous power transfer to the output, thereby allowing sinusoidal or other net waveform generation at sub-carrier output frequencies (e.g. 60 Hz) including DC. Note that power carrier related components of the output are smoothed/integrated/filtered/sufficiently eliminated by carrier filter capacitors or other output filtering that leave desired sub-carrier waveform intact.

WAVES Strapping Approach to PTM Assembly and Fabrication

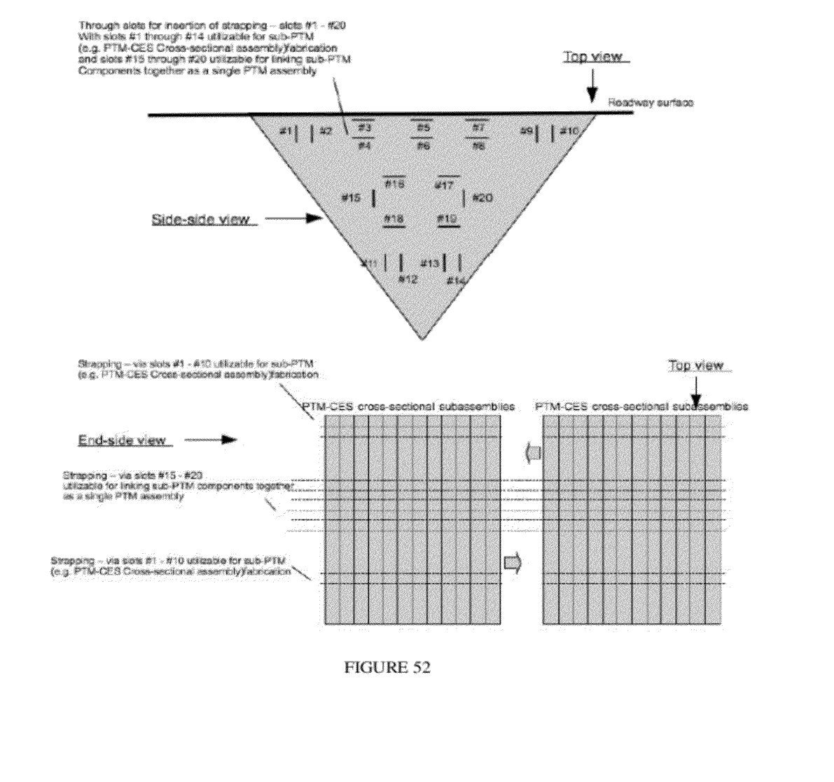

Referring to FIG. 52, it is important to be able to easily and robustly assemble at least three levels of PTM 14 housing to insure integrity and strength while minimizing costs. The use of heavy duty strapping allows the levels of housing components to be placed in compression with great pressure thus insuring that components remained sealed under lifetime of use with heavy traffic loads. Strapping can be removed for maintenance as necessary. Tensioning of straps during manufacture is easily and cheaply accomplished as the straps are inserted through various slots within the PTM cross-section and looped or otherwise secured following compressive tensioning.

What is claimed is:

1. A wireless energizing system for charging an electric battery positioned in a vehicle, comprising:
a power transmit module positioned in a fixed location and including at least one transmit coil for transmitting power via a magnetic field;
an interface magnetically coupling said power transmit module to a power source; and
a power receive module attached to said vehicle and interconnected to the battery, wherein said power receive module includes at least one pickup coil for receiving said power from said power transmit module via said magnetic field when positioned proximately to said power transmit module.

2. The system of claim 1, wherein said transmit coil and said pickup coil are formed from conductive foil.

3. The system of claim 1 wherein said interface comprises a grid power multiphase interface comprising a set of phase inverters that are phase linked to transform power received from said power source to six phase if nominally multi-kHz power.

4. The system of claim 3, wherein said interface further comprises a transformer cable having a set of magnetically coupled transformer links for transmitting power from said set of phase inverters to said power transmit module.

5. The system of claim 4, wherein said interface comprises conductors formed by conductive foil.

6. The system of claim 3, wherein said grid power interface enables distributed generation power sources in parallel with grid power sourcing.

7. The system of claim 1, wherein each said transmit coil comprises a power amplifier for energizing a link coil having a first predetermined number of turns that is magnetically coupled to a tank circuit including a tank coil having a second predetermined number of turns that is greater than said first predetermined number of turns of said link coil and a tank capacitor.

8. The system of claim 7, wherein said tank capacitor includes a plate split into first and second sections, and wherein said first section is coupled to an external capacitor for monitoring the voltage of said tank capacitor in real-time and regulating power inductively coupled to a load based on said monitoring.

9. The system of claim 8, further comprising a transformer with primary formed from a set of conductors within a Litz wire primary.

10. The system of claim 8, wherein said transmit coil is formed from conductive foil.

11. The system of claim 1, wherein said power transmit module further includes a microprocessor programmed to establish a proximity link to said vehicle that triggers the transmission of power from said transmitter when said vehicle is located proximately to said power transmit module.

12. The system of claim 1 further comprises a display configured to indicate to a driver of said vehicle the location of said vehicle relative to said power transmit module.

13. The system of claim 12, further comprising a series of power transmit modules, each of which is triggered to transmit power when said vehicle is located proximately to said power transmit module.

14. The system of claim 13, wherein said series of power transmit modules are concatenated and positioned along a section of a roadway.

15. The system of claim 14, wherein each of said concatenated power transmit modules are energized only when said vehicle is proximity thereto.

16. The system of claim 1, wherein said power receive module includes a microprocessor programmed to establish said first and second proximity links and said data link with said microprocessor of said power transmit module.

17. The system of claim 1 wherein said power receive module includes a predetermined plurality of pickup coils, the number of which are based on the power demands of the vehicle.

18. The system of claim 1, wherein said power transmit module is located within a V-shaped groove.

19. The system of claim 18, wherein a plurality of said power transmit modules are concatenated and removeably positioned within said groove.

20. The system of claim 19, wherein said groove is formed in a roadway lane.
